(19) United States
(12) Patent Application Publication
(10) Pub. No.: US 2026/0099236 A1
(43) Pub. Date: Apr. 9, 2026

(54) DEVICES, METHODS, AND GRAPHICAL USER INTERFACES FOR INTERACTING WITH MEDIA AND THREE-DIMENSIONAL ENVIRONMENTS

(71) Applicant: Apple Inc., Cupertino, CA (US)

(72) Inventors: Miquel ESTANY RODRIGUEZ, San Francisco, CA (US); James J. OWEN, San Francisco, CA (US); Gregory M. APODACA, Colbert, WA (US); Chia Yang LIN, San Francisco, CA (US); William A. SORRENTINO, III, Mill Valley, CA (US); Michael I. WEINSTEIN, San Francisco, CA (US); Vedant SARAN, Campbell, CA (US); Bryce L. SCHMIDTCHEN, San Francisco, CA (US)

(21) Appl. No.: 19/415,644

(22) Filed: Dec. 10, 2025

Related U.S. Application Data
(63) Continuation of application No. 18/374,562, filed on Sep. 28, 2023.
Application No. 18/374,562 is a continuation of application No. PCT/US2022/044637, filed on Sep. 24, 2022.
(60) Provisional application No. 63/248,222, filed on Sep. 24, 2021.
(60) Provisional application No. 63/409,695, filed on Sep. 23, 2022.

(51) Int. Cl. G06F 3/04815; G06F 3/01; G06F 3/04845; G06F 3/0488; G06T 3/40; G06T 5/70; G06T 17/00

(52) U.S. Cl. CPC G06F 3/04815; G06F 3/013; G06F 3/04845; G06F 3/0488; G06T 3/40; G06T 5/70; G06T 17/00

(57) ABSTRACT

The present disclosure generally relates to user interfaces for electronic devices, including user interfaces for viewing and interacting with media items.

### CROSS-REFERENCE TO RELATED APPLICATIONS

This application is a continuation of U.S. patent application Ser. No. 18/374,562, entitled “DEVICES, METHODS, AND GRAPHICAL USER INTERFACES FOR INTERACTING WITH MEDIA AND THREE-DIMENSIONAL ENVIRONMENTS,” filed on Sep. 28, 2023, which is a continuation of PCT/US2022/044637, entitled “DEVICES, METHODS, AND GRAPHICAL USER INTERFACES FOR INTERACTING WITH MEDIA AND THREE-DIMENSIONAL ENVIRONMENTS,” filed on Sep. 24, 2022, which claims priority to U.S. Provisional Patent Application No. 63/409,695 , entitled “DEVICES, METHODS, AND GRAPHICAL USER INTERFACES FOR INTERACTING WITH MEDIA AND THREE-DIMENSIONAL ENVIRONMENTS,” filed on Sep. 23, 2022; and to U.S. Provisional Patent Application No. 63/248,222 , entitled “DEVICES, METHODS, AND GRAPHICAL USER INTERFACES FOR INTERACTING WITH MEDIA AND THREE-DIMENSIONAL ENVIRONMENTS,” filed on Sep. 24, 2021. The contents of each of these applications are hereby incorporated by reference in their entireties.

### TECHNICAL FIELD

The present disclosure relates generally to computer systems that are in communication with a display generation component and one or more input devices that provide computer-generated experiences, including, but not limited to, electronic devices that provide virtual reality and mixed reality experiences.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with media items and environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for interacting with media items and providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with media items within a three-dimensional environment. Such methods and interfaces may complement or replace conventional methods for interacting with media items within a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges. Such methods and interfaces also enhance the operability of devices and make user-device interfaces more efficient by, for example, reducing the number of unnecessary and/or extraneous received inputs and providing improved visual feedback to users.

In accordance with some embodiments, a method is described. The method comprises: at a computer system that is in communication with a display generation component and one or more input devices: displaying, via the display generation component, a media library user interface that includes representations of a plurality of media items including a representation of a first media item; and while displaying the media library user interface: detecting, at a first time, via the one or more input devices, a user gaze corresponding to a first position in the media library user interface; in response to detecting the user gaze corresponding to the first position in the media library user interface, changing an appearance of the representation of the first media item from being displayed, via the display generation component, in a first manner to being displayed in a second manner different from the first manner; detecting, at a second time subsequent to the first time, via the one or more input devices, a user gaze corresponding to a second position in the media library user interface different from the first position; and in response to detecting the user gaze corresponding to the second position in the media library user interface, displaying, via the display generation component, the representation of the first media item in a third manner different from the second manner.

In accordance with some embodiments, a non-transitory computer-readable storage medium is described. In some embodiments, the non-transitory computer-readable storage medium stores one or more programs configured to be executed by one or more processors of a computer system that is in communication with a display generation component and one or more input devices, the one or more programs including instructions for: displaying, via the display generation component, a media library user interface that includes representations of a plurality of media items including a representation of a first media item; and while displaying the media library user interface: detecting, at a first time, via the one or more input devices, a user gaze corresponding to a first position in the media library user interface; in response to detecting the user gaze corresponding to the first position in the media library user interface, changing an appearance of the representation of the first media item from being displayed, via the display generation component, in a first manner to being displayed in a second manner different from the first manner; detecting, at a second time subsequent to the first time, via the one or more input devices, a user gaze corresponding to a second position in the media library user interface different from the first position; and in response to detecting the user gaze corresponding to the second position in the media library user interface, displaying, via the display generation component, the representation of the first media item in a third manner different from the second manner.

In accordance with some embodiments, a transitory computer-readable storage medium is described. In some embodiments, the transitory computer-readable storage medium stores one or more programs configured to be executed by one or more processors of a computer system that is in communication with a display generation component and one or more input devices, the one or more programs including instructions for: displaying, via the display generation component, a media library user interface that includes representations of a plurality of media items including a representation of a first media item; and while displaying the media library user interface: detecting, at a first time, via the one or more input devices, a user gaze corresponding to a first position in the media library user interface; in response to detecting the user gaze corresponding to the first position in the media library user interface, changing an appearance of the representation of the first media item from being displayed, via the display generation component, in a first manner to being displayed in a second manner different from the first manner; detecting, at a second time subsequent to the first time, via the one or more input devices, a user gaze corresponding to a second position in the media library user interface different from the first position; and in response to detecting the user gaze corresponding to the second position in the media library user interface, displaying, via the display generation component, the representation of the first media item in a third manner different from the second manner.

In accordance with some embodiments, a computer system is described. In some embodiments, the computer system is in communication with a display generation component and one or more input devices, and comprises: one or more processors; and memory storing one or more programs configured to be executed by the one or more processors, the one or more programs including instructions for: displaying, via the display generation component, a media library user interface that includes representations of a plurality of media items including a representation of a first media item; and while displaying the media library user interface: detecting, at a first time, via the one or more input devices, a user gaze corresponding to a first position in the media library user interface; in response to detecting the user gaze corresponding to the first position in the media library user interface, changing an appearance of the representation of the first media item from being displayed, via the display generation component, in a first manner to being displayed in a second manner different from the first manner; detecting, at a second time subsequent to the first time, via the one or more input devices, a user gaze corresponding to a second position in the media library user interface different from the first position; and in response to detecting the user gaze corresponding to the second position in the media library user interface, displaying, via the display generation component, the representation of the first media item in a third manner different from the second manner.

In some embodiments, a computer system is described. In some embodiments, the computer system is in communication with a display generation component and one or more input devices and comprises: means for displaying, via the display generation component, a media library user interface that includes representations of a plurality of media items including a representation of a first media item; and means for, while displaying the media library user interface: detecting, at a first time, via the one or more input devices, a user gaze corresponding to a first position in the media library user interface; in response to detecting the user gaze corresponding to the first position in the media library user interface, changing an appearance of the representation of the first media item from being displayed, via the display generation component, in a first manner to being displayed in a second manner different from the first manner; detecting, at a second time subsequent to the first time, via the one or more input devices, a user gaze corresponding to a second position in the media library user interface different from the first position; and in response to detecting the user gaze corresponding to the second position in the media library user interface, displaying, via the display generation component, the representation of the first media item in a third manner different from the second manner.

In some embodiments, a computer program product is described. In some embodiments, the computer program product comprises one or more programs configured to be executed by one or more processors of a computer system that is in communication with a display generation component and one or more input devices, the one or more programs including instructions for: displaying, via the display generation component, a media library user interface that includes representations of a plurality of media items including a representation of a first media item; and while displaying the media library user interface: detecting, at a first time, via the one or more input devices, a user gaze corresponding to a first position in the media library user interface; in response to detecting the user gaze corresponding to the first position in the media library user interface, changing an appearance of the representation of the first media item from being displayed, via the display generation component, in a first manner to being displayed in a second manner different from the first manner; detecting, at a second time subsequent to the first time, via the one or more input devices, a user gaze corresponding to a second position in the media library user interface different from the first position; and in response to detecting the user gaze corresponding to the second position in the media library user interface, displaying, via the display generation component, the representation of the first media item in a third manner different from the second manner.

In accordance with some embodiments, a method is described. The method comprises: at a computer system that is in communication with a display generation component and one or more input devices: displaying, via the display generation component, a user interface at a first zoom level; while displaying the user interface, detecting, via the one or more input devices, one or more user inputs corresponding to a zoom-in user command; and in response to detecting the one or more user inputs corresponding to the zoom-in user command: in accordance with a determination that a user gaze corresponds to a first position in the user interface, displaying, via the display generation component, the user interface at a second zoom level that is greater than the first zoom level, wherein displaying the user interface at the second zoom level includes zooming the user interface using a first zoom center that is selected based on the first position; and in accordance with a determination that the user gaze corresponds to a second position in the user interface different from the first position, displaying, via the display generation component, the user interface at a third zoom level that is greater than the first zoom level, wherein displaying the user interface at the third zoom level includes zooming the user interface using a second zoom center that is selected based on the second position and the second zoom center is at a different location than the first zoom center.

In accordance with some embodiments, a non-transitory computer-readable storage medium is described. In some embodiments, the non-transitory computer-readable storage medium stores one or more programs configured to be executed by one or more processors of a computer system that is in communication with a display generation component and one or more input devices, the one or more programs including instructions for: displaying, via the display generation component, a user interface at a first zoom level; while displaying the user interface, detecting, via the one or more input devices, one or more user inputs corresponding to a zoom-in user command; and in response to detecting the one or more user inputs corresponding to the zoom-in user command: in accordance with a determination that a user gaze corresponds to a first position in the user interface, displaying, via the display generation component, the user interface at a second zoom level that is greater than the first zoom level, wherein displaying the user interface at the second zoom level includes zooming the user interface using a first zoom center that is selected based on the first position; and in accordance with a determination that the user gaze corresponds to a second position in the user interface different from the first position, displaying, via the display generation component, the user interface at a third zoom level that is greater than the first zoom level, wherein displaying the user interface at the third zoom level includes zooming the user interface using a second zoom center that is selected based on the second position and the second zoom center is at a different location than the first zoom center.

In accordance with some embodiments, a transitory computer-readable storage medium is described. In some embodiments, the transitory computer-readable storage medium stores one or more programs configured to be executed by one or more processors of a computer system that is in communication with a display generation component and one or more input devices, the one or more programs including instructions for: displaying, via the display generation component, a user interface at a first zoom level; while displaying the user interface, detecting, via the one or more input devices, one or more user inputs corresponding to a zoom-in user command; and in response to detecting the one or more user inputs corresponding to the zoom-in user command: in accordance with a determination that a user gaze corresponds to a first position in the user interface, displaying, via the display generation component, the user interface at a second zoom level that is greater than the first zoom level, wherein displaying the user interface at the second zoom level includes zooming the user interface using a first zoom center that is selected based on the first position; and in accordance with a determination that the user gaze corresponds to a second position in the user interface different from the first position, displaying, via the display generation component, the user interface at a third zoom level that is greater than the first zoom level, wherein displaying the user interface at the third zoom level includes zooming the user interface using a second zoom center that is selected based on the second position and the second zoom center is at a different location than the first zoom center.

In accordance with some embodiments, a computer system is described. In some embodiments, the computer system is in communication with a display generation component and one or more input devices, and the computer system comprises: one or more processors; and memory storing one or more programs configured to be executed by the one or more processors, the one or more programs including instructions for: displaying, via the display generation component, a user interface at a first zoom level; while displaying the user interface, detecting, via the one or more input devices, one or more user inputs corresponding to a zoom-in user command; and in response to detecting the one or more user inputs corresponding to the zoom-in user command: in accordance with a determination that a user gaze corresponds to a first position in the user interface, displaying, via the display generation component, the user interface at a second zoom level that is greater than the first zoom level, wherein displaying the user interface at the second zoom level includes zooming the user interface using a first zoom center that is selected based on the first position; and in accordance with a determination that the user gaze corresponds to a second position in the user interface different from the first position, displaying, via the display generation component, the user interface at a third zoom level that is greater than the first zoom level, wherein displaying the user interface at the third zoom level includes zooming the user interface using a second zoom center that is selected based on the second position and the second zoom center is at a different location than the first zoom center.

In some embodiments, a computer system is described. In some embodiments, the computer system is in communication with a display generation component and one or more input devices, and the computer system comprises: means for displaying, via the display generation component, a user interface at a first zoom level; means for, while displaying the user interface, detecting, via the one or more input devices, one or more user inputs corresponding to a zoom-in user command; and means for, in response to detecting the one or more user inputs corresponding to the zoom-in user command: in accordance with a determination that a user gaze corresponds to a first position in the user interface, displaying, via the display generation component, the user interface at a second zoom level that is greater than the first zoom level, wherein displaying the user interface at the second zoom level includes zooming the user interface using a first zoom center that is selected based on the first position; and in accordance with a determination that the user gaze corresponds to a second position in the user interface different from the first position, displaying, via the display generation component, the user interface at a third zoom level that is greater than the first zoom level, wherein displaying the user interface at the third zoom level includes zooming the user interface using a second zoom center that is selected based on the second position and the second zoom center is at a different location than the first zoom center.

In some embodiments, a computer program product is described. In some embodiments, the computer program product comprises one or more programs configured to be executed by one or more processors of a computer system that is in communication with a display generation component and one or more input devices, the one or more programs including instructions for: displaying, via the display generation component, a user interface at a first zoom level; while displaying the user interface, detecting, via the one or more input devices, one or more user inputs corresponding to a zoom-in user command; and in response to detecting the one or more user inputs corresponding to the zoom-in user command: in accordance with a determination that a user gaze corresponds to a first position in the user interface, displaying, via the display generation component, the user interface at a second zoom level that is greater than the first zoom level, wherein displaying the user interface at the second zoom level includes zooming the user interface using a first zoom center that is selected based on the first position; and in accordance with a determination that the user gaze corresponds to a second position in the user interface different from the first position, displaying, via the display generation component, the user interface at a third zoom level that is greater than the first zoom level, wherein displaying the user interface at the third zoom level includes zooming the user interface using a second zoom center that is selected based on the second position and the second zoom center is at a different location than the first zoom center.

In accordance with some embodiments, a method is described. The method comprises: at a computer system that is in communication with a display generation component and one or more input devices: detecting, via the one or more input devices, one or more user inputs corresponding to selection of a first media item; and in response to detecting the one or more user inputs corresponding to selection of the first media item: in accordance with a determination that the first media item is a media item that includes a respective type of depth information, displaying, via the display generation component, the first media item in a first manner; and in accordance with a determination that the first media item is a media item that does not include the respective type of depth information, displaying, via the display generation component, the first media item in a second manner different from the first manner.

In accordance with some embodiments, a non-transitory computer-readable storage medium is described. In some embodiments, the non-transitory computer-readable storage medium stores one or more programs configured to be executed by one or more processors of a computer system that is in communication with a display generation component and one or more input devices, the one or more programs including instructions for: detecting, via the one or more input devices, one or more user inputs corresponding to selection of a first media item; and in response to detecting the one or more user inputs corresponding to selection of the first media item: in accordance with a determination that the first media item is a media item that includes a respective type of depth information, displaying, via the display generation component, the first media item in a first manner; and in accordance with a determination that the first media item is a media item that does not include the respective type of depth information, displaying, via the display generation component, the first media item in a second manner different from the first manner.

In accordance with some embodiments, a transitory computer-readable storage medium is described. In some embodiments, the transitory computer-readable storage medium stores one or more programs configured to be executed by one or more processors of a computer system that is in communication with a display generation component and one or more input devices, the one or more programs including instructions for: detecting, via the one or more input devices, one or more user inputs corresponding to selection of a first media item; and in response to detecting the one or more user inputs corresponding to selection of the first media item: in accordance with a determination that the first media item is a media item that includes a respective type of depth information, displaying, via the display generation component, the first media item in a first manner; and in accordance with a determination that the first media item is a media item that does not include the respective type of depth information, displaying, via the display generation component, the first media item in a second manner different from the first manner.

In accordance with some embodiments, a computer system is described. In some embodiments, the computer system is in communication with a display generation component and one or more input devices, and the computer system comprises: one or more processors; and memory storing one or more programs configured to be executed by the one or more processors, the one or more programs including instructions for: detecting, via the one or more input devices, one or more user inputs corresponding to selection of a first media item; and in response to detecting the one or more user inputs corresponding to selection of the first media item: in accordance with a determination that the first media item is a media item that includes a respective type of depth information, displaying, via the display generation component, the first media item in a first manner; and in accordance with a determination that the first media item is a media item that does not include the respective type of depth information, displaying, via the display generation component, the first media item in a second manner different from the first manner.

In some embodiments, a computer system is described. In some embodiments, the computer system is in communication with a display generation component and one or more input devices, and the computer system comprises: means for detecting, via the one or more input devices, one or more user inputs corresponding to selection of a first media item; and means for, in response to detecting the one or more user inputs corresponding to selection of the first media item: in accordance with a determination that the first media item is a media item that includes a respective type of depth information, displaying, via the display generation component, the first media item in a first manner; and in accordance with a determination that the first media item is a media item that does not include the respective type of depth information, displaying, via the display generation component, the first media item in a second manner different from the first manner.

In some embodiments, a computer program product is described. In some embodiments, the computer program product comprises one or more programs configured to be executed by one or more processors of a computer system that is in communication with a display generation component and one or more input devices, the one or more programs including instructions for: detecting, via the one or more input devices, one or more user inputs corresponding to selection of a first media item; and in response to detecting the one or more user inputs corresponding to selection of the first media item: in accordance with a determination that the first media item is a media item that includes a respective type of depth information, displaying, via the display generation component, the first media item in a first manner; and in accordance with a determination that the first media item is a media item that does not include the respective type of depth information, displaying, via the display generation component, the first media item in a second manner different from the first manner.

In some embodiments, a method performed at a computer system that is in communication with a display generation component is described. The method comprises: displaying, via the display generation component, a user interface that includes: a first representation of a stereoscopic media item, wherein the first representation of the stereoscopic media item includes at least a first edge; and a visual effect, wherein the visual effect obscures at least a first portion of the stereoscopic media item and extends inwards from at least the first edge of the first representation of the stereoscopic media item towards an interior of the first representation of the stereoscopic media item.

In some embodiments a non-transitory computer readable storage medium is described. The non-transitory computer-readable storage medium stores one or more programs configured to be executed by one or more processors of a computer system, wherein the computer system is in communication with a display generation component, the one or more programs including instructions for: displaying, via the display generation component, a user interface that includes: a first representation of a stereoscopic media item, wherein the first representation of the stereoscopic media item includes at least a first edge; and a visual effect, wherein the visual effect obscures at least a first portion of the stereoscopic media item and extends inwards from at least the first edge of the first representation of the stereoscopic media item towards an interior of the first representation of the stereoscopic media item.

In some embodiments a transitory computer readable storage medium is described. The transitory computer-readable storage medium stores one or more programs configured to be executed by one or more processors of a computer system, wherein the computer system is in communication with a display generation component, the one or more programs including instructions for: displaying, via the display generation component, a user interface that includes: a first representation of a stereoscopic media item, wherein the first representation of the stereoscopic media item includes at least a first edge; and a visual effect, wherein the visual effect obscures at least a first portion of the stereoscopic media item and extends inwards from at least the first edge of the first representation of the stereoscopic media item towards an interior of the first representation of the stereoscopic media item.

In some embodiments, a computer system is described. The computer system comprises one or more processors, wherein the computer system is in communication with a display generation component; and memory storing one or more programs configured to be executed by the one or more processors, the one or more programs including instructions for: displaying, via the display generation component, a user interface that includes: a first representation of a stereoscopic media item, wherein the first representation of the stereoscopic media item includes at least a first edge; and a visual effect, wherein the visual effect obscures at least a first portion of the stereoscopic media item and extends inwards from at least the first edge of the first representation of the stereoscopic media item towards an interior of the first representation of the stereoscopic media item.

In some embodiments, a computer system is described. The computer system is in communication with a display generation component, and the computer system comprises,: means for displaying via the display generation component, a user interface that includes: a first representation of a stereoscopic media item, wherein the first representation of the stereoscopic media item includes at least a first edge; and a visual effect, wherein the visual effect obscures at least a first portion of the stereoscopic media item and extends inwards from at least the first edge of the first representation of the stereoscopic media item towards an interior of the first representation of the stereoscopic media item.

In some embodiments, a computer program product is described. The computer program product comprising one or more programs configured to be executed by one or more processors of a computer system that is in communication with a display generation component, the one or more programs including instructions for: displaying, via the display generation component, a user interface that includes: a first representation of a stereoscopic media item, wherein the first representation of the stereoscopic media item includes at least a first edge; and a visual effect, wherein the visual effect obscures at least a first portion of the stereoscopic media item and extends inwards from at least the first edge of the first representation of the stereoscopic media item towards an interior of the first representation of the stereoscopic media item.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a block diagram illustrating an operating environment of a computer system for providing extended reality experiences in accordance with some embodiments.

FIG. 2 is a block diagram illustrating a controller of a computer system that is configured to manage and coordinate an extended reality experience for the user in accordance with some embodiments.

FIG. 3 is a block diagram illustrating a display generation component of a computer system that is configured to provide a visual component of the extended reality experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7N illustrate example techniques for interacting with media items and user interfaces, in accordance with some embodiments.

FIG. 8 is a flow diagram of methods of interacting with media items and user interfaces, in accordance with various embodiments.

FIG. 9 is a flow diagram of methods of interacting with media items and user interfaces, in accordance with various embodiments.

FIG. 10 is a flow diagram of methods of interacting with media items and user interfaces, in accordance with various embodiments.

FIGS. 11A-11F illustrate example techniques for displaying media items, in accordance with some embodiments.

FIG. 12 is a flow diagram of methods for displaying media items, in accordance with some embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, one or more visual characteristics of displayed content are modified based on where the gaze of a user is directed. For example, if a user gazes at a first media item in a media library, visual characteristics of the first media item are modified, and if a user gazes at a second media item in the media library, visual characteristics of the second media item are modified. The location and/or position of a user's gaze is detected using sensors and/or cameras (e.g., sensors and/or cameras integrated with a head-mounted device or installed away from the user (e.g., in a XR room)), e.g., as opposed to touch-sensitive surfaces or other physical controllers. Modifying visual characteristics of displayed content based on the gaze of a user provides the user with visual feedback about the state of the computer system (e.g., that the computer system has detected a user gaze at a particular position in a user interface). Modifying visual characteristics of displayed content based on the gaze of a user also allows the user to efficiently interact with displayed content in more than one context, without visually cluttering the display with multiple controls, and improves the interaction efficiency of the user interfaces (e.g., reduces the number of inputs required to achieve a desired outcome).

In some embodiments, a computer system allows a user to zoom into a user interface based on where the gaze of the user is directed. For example, if a user gazes at a first position in the user interface while providing a zoom-in command (e.g., one or more hand gestures), the computer system zooms in on the user interface using the first position as a center point of the zoom operation, and if the user gazes at a second position in the user interface while providing the zoom-in command, the computer system zooms in on the user interface using the second position as the center point of the zoom operation. Zooming in on a user interface based on the gaze of a user provides the user with visual feedback about the state of the computer system (e.g., that the computer system has detected a user gaze at a particular position in a user interface), and assists the user in providing appropriate and/or correct inputs. Zooming in on a user interface based on the gaze of a user also allows the user to efficiently interact with displayed content in more than one context, without visually cluttering the display with multiple controls, and improves the interaction efficiency of the user interfaces (e.g., reducing the number of inputs required to achieve a desired outcome).

In some embodiments, media items are displayed differently (e.g., with different visual effects) based on whether the media item includes a particular type of depth information (e.g., based on whether the media item is a stereoscopic capture). For example, if the media item is a stereoscopic capture, the media item is displayed with a first set of visual characteristics (e.g., displayed within a three-dimensional shape, displayed with multiple layers, displayed with refractive and/or blurred edges); and if the media item is not a stereoscopic capture, the media item is displayed with a second set of visual characteristics (e.g., displayed within a two-dimensional shape, displayed as a single layer, displayed without refractive and/or blurred edges). Displaying media items differently based on whether the media item includes a particular type of depth information provides the user with visual feedback about the state of the computer system (e.g., indicates to the user whether the currently displayed media item includes the particular type of depth information).

In some embodiments, a visual effect is displayed as overlaid on top of a representation of a previously captured media item (e.g., a previously captured stereoscopic media item). For example, the visual effect can be displayed at one or more edges of the representation of the previously captured media item and extend inwards towards the center of the representation of the previously captured media item. The visual effect has a visual characteristic (e.g., amount of blur) that decreases in value and/or intensity as the visual effect extends towards the center of the representation of the media item. Displaying the visual effect at one or more edges of the representation of the media item aids in reducing the amount of visual discomfort (e.g., window violation) a user may experience while the user views the representation of the previously captured media item.

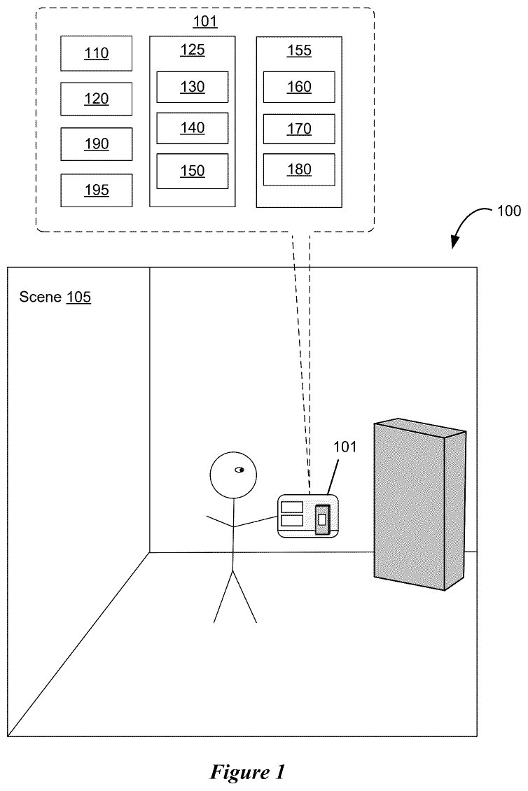

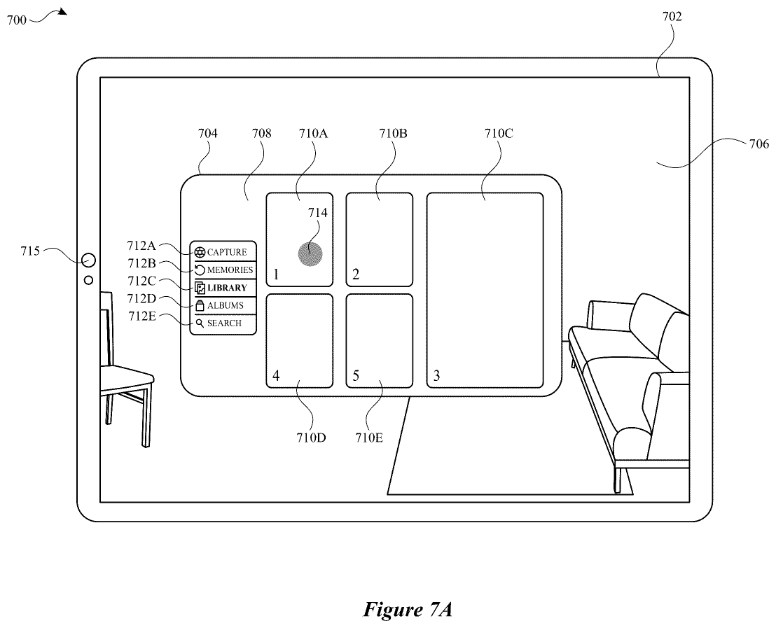

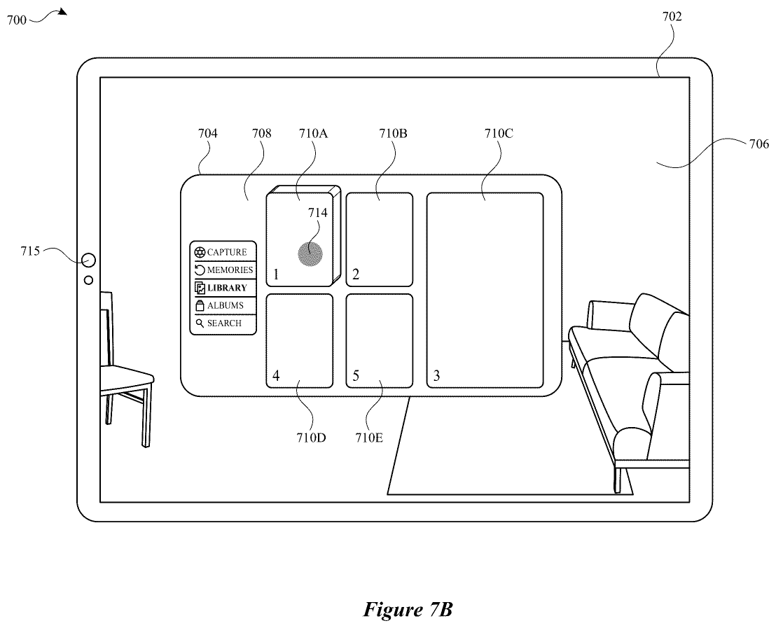

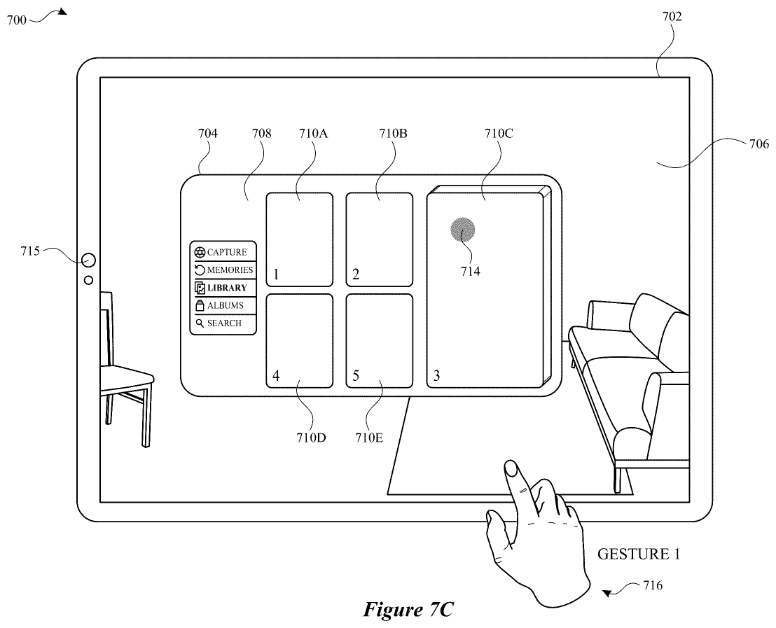

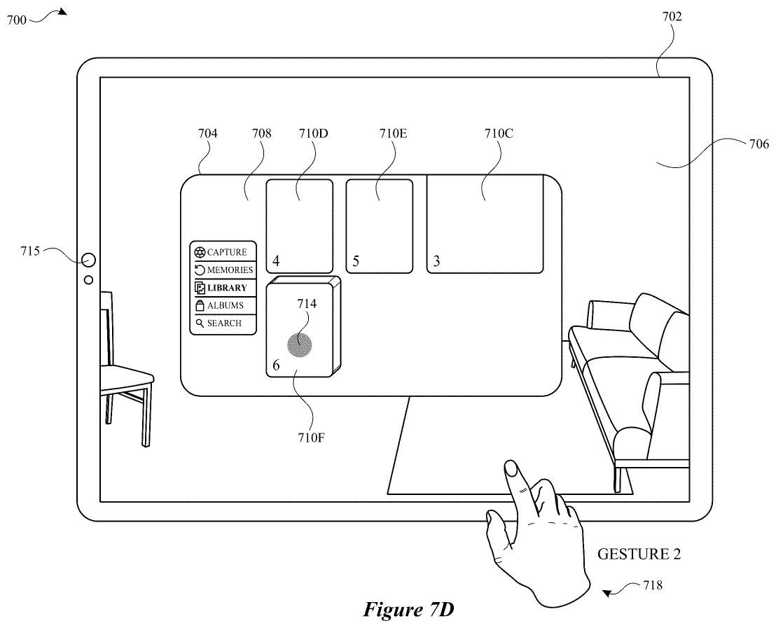

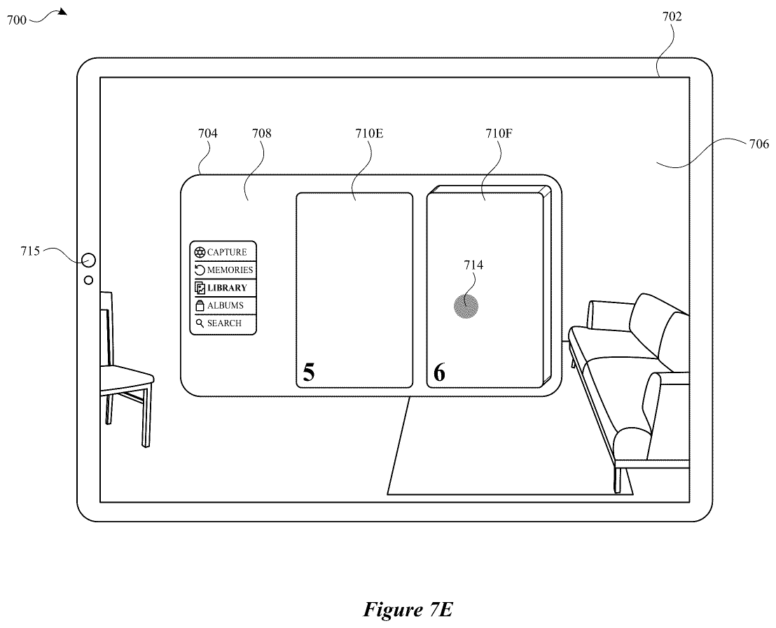

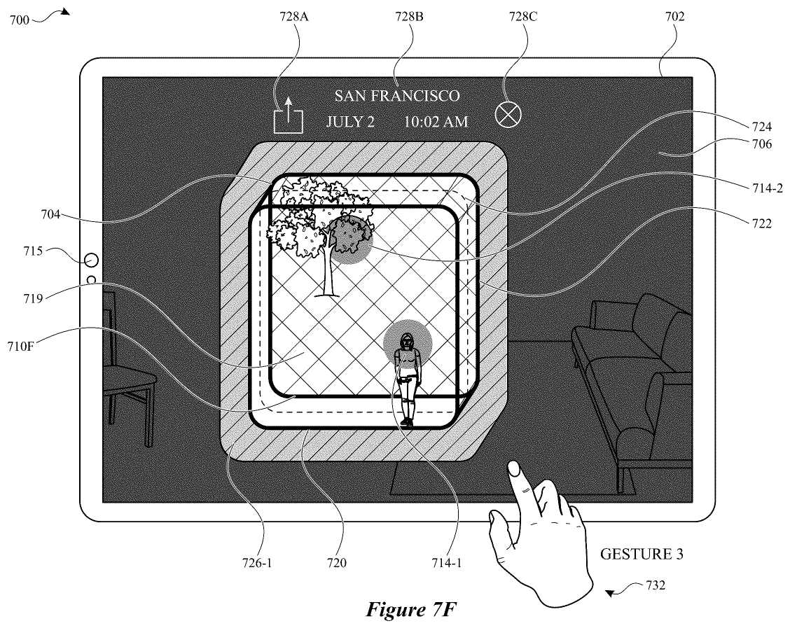

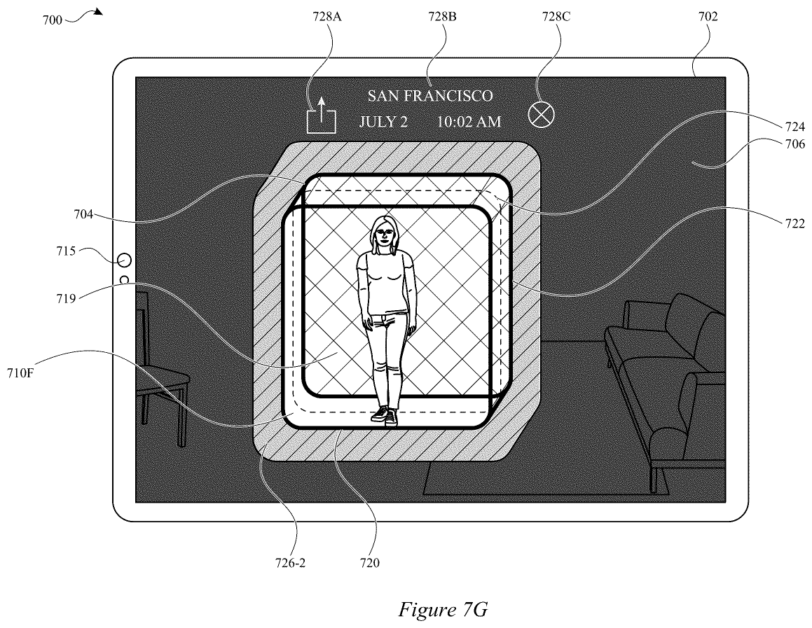

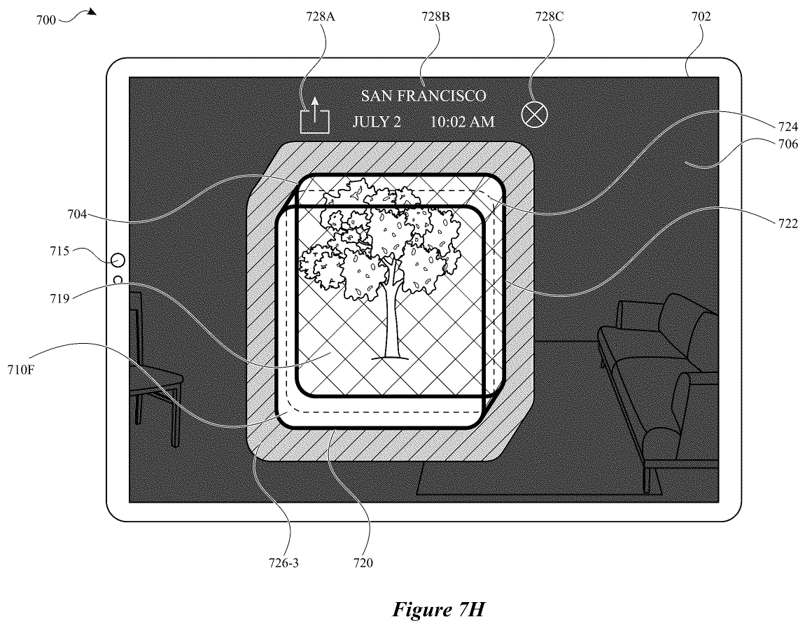

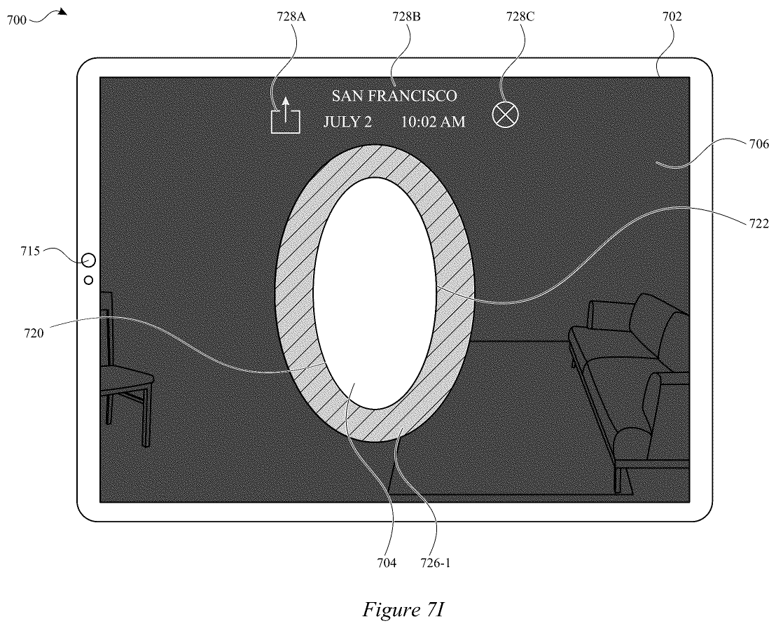

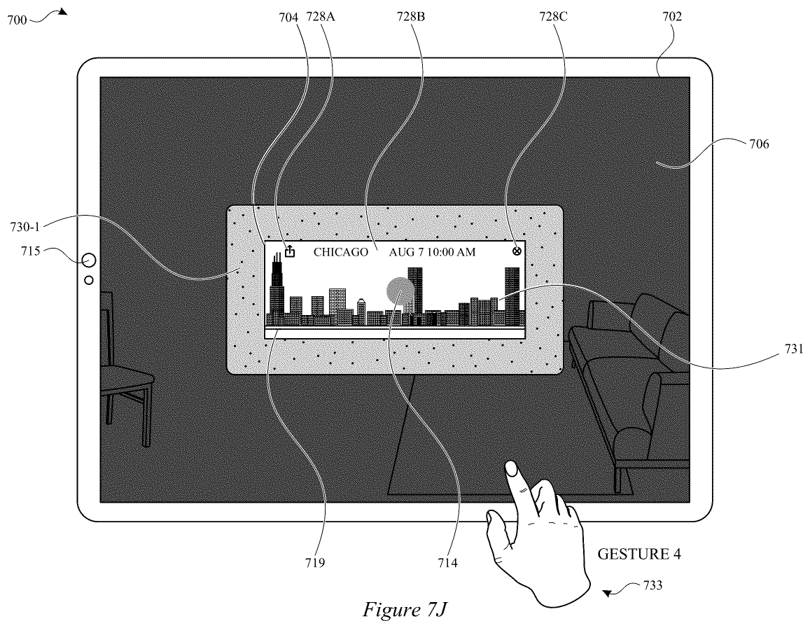

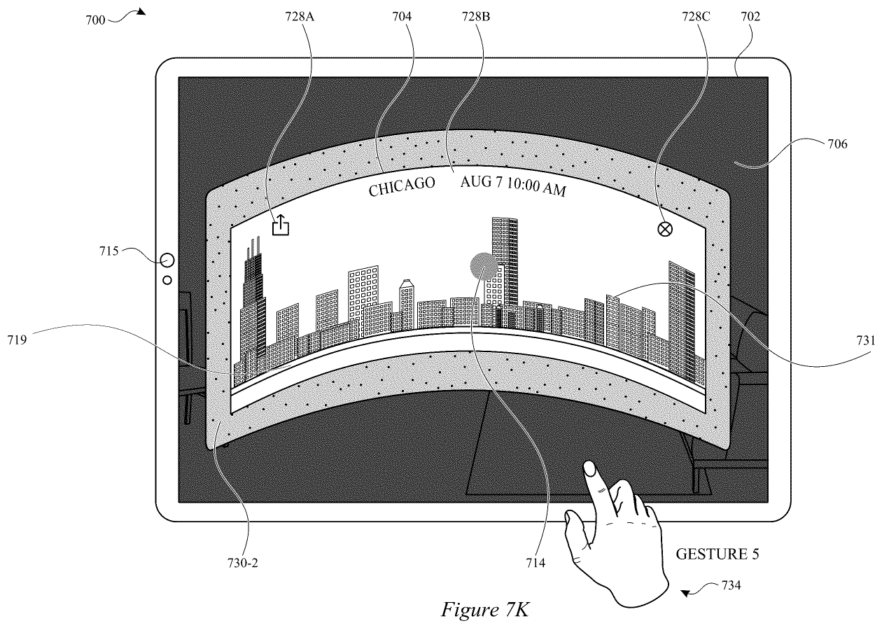

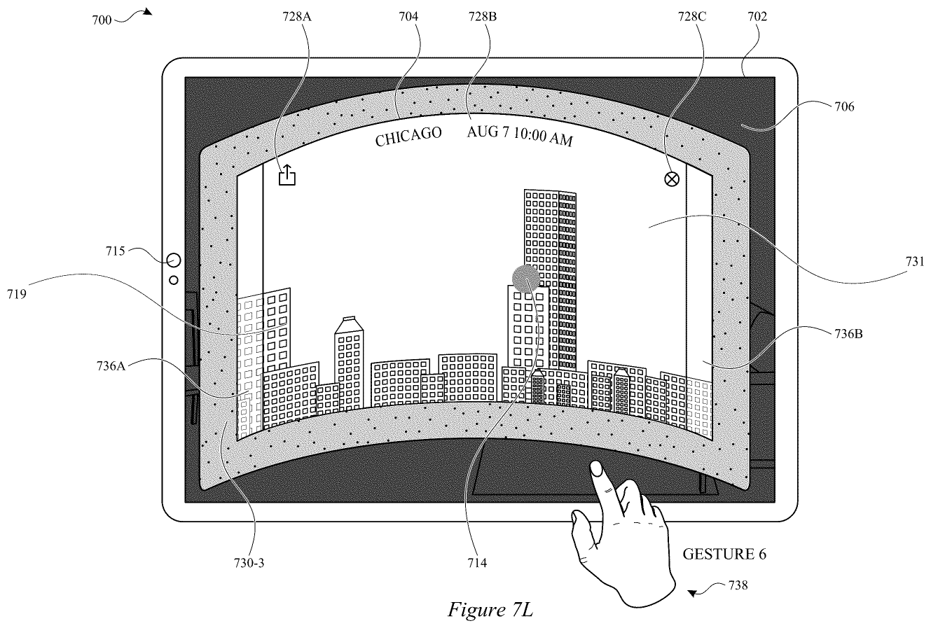

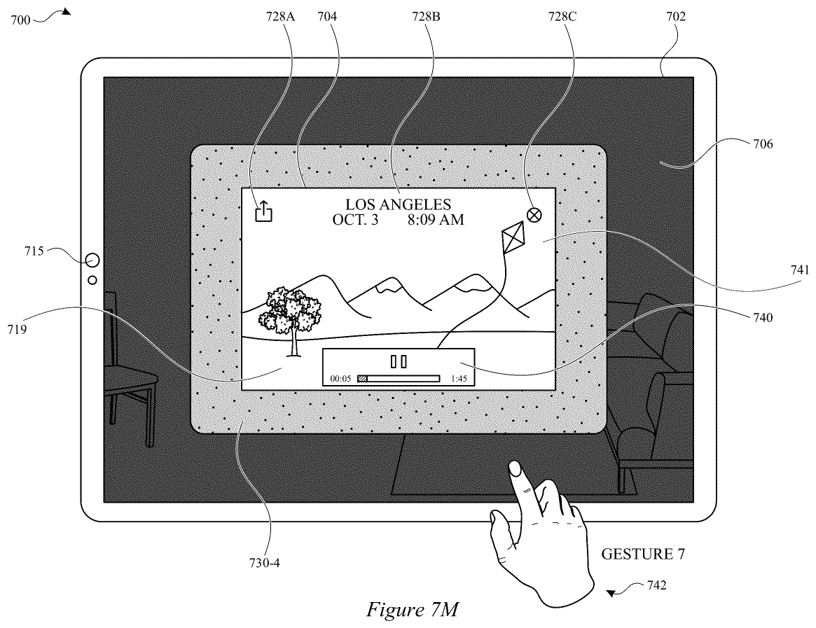

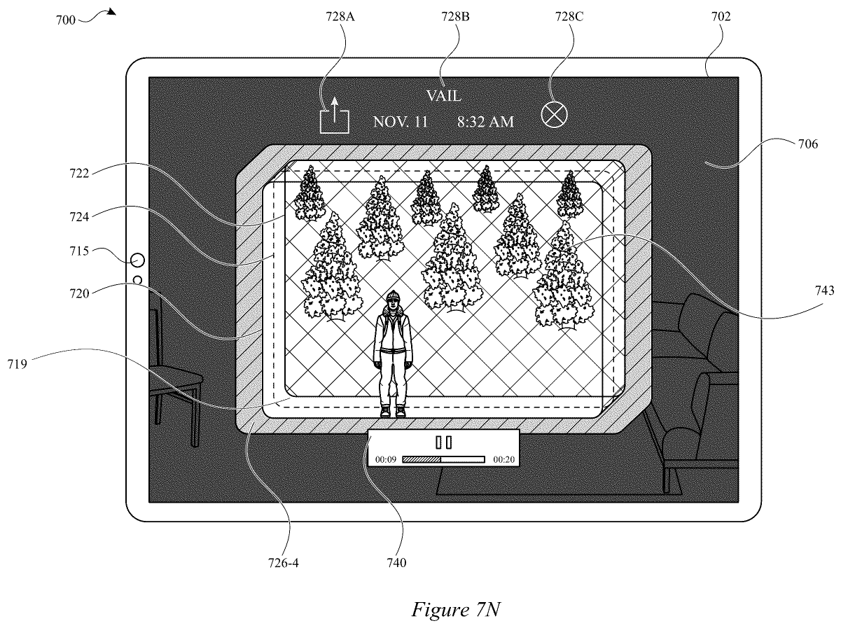

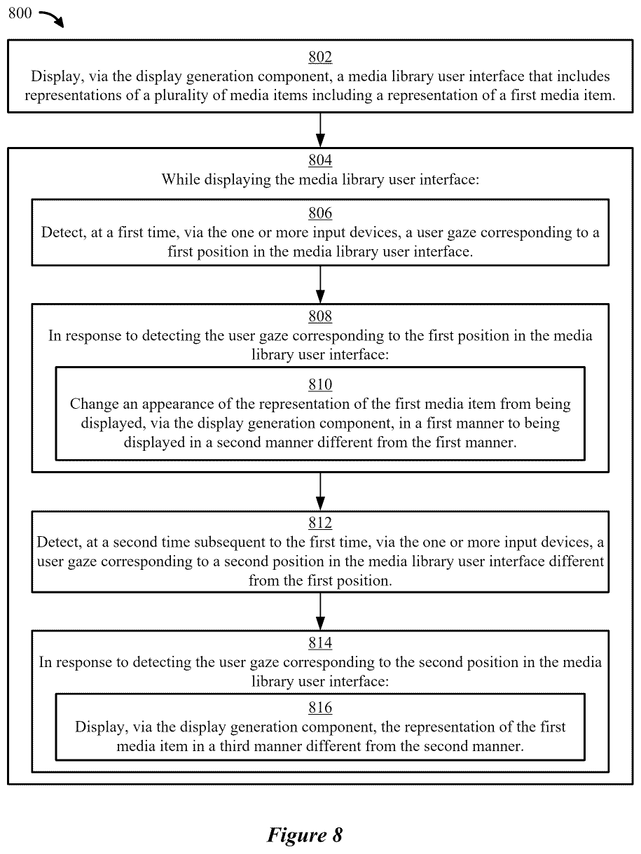

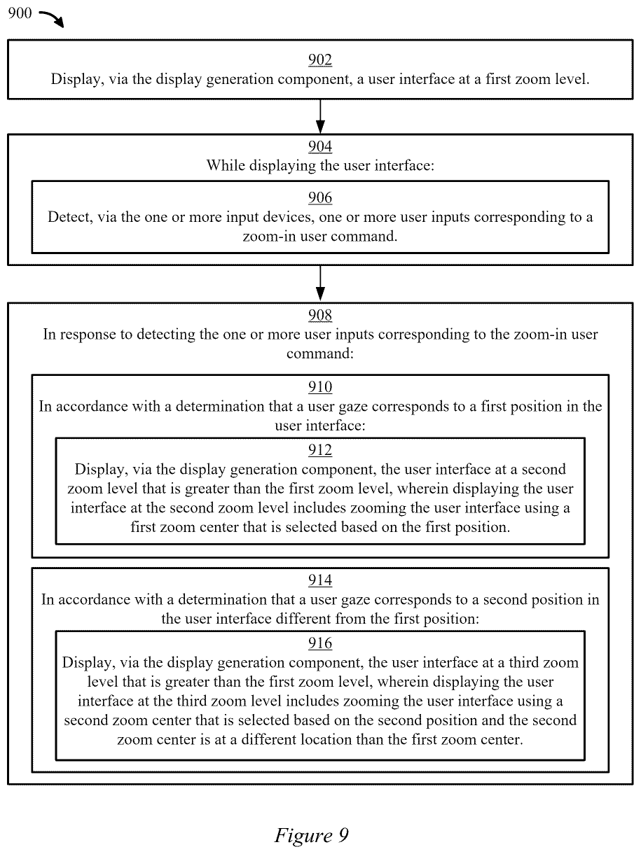

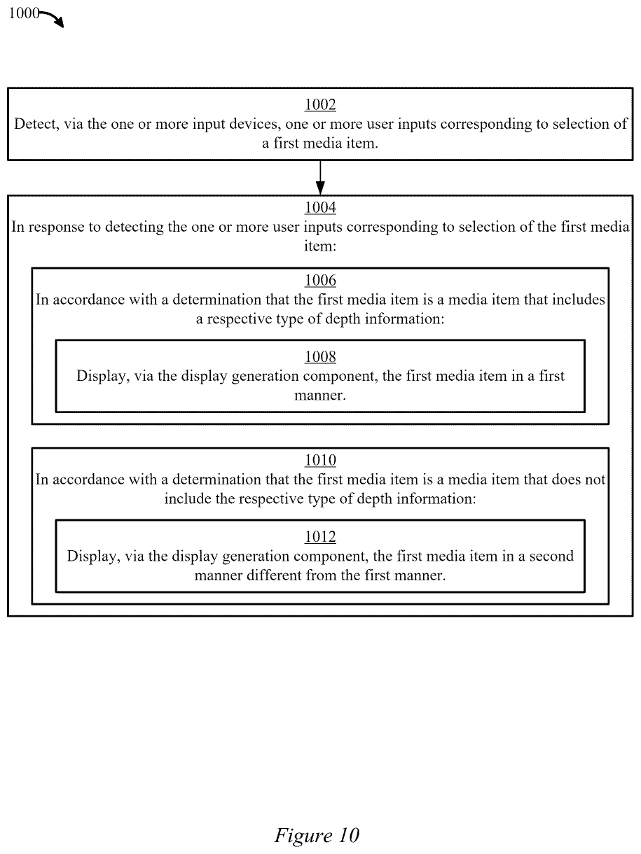

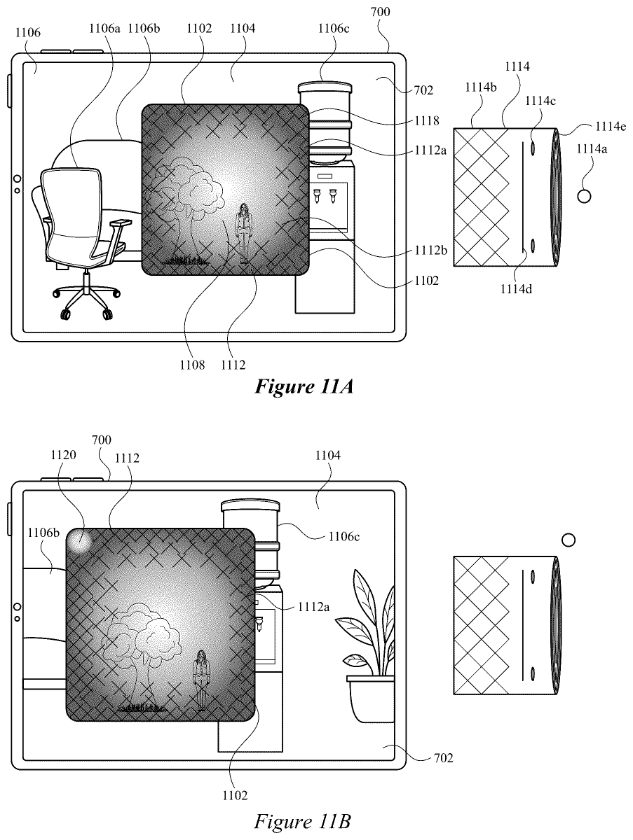

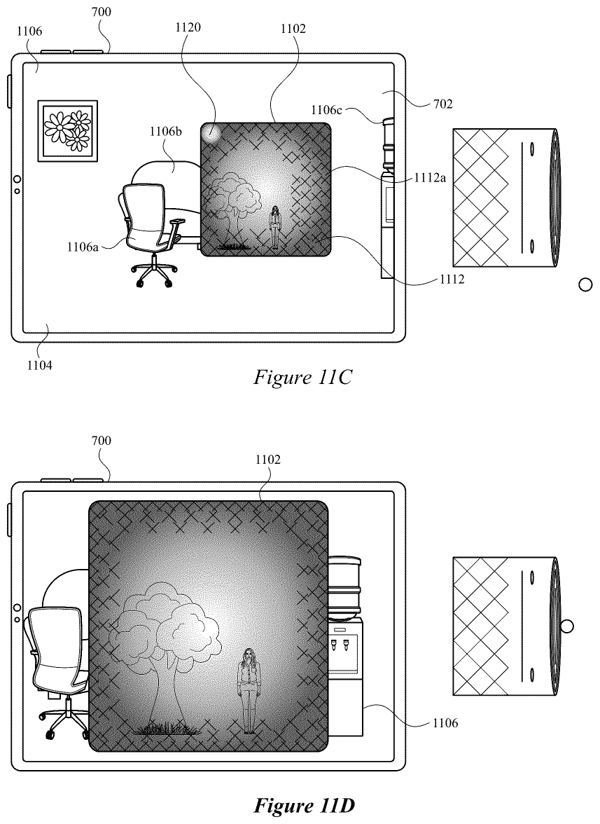

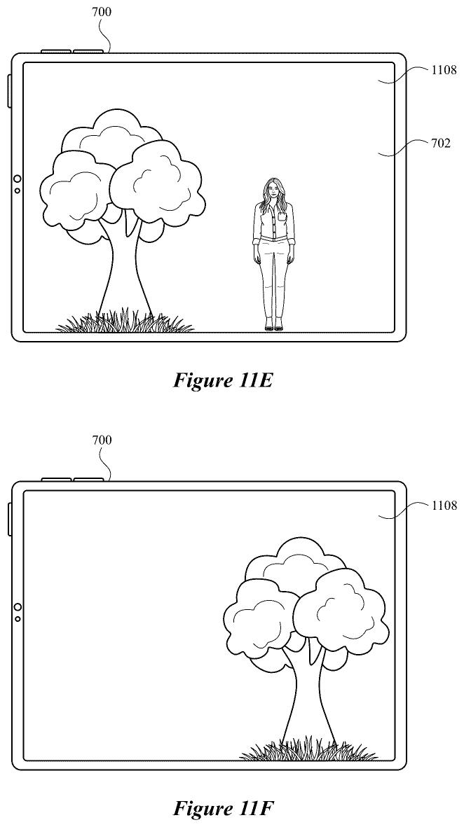

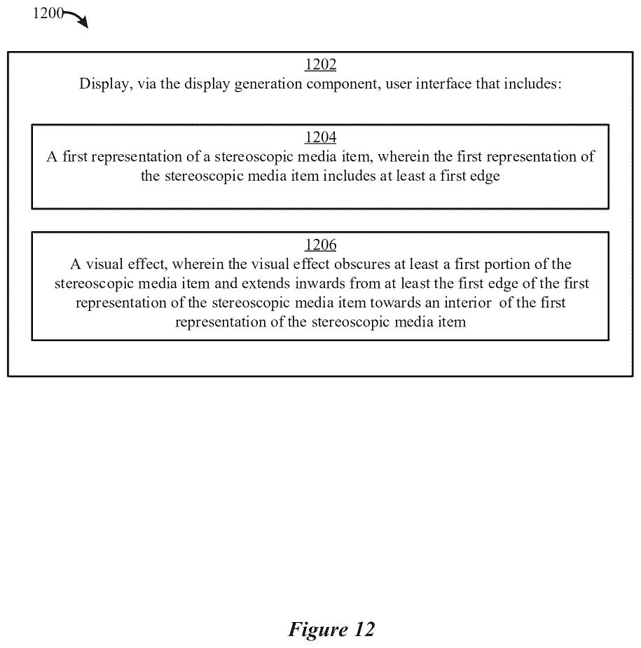

FIGS. 1-6 provide a description of example computer systems for providing XR experiences to users. FIGS. 7A-7N illustrate example techniques for interacting with media items and user interfaces, in accordance with some embodiments. FIG. 8 is a flow diagram of methods of interacting with media items and user interfaces, in accordance with various embodiments. FIG. 9 is a flow diagram of methods of interacting with media items and user interfaces, in accordance with various embodiments. FIG. 10 is a flow diagram of methods of interacting with media items and user interfaces, in accordance with various embodiments. The user interfaces in FIGS. 7A-7N are used to illustrate the processes in FIGS. 8-10. FIGS. 11A-11F illustrate example techniques for displaying media items, in accordance with some embodiments. FIG. 12 is a flow diagram of methods for displaying media items, in accordance with various embodiments. The user interfaces in FIGS. 11A-11F are used to illustrate the processes in FIG. 12.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, reducing the amount of window violation that a user experiences, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing a XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.
Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.
Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.
Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.
Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.
Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”
Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

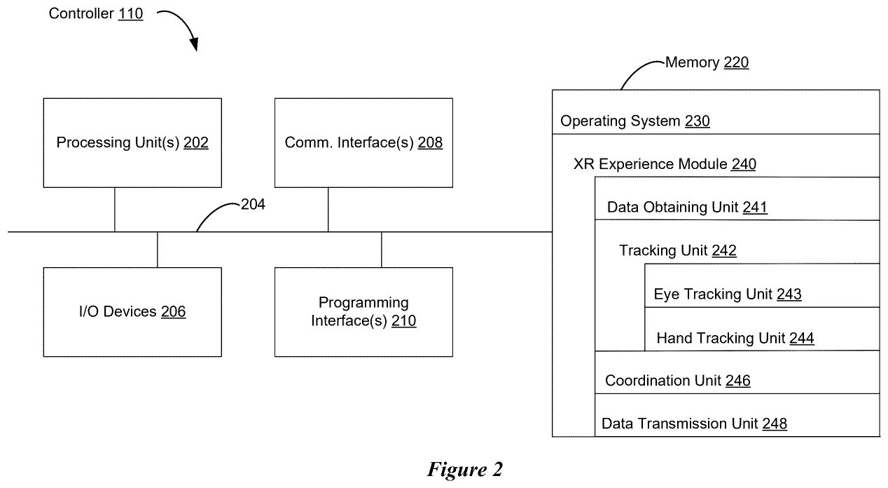

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).
Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may include speakers and/or other audio output devices integrated into the head-mounted system for providing audio output. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

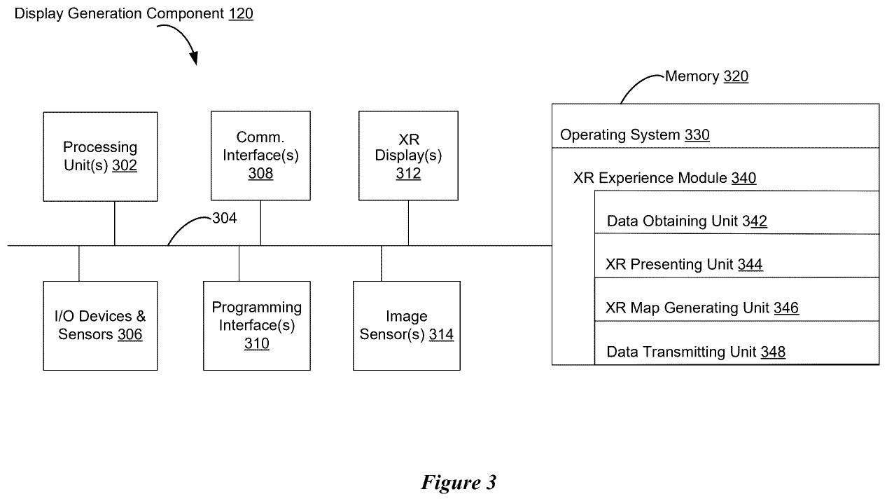

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides a XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1, those of ordinary skill in the art will appreciate from the present disclosure that various other features have not been illustrated for the sake of brevity and so as not to obscure more pertinent aspects of the example embodiments disclosed herein.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

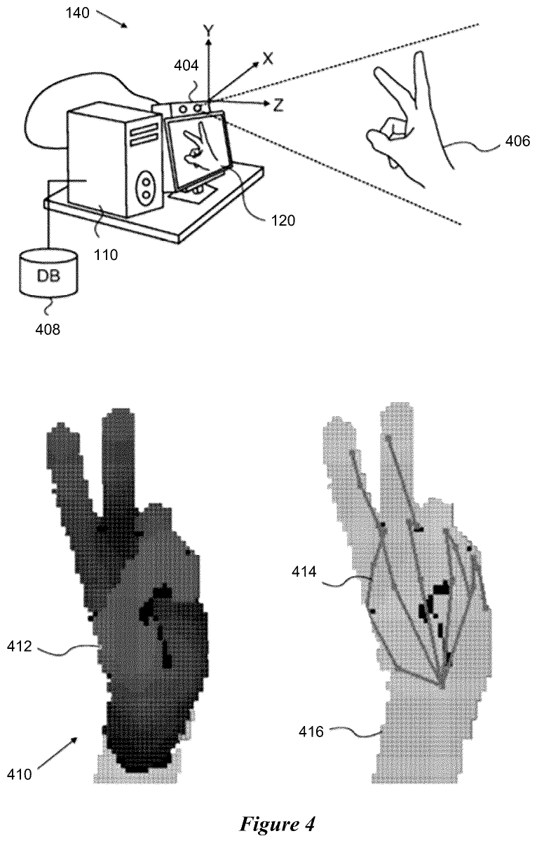

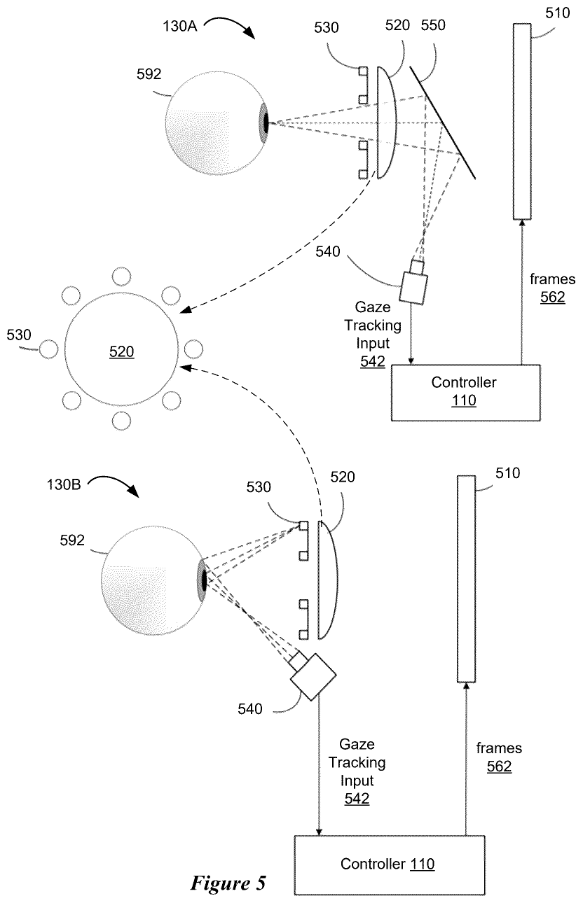

In some embodiments, the tracking unit 242 is configured to map the scene 105 and to track the position/location of at least the display generation component 120 with respect to the scene 105 of FIG. 1, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior-and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. n some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1) is controlled by hand tracking unit 244 (FIG. 2) to track the position/location of one or more portions of the user's hands, and/or motions of one or more portions of the user's hands with respect to the scene 105 of FIG. 1 (e.g., with respect to a portion of the physical environment surrounding the user, with respect to the display generation component 120, or with respect to a portion of the user (e.g., the user's face, eyes, or head), and/or relative to a coordinate system defined relative to the user's hand). In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) (or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand). In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands). In some embodiments, movement between the user's two hands (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., light sources 530 (e.g., IR or NIR LEDs)), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight light sources 530 (e.g., LEDs) are arranged around each lens 520 as an example. However, more or fewer light sources 530 may be used, and other arrangements and locations of light sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

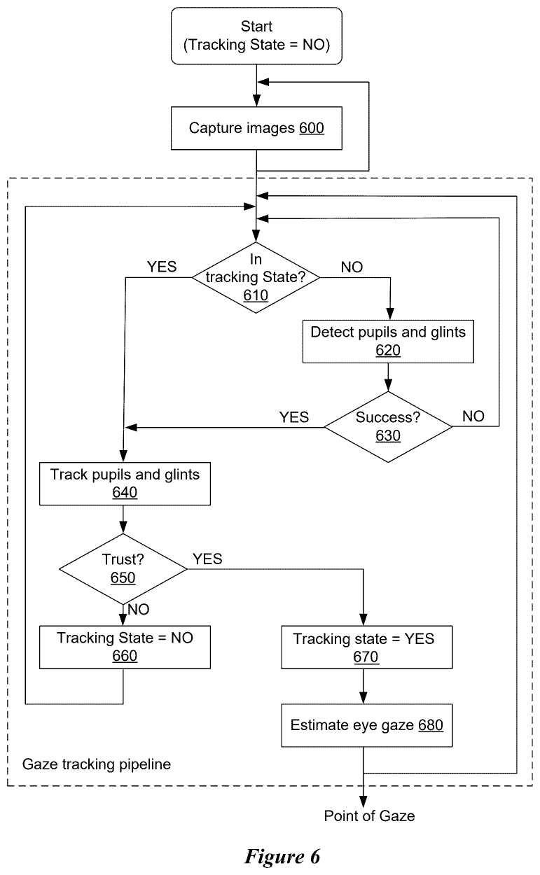

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1 and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as a portable multifunction device or a head-mounted device, in communication with a display generation component and one or more input devices.

FIGS. 7A-7N illustrate example techniques for interacting with media items and user interfaces, in accordance with some embodiments. FIGS. 8-10 are flow diagrams of exemplary methods 800, 900, and 1000, respectively, for interacting with media items and user interfaces. The user interfaces in FIGS. 7A-7N are used to illustrate the processes described below, including the processes in FIGS. 8-10.

FIG. 7A depicts computer system 700, which is a tablet that includes display device (e.g., touch-sensitive display) 702, and one or more input sensors 715 (e.g., one or more cameras, eye gaze trackers, hand movement trackers, and/or head movement trackers). In some embodiments described below, computer system 700 is a tablet. In some embodiments, computer system 700 is a smart phone, a wearable device, a wearable smartwatch device, a head-mounted system (e.g., a headset), or other computer system that includes and/or is in communication with a display device (e.g., display screen, projection device, or the like). Computer system 700 is a computer system (e.g., computer system 101 in FIG. 1).

At FIG. 7A, computer system 700 displays, via display device (e.g., touch-sensitive display or a display of an HMD) 702, media window 704 and three-dimensional environment 706. In some embodiments, three-dimensional environment 706 is displayed by a display (as depicted in FIG. 7A). In some embodiments, three-dimensional environment 706 is a virtual environment or an image (or video) of a physical environment captured by one or more cameras. In some embodiments, three-dimensional environment 706 is visible to a user behind media window 704, but is not displayed by a display. For example, in some embodiments, three-dimensional environment 706 is a physical environment that is visible to a user (e.g., through a transparent display) behind media window 704 without being displayed by a display.

At FIG. 7A, electronic 700 displays, within media window 704, media library user interface 708. Media library user interface 708 includes representations of a plurality of media items 710A-710E. In some embodiments, the plurality of media items includes photos and/or videos (e.g., stereoscopic photos and/or videos and/or non-stereoscopic photos and/or videos). In some embodiments, the plurality of media items includes a plurality of media items and/or a subset of media items from a media library (e.g., a media library associated with device 700 and/or a user of device 700). In some embodiments, the plurality of media items 710A-710E includes one or more stereoscopic media items (e.g., stereoscopic photos and/or stereoscopic videos) and one or more non-stereoscopic media items (e.g., non-stereoscopic photos and/or non-stereoscopic videos). In some embodiments, a stereoscopic media item includes a particular type of depth information, while a non-stereoscopic media item does not include the particular type of depth information. In some embodiments, a stereoscopic media item is a media item that includes at least two images that are captured at the same time using two different cameras (or two different sets of cameras). In some embodiments, a stereoscopic media item is displayed by displaying, for a first eye of a user, a first image captured by a first camera (or a first set of cameras) (e.g., without the first image being displayed for the second eye of the user), and concurrently displaying, for a second eye of the user, a second image different from the first image but captured at the same time as the first image by a second camera (or a second set of cameras) (e.g., without the second image being displayed for the first eye of the user). Non-stereoscopic images include, for example, still images captured by a single camera and/or videos captured by a single camera. In some embodiments, a non-stereoscopic media item includes, for example, multiple images that are captured by multiple cameras (e.g., captured by multiple cameras at the same time), but different images are not presented to different eyes of a user concurrently (e.g., the multiple images are combined into a single image that is presented to both eyes of the user). In some embodiments, stereoscopic media items and/or non-stereoscopic media items are captured by device 700 (e.g., using one or more cameras that are part of and/or that are in communication with device 700).

Media library user interface 708 includes options 712A-712E. Option 712A is selectable to display a set of stereoscopic media items (e.g., without displaying any non-stereoscopic media items). In some embodiments, option 712A is selectable to display a user interface that includes representations of one or more stereoscopic media items without including representations of non-stereoscopic media items. Option 712B is selectable to display a set of aggregated content items that are generated (e.g., automatically) by aggregating a plurality of media items from the media library (e.g., a collection of media items associated with a particular time, event, and/or location). Option 712C is selectable to display media library user interface 708. Option 712D is selectable to display albums of media items (e.g., collections of media items) (e.g., manually curated collections of media items and/or automatically generated collections of media items). Option 712E is selectable to initiate a process for conducting a text search for media items (e.g., selectable to display a text search user interface).

At FIG. 7A, computer system 700 displays media item 710A with a first set of visual characteristics. At FIG. 7A, computer system 700 detects (e.g., via sensors 715) that a user is gazing at media item 710A, as indicated by gaze indication 714. In some embodiments, gaze indication 714 is not displayed by computer system 700.

At FIG. 7B, in response to a determination that the user has gazed at media item 710A for a threshold duration of time (e.g., continuously without gazing at another media item), computer system 700 modifies one or more visual characteristics of media item 710A and displays media item 710A with a second set of visual characteristics different from the first set of visual characteristics.

In some embodiments, modifying one or more visual characteristics of media item 710A and/or displaying media item 710A with the second set of visual characteristics includes separating and/or expanding elements of media item 710A along a pre-defined axis (e.g., changing display of media item 710A from a two-dimensional object to a three-dimensional object). For example, in some embodiments, as a part of modifying one or more visual characteristics of media item 710A, computer system 700 expands the display of media item 710A along a respective axis of media item 710A (e.g., a z-axis of media item 710A) such that a user perceives media item 710a as a three-dimensional object with depth (e.g., thickness). In some embodiments, media item 710A is expanded along the respective axis of media item 710A based on a determination (e.g., in response to a determination) that media item 710A includes depth information (e.g., a particular type of depth information) (e.g., media item 710A is a stereoscopic media item). For example, when media item 710A is expanded along the respective axis of media item 710A, a first set of elements in media item 710A are displayed at a first depth (e.g., a first z-position along the z-axis of expanded media item 710A), and a second set of elements in media item 710A are displayed at a second depth (e.g., a second z-position on the z-axis of expanded media item 710A) different from the first depth.

In some embodiments, while gazing at media item 710A, if the user shifts his or her viewpoint (e.g., by moving and/or turning his or her head while wearing an HMD, and/or moving his or her body relative to display device 702), content within media item 710A shifts in response to the user shifting his or her viewpoint. In some embodiments, a parallax effect is implemented such that, for example, layers of media item 710A that are further from the user move more slowly (or by a smaller amount) than layers of media item 710A that are closer to the user.

In some embodiments, modifying one or more visual characteristics of media item 710A and/or displaying media item 710A with the second set of visual characteristics includes pushing media item 710A backwards (e.g., away from a user). For example, in some embodiments, in FIG. 7B, in response to the determination that the user has gazed at media item 710A for the threshold duration of time, computer system 700 maintains the displayed depth of media items 710B-710E while pushing back media item 710A. In some embodiments, media item 710A is pushed backwards based on a determination that media item 710A includes a particular type of depth information (e.g., is a stereoscopic media item).

In some embodiments, modifying one or more visual characteristics of media item 710A and/or displaying media item 710A with the second set of visual characteristics includes auto-playing (e.g., automatically playing (e.g., without further user input other than the user gaze)) media item 710A. For example, in some embodiments, if media item 710A is a video (e.g., a stereoscopic video or a non-stereoscopic video), in response to the determination that the user has gazed at media item 710A for the threshold duration of time, computer system 700 begins playing video content of media item 710A within media library user interface 708. In some embodiments, auto-playing media item 710A (e.g., in response to the user's gaze) includes applying a low pass filter (e.g., a blurring and/or smoothing filter) when playing media item 710A within media library user interface 708. In some embodiments, the low pass filter is removed when playing media item 710A in a selected state (e.g., within a selected media user interface 719, as discussed, for example, with reference to FIGS. 7M-7N below). In some embodiments, auto-playing media item 710A within media library user interface 708 includes outputting audio content of media item 710A at a lower volume than when media item 710A is played in a selected state (e.g., within a selected media user interface 719, as discussed, for example, with reference to FIGS. 7M-7N below).

In some embodiments, when the user's gaze moves away from media item 710A (e.g., to another media item 710B-710E), computer system 700 ceases displaying media item 710A with the second set of visual characteristics (e.g., ceases auto-playing media item 710A) (e.g., transitions from displaying media item 710A with the second set of visual characteristics back to displaying media item 710A with the first set of visual characteristics and/or displaying media item 710A with a third set of visual characteristics).

At FIG. 7C, while displaying media item 710A with the second set of visual characteristics, computer system 700 detects that a gaze of the user has moved to a different position within media library user interface 708 corresponding to media item 710C, as indicated by gaze indication 714. At FIG. 7C, in response to determining that the gaze of the user has moved to media item 710C, computer system 700 ceases displaying media item 710A with the second set of visual characteristics, and displays media item 710A with the first set of visual characteristics (as it was displayed in FIG. 7A). Furthermore, in response to a determination that the gaze of the user has moved to media item 710C (and, optionally, has been maintained for the threshold duration of time), computer system 700 transitions media item 710C from being displayed with a third set of visual characteristics (e.g., FIGS. 7A-7B) to being displayed with a fourth set of visual characteristics (e.g., FIG. 7C). In some embodiments, the third set of visual characteristics is the same as the first set of visual characteristics. In some embodiments, the fourth set of visual characteristics is the same as the second set of visual characteristics. In some embodiments, the examples described above with respect to transitioning from the first set of visual characteristics to the second set of visual characteristics can be applied to transitioning from the third set of visual characteristics to the fourth set of visual characteristics.

At FIG. 7C, while displaying media item 710C with the fourth set of visual characteristics within media library user interface 708, computer system 700 detects (e.g., via sensors 715) user gesture 716. In some embodiments, user gesture 716 and the various user gestures described herein include one or more touch inputs (e.g., display device 702 such as a touch-sensitive display). In some embodiments, user gesture 716 and the various user gestures described herein include one or more air gestures (e.g., movement of one or more parts of a user's body in a predefined manner) (e.g., as captured by a camera and/or a body movement sensor (e.g., a hand movement sensor and/or a head movement sensor)). In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body). In some embodiments, user gesture 716 includes a pinch and drag gesture (e.g., a pinch and drag air gesture), in which a user forms a predefined pinched shape with their hand and drags (e.g., moves) the hand making the predefined pinched shape in a particular direction (e.g., while the hand maintains the predefined pinched shape) (e.g., a pinch and drag gesture in an upward direction). In some embodiments, the predefined pinched shape is a shape in which a user contacts an area proximate the end of the thumb of one hand with the end(s) of one or more other fingers of the same hand. In some embodiments, in FIG. 7C, while displaying media library user interface 708, computer system 700 detects (e.g., via sensors 715), the hand of a user making a predefined shape (e.g., a predefined pinched shape), and detects the hand of the user moving in a predefined (e.g., upward) direction (e.g., while maintaining the predefined shape).

At FIG. 7D, in response to detecting user gesture 716, computer system 700 scrolls media library user interface 708 upward. In some embodiments, media library user interface 708 is scrolled upward based on a direction and magnitude of user gesture 716 (e.g., based on a direction and magnitude of movement of a pinch and drag gesture (e.g., based on the direction of the user's pinched hand, and how far the user's pinched hand moves)). Consequently, media library user interface 708 no longer includes media items 710A-710B, moves media items 710C-710E upwards, and now displays media item 710F. Furthermore, at FIG. 7D, computer system 700 detects that the user's gaze is directed to media item 710F, as indicated by gaze indication 714. At FIG. 7D, in response to a determination that the user's gaze has been maintained on media item 710F for a threshold duration of time, computer system 700 transitions from displaying media item 710F with a fifth set of visual characteristics (e.g., two-dimensional and/or not expanded) to displaying media item 710F with a sixth set of visual characteristics (e.g., three-dimensional and/or expanded) different from the fifth set of visual characteristics. In some embodiments, the fifth set of visual characteristics is the same as the first and/or the third set of visual characteristics. In some embodiments, the sixth set of visual characteristics is the same as the second and/or the fourth set of visual characteristics. In some embodiments, the examples described above with respect to transitioning from the first set of visual characteristics to the second set of visual characteristics can also be applied to transitioning from the fifth set of visual characteristics to the sixth set of visual characteristics.

At FIG. 7D, while the gaze of the user is maintained on media item 710F, computer system 700 detects user gesture 718. In some embodiments, user gesture 718 corresponds to a zoom-in command. In some embodiments, user gesture 718 includes a two-handed de-pinch gesture (e.g., a two-handed de-pinch air gesture) (e.g., a gesture in which two pinched hands are moved away from each other). In some embodiments, detecting the two-handed de-pinch gesture includes: computer system 700 detecting that a first hand of a user has formed a predefined shape (e.g., a pre-defined pinched shape); computer system 700 detecting that the second hand of the user has formed a predefined shape (e.g., a pre-defined pinched shape); computer system 700 detecting, at a first time, that the first hand forming the predefined shape and the second hand forming the predefined shape are a first distance from one another; and, subsequent to the second time, computer system 700 detecting that the first hand forming the predefined shape and the second hand forming the predefined shape are moved to a second distance from one another, wherein the second distance is larger than the first distance. In some embodiments, user gesture 718 includes a one-handed pinch gesture or one-handed double pinch gesture (e.g., a single hand of a user making two pinch gestures in quick succession (e.g., two pinch gestures within a threshold duration of time of one another)). In some embodiments, computer system 700 detecting the one-handed pinch gesture includes: computer system 700 detecting a pinch that includes two or more of the user's fingers moving closer together until the two fingers are within a threshold distance of one another (e.g., until the two fingers are closer to each other than the threshold distance (e.g., until the two fingers contact each other)). In some embodiments, computer system 700 detecting the one-handed double pinch gesture includes: computer system 700 detecting a first pinch that includes two or more of the user's fingers moving closer together until the two fingers are within a threshold distance of one another (e.g., until the two fingers are closer to each other than the threshold distance (e.g., until the two fingers contact each other)); and subsequent to detecting the two fingers separate, computer system 700 detecting a second pinch that includes two or more of the user's fingers moving closer together until the two fingers are within the threshold distance of one another (e.g., until the two fingers are closer to each other than the threshold distance (e.g., until the two fingers contact each other)). In some embodiments, the one-handed double pinch gesture includes detecting the second pinch within a threshold period of time of the first pinch (e.g., the second pinch is initiated and/or completed within a threshold period of time after the first pinch was initiated and/or completed).

At FIG. 7E, in response to detecting user gesture 718 corresponding to a zoom-in command while the gaze of the user is directed to media item 710F, computer system 700 zooms in on media library user interface 708 with media item 710F as a center and/or a focus of the zoom-in operation. Accordingly, in FIG. 7E, media item 710F is displayed at a larger size than in FIG. 7D. In some embodiments, had the user's gaze been directed to a different media item, the zoom-in user command would have resulted in zooming in on the different media item rather than zooming in on media item 710F. In some embodiments, the magnitude of the zoom operation (e.g., how far in computer system 700 zooms in on media library user interface 708) is determined based on a direction and/or magnitude of a two-handed de-pinch gesture (e.g., air gesture) (e.g., based on how far the user's first pinched hand moves from the user's second pinched hand). In some embodiments, when user gesture 718 is a one-handed pinch and/or a one-handed double pinch gesture (e.g., air gesture), computer system 700 zooms in on media library user interface 708 by a predetermined amount (e.g., a default amount). In some embodiments, when computer system 700 is a head-mounted device, computer system 700 separately increases the zoom level of the display of media 710F on two separate display devices of computer system 700, where each display device of computer system 700 corresponds to a respective eye of the user (e.g., each display device is visible to a respective eye of the user).

Returning to FIG. 7D, while the gaze of the user is maintained on media item 710F, computer system 700 detects user gesture 718. In some embodiments, rather than user gesture 718 corresponding to a zoom-in user command, as discussed above with reference to FIG. 7E, user gesture 718 corresponds to a media item selection command. In some embodiments, the media item selection command includes (e.g., is) a one-handed pinch gesture (e.g., air gesture) (e.g., as described above). In some embodiments, the media item selection command includes (e.g., is) a two-handed de-pinch gesture (e.g., air gesture) (e.g., as described above). In some embodiments, multiple gestures correspond to a single command (e.g., different gestures result in the same outcome).

At FIG. 7F, in response to detecting user gesture 718 corresponding to a media item selection command while the gaze of the user is directed to media item 710F, computer system 700 ceases display of media library user interface 708 within media window 704, and displays, within media window 704, media item 710F within selected media user interface 719. In some embodiments, when computer system 700 is a head-mounted device, computer system 700 displays a first representation of media item 710F (e.g. first perspective of the environment included in included media item 710F) to a first eye of the user and computer system 700 displays a second representation of media item 710F (e.g., a second perspective of the environment included in media item 710F) to a second eye of the user such that a user views media item 710F with a stereoscopic depth effect.

In some embodiments, user gesture 718 of FIG. 7D, which, in the scenario depicted in FIG. 7F, corresponds to a media item selection command, includes one or more intermediate states. For example, if the media item selection command is a one-handed pinch gesture, a user can slowly and/or gradually move their index finger closer to their thumb to perform the pinch gesture. In some embodiments, as the user progresses in the media item selection command, one or more separated elements of media item 710F in FIG. 7D gradually move closer to one another (e.g., along a pre-defined axis (e.g., along a z-axis)). In some embodiments, when the user gesture surpasses a completion threshold, media item 710F is displayed in selected media user interface 719 with the one or more elements re-expanded (e.g., as seen in FIG. 7F). In some embodiments, if the user ceases to perform the media item selection gesture before the completion threshold is reached (e.g., the user stops the pinch gesture before reaching the completion threshold and/or spreads his or her index finger and thumb back apart before reaching the completion threshold), the elements of media item 710F in FIG. 7D re-expand and/or separate within media library user interface 708. In some embodiments, as the user progresses in the media item selection command, other media items in FIG. 7D (e.g., media items 710C-710E) are gradually blurred (e.g., become more blurry as the media item selection command progresses towards the completion threshold). In some embodiments, certain types of user gestures result in display of intermediate stages between FIG. 7D and FIG. 7F (e.g., gradual blurring of media items and/or gradual movement of media item layers and/or elements closer together) while other types of user gestures cause a transition immediately from the media library user interface 708 in FIG. 7D to the selected media user interface 719 in FIG. 7F without displaying the intermediate stages. For example, in some embodiments, a quick one-handed pinch gesture (e.g., a one-handed pinch gesture that is completed within a threshold period of time) results in a transition immediately from media library user interface 708 to selected media user interface 719 without displaying intermediate states, while a slow one-handed pinch gesture or a two-handed de-pinch gesture will display intermediate states while transitioning from media library user interface 708 to selected media user interface 719 based on the user gesture.

It can be seen in FIG. 7F that when selected media user interface 719 is displayed, three-dimensional environment 706 is darkened. Furthermore, media window 704 is displayed with one or more lighting effects 726-1 extending from media window 704 (e.g., into three-dimensional environment 706). In some embodiments, when opening a media item (e.g., when transitioning from media library user interface 708 to selected media user interface 719), lighting effects (e.g., 726-1) extending from media window 704 and lighting effects applied to three-dimensional environment 706 are gradually implemented and/or displayed. For example, in some embodiments, from FIG. 7D to FIG. 7F, in response to user gesture 718 (a media item selection command), the size of media item 710F is gradually increased to fill media window 704, three-dimensional environment 706 is gradually darkened, and lighting effects 726-1 gradually extend from media window 704 and gradually increase in intensity. Similarly, in some embodiments, when a media item is closed (e.g., to transition from selected media user interface 719 to media library user interface 708), lighting effects extending from media window 704 and applied to three-dimensional environment 706 are gradually removed (e.g., lighting effects 726-1 gradually decrease in intensity and size, and three-dimensional environment 706 is gradually brightened). In some embodiments, when computer system 700 is a head mounted device, computer system 700 changes the appearance of lighting effects 726-1 in response to the user rotating their head and/or walking around the physical environment (e.g., while wearing computer system 700). In some embodiments, lighting effects 726-1 include a plurality of light rays extending from media window 704. In some embodiments, visual characteristics for the plurality of light rays (e.g., the length of one or more light rays, the color(s) of one or more light rays, and/or the brightness and/or intensity of one or more light rays) are determined based on visual content of the displayed media item (e.g., the media item displayed within selected media user interface 719). In some embodiments, visual content at the edge of media window 704 (e.g., visual content within a threshold distance of the edge and/or border of media window 704) is weighted more heavily than content interior to the edge of media window 704 in determining visual characteristics for the plurality of light rays. In some embodiments, one or more light rays have a variable length, variable colors, variable brightness, and/or variable intensity (e.g., based on visual content of the displayed media item). As such, in some embodiments, when the visual content of the displayed media item changes (e.g., the displayed media item changes from one media item to another, the displayed media item is a video that has changing visual content as the video is played, and/or the user zooms in or out within a media item), lighting effects 726-1, including the plurality of light rays, change accordingly. In some embodiments, changes in lighting effects 726-1 (e.g., a plurality of light rays) are smoothed over time when the displayed media item is a video. In some embodiments, lighting effects 726-1 includes light rays that extend (e.g., extend forward) from a front surface of media window 704 (e.g., front layer 720) and light rays that extend (e.g., extend backward) from a rear surface of media window 704 (e.g., rear layer 722).

In some embodiments, lighting effects 726-1 extend from media window 704 regardless of whether the displayed media item (e.g., the media item displayed within selected media user interface 719) is a stereoscopic media item or a non-stereoscopic media item. In some embodiments, the light rays extending from media window 704 differ based on whether the depicted media item is a stereoscopic media item (e.g., as depicted in FIGS. 7F, 7G, 7H, and 7N) or whether the depicted media item is a non-stereoscopic media item (e.g., as depicted in FIGS. 7J-7M). For example, one or more algorithms used to determine visual characteristics of the light rays differ based on whether the displayed media item is a stereoscopic media item or a non-stereoscopic media item. In some embodiments, the light rays (or the algorithms used to determine visual characteristics of the light rays) do not differ based on whether the displayed media item is a stereoscopic media item or a non-stereoscopic media item.

In some embodiments, visual characteristics of a media item, media window 704, and/or three-dimensional environment 706 depend on whether the displayed media item is a stereoscopic media item or a non-stereoscopic media item. In FIG. 7F, the displayed media item is a stereoscopic media item. Based on a determination that the displayed media item is a stereoscopic media item, computer system 700 displays the media item with a set of visual characteristics that correspond to stereoscopic media items. For example, in the depicted embodiment, media window 704 displays the displayed media item in a three-dimensional manner with elements of the media item expanded along an axis. In the depicted embodiment, media window 704 is shown with front layer 720, rear layer 722, and one or more intermediate layers 724 between front layer 720 and rear layer 722. In some embodiments, when computer system 700 is a head mounted device, computer system 700 displays a different perspective of the displayed media item within media window 704 in response to a user repositioning themselves within a physical environment and/or rotating their head (e.g., while wearing computer system 700 on their head).

In some embodiments, in accordance with a determination that the displayed media item is a stereoscopic media item, the displayed media item is displayed within a continuous three-dimensional shape with continuous edges (e.g., media window 704 is a continuous three-dimensional shape with continuous edges). FIG. 7I shows a side profile view of an example embodiment of a continuous three-dimensional shape with continuous edges, with front layer 720 shown as a left surface of the shape in FIG. 7I, and rear layer 722 shown as a right surface of the shape in FIG. 7I. In some embodiments, as shown in FIG. 7I, the three-dimensional shape of media window 704 has a curved front surface and/or a curved back surface. In some embodiments, the three-dimensional shape of media window 704 has refractive edges (e.g., blurred and/or glassy edges). In contrast, in some embodiments, in accordance with a determination that the displayed media item is a non-stereoscopic media item, the displayed media item is displayed within and/or as a two-dimensional object (as depicted in FIG. 7J) (e.g., media window 704 is a two-dimensional object and/or shape). In some embodiments, when computer system 700 is a head mounted device, computer system 700 displays different perspectives of the three-dimensional shape of the stereoscopic media item in response to a user repositioning themselves within a physical environment and/or rotating their head (e.g., while the user wears computer system 700 on their head).

In FIG. 7F, computer system 700 also displays share option 728A, time and location information 728B, and close option 728C. Share option 728A is selectable to displayed one or more options for sharing the displayed media item. Time and location information 728B displays time and location information 728B corresponding to the displayed media item (e.g., time and location of capture for the displayed media item). Close option 728C is selectable to close the displayed media item (e.g., selectable to cease displaying selected media user interface 719 and re-display media library user interface 708). In some embodiments, in accordance with a determination that the displayed media item is a stereoscopic media item, one or more controls, such as share option 728A, date and time information 728B, and close option 728C, are displayed (e.g., outside of media window 704 and/or in a manner such that the one or more controls do not overlap and/or overlay the displayed stereoscopic media item 710F).

In some embodiments, when a media item is displayed in selected media user interface 719, the media item is displayed with vignetting applied to the media item (e.g., darkened corners and/or edges) (e.g., regardless of whether the displayed media item is a stereoscopic media item or a non-stereoscopic media item). In some embodiments, when a media item is displayed in selected media user interface 719, the media item is optionally displayed in an immersive state. In some embodiments, if a first set of conditions is met, the media item is displayed in an immersive state, and if the first set of conditions is not met, the media item is not displayed in the immersive state. In various embodiments, the first set of conditions includes, for example, one or more of: a determination that a first user setting (e.g., an immersive viewing setting) is enabled and/or disabled; a determination that the first media item is of a particular type (e.g., stereoscopic as compared to non-stereoscopic) (e.g., in accordance with a determination that the first media item is a stereoscopic media item); and/or a determination that one or more user inputs of a particular type (e.g., one or more gestures (e.g., one or more air gestures)) are detected. In some embodiments, a non-immersive state corresponds to a first angular size, and the immersive state corresponds to a second angular size that is greater than the first angular size. In other words, in an immersive state, the displayed media item is displayed at a greater angular display size, and in a non-immersive state, the displayed media item is displayed at a smaller angular display size. In some embodiments, when the media item is displayed in the immersive state and when computer system 700 is a head mounted device, computer system 700 displays different perspectives of the media item based on a user repositioning themselves within a physical environment and/or rotating their head (e.g., while the user wears computer system 700 on their head).

At FIG. 7F, while displaying media item 710F in selected media user interface 719, computer system 700 detects user gesture 732. Various different scenarios corresponding to different types of user gestures for user gesture 732 will be described in turn below.

In a first scenario, user gesture 732 corresponds to a close media item command to, for example, cease displaying selected media user interface 719 and/or re-display media library user interface 708. In some embodiments, the close media item command includes a pinch and drag gesture (e.g., air gesture) (e.g., a pinch and drag gesture in a predefined direction (e.g., a pinch and drag gesture in a downward direction)). In some embodiments, a pinch and drag gesture in a first direction (e.g., left) corresponds to a next media item command to display a subsequent media item within selected media user interface 719 (e.g., an immediate next media item within an ordered sequence of media items), a pinch and drag gesture in a second direction (e.g., a second direction opposite the first direction) (e.g., right) corresponds to a previous media item command to display a previous media item within selected media user interface 719 (e.g., an immediately previous media item within an ordered sequence of media items), and a pinch and drag gesture in a third direction (e.g., down) corresponds to a close media item command. As described above, in some embodiments, computer system 700 detecting a pinch and drag gesture (e.g., a pinch and drag air gesture) includes: computer system 700 detecting that the hand of a user forms a predefined shape (e.g., a predefined pinched shape); and computer system 700 detecting movement of the hand forming the predefined shape (e.g., while the hand of the user forms and/or maintains the predefined shape) in a particular direction. In some embodiments, computer system 700 detecting the pinch and drag gesture further includes computer system 700 detecting movement of the hand forming the predefined shape in a particular direction and for at least a threshold distance.

In a second scenario, user gesture 732 corresponds to a zoom in command (e.g., a one-handed double pinch gesture or a two-handed de-pinch gesture, various embodiments of which were described above with reference to FIG. 7D) that is received while the gaze of the user is detected at a bottom right corner of media window 704 as indicated by gaze indication 714-1. In a third scenario, user gesture 732 corresponds to a zoom in command that is received while the gaze of the user is detected at a top left corner of media window 704 as indicated by gaze indication 714-2. In the second scenario, in response to user gesture 732 corresponding to the zoom in command while the gaze of the user is directed at the bottom right corner of media window 704, computer system 700 zooms in on the bottom right corner of media window 704, as depicted in FIG. 7G. In the third scenario, in response to user gesture 732 corresponding to the zoom in command while the gaze of the user is directed at the top left corner of media window 704, computer system 700 zooms in on the top left corner of media window 704, as depicted in FIG. 7H.

FIG. 7J depicts selected media user interface 719 displaying non-stereoscopic media item 731. In FIG. 7J, media item 731 is a panoramic non-stereoscopic image. In FIG. 7J, three-dimensional environment 706 is darkened, as it was in FIG. 7F, and lighting effects 730-1 extend from media window 704. Like lighting effects 726-1 discussed above with reference to FIG. 7F, in some embodiments, lighting effects 730-1 are determined based on visual content depicted in media window 704 (e.g., visual content of displayed media item 731). In some embodiments, lighting effects 730-1 differ from lighting effects 726-1 based on the differences in the displayed visual content in media window 704, but the algorithms used to generate and/or determine lighting effects 730-1 are the same as the algorithms used to generate and/or determine lighting effects 726-1. In some embodiments, the algorithms used to generate and/or determine lighting effects 730-1 are different from the algorithms used to generate and/or determine lighting effects 726-1 based on the fact that media item 731 is a non-stereoscopic media item and media item 710F was a stereoscopic media item. In some embodiments, the various characteristics of lighting effects 726-1 as described above with reference to FIG. 7F are applicable to lighting effects 730-1, and the other lighting effects described herein (e.g., 730-2, 730-3, 730-4, 726-2, 726-3, and/or 726-4). In some embodiments, when computer system 700 is a head mounted device, computer system 700 does not display various perspectives of the content included in media item 731 in response to a user walking around a physical environment and/or turning their head (e.g., while the user wears computer system 700 on their head) as a result of media item 731 being a non-stereoscopic media item.

In some embodiments, certain visual characteristics of media window 704 and selected media user interface 719 in FIG. 7J differ from those of FIG. 7F based on a determination that displayed media item 731 is a non-stereoscopic media item. For example, in some embodiments, based on a determination that displayed media item 731 in FIG. 7J is a non-stereoscopic media item, one or more controls, such as share option 728A, time and location information 728B, and close option 728C are displayed overlaid on displayed media item 731. In another example, in some embodiments, based on a determination that displayed media item 731 in FIG. 7J is a non-stereoscopic media item, media item 731 is displayed within and/or as a two-dimensional object (whereas media item 710F in FIG. 7F was displayed within a three-dimensional object). Other differences between stereoscopic and non-stereoscopic media items were described in greater detail above with reference to FIG. 7F.

At FIG. 7J, while displaying non-stereoscopic panoramic media item 731 within selected media user interface 719, computer system 700 detects (e.g., via sensors 715) user gesture 733. In the depicted scenario, user gesture 733 corresponds to a zoom-in command. In some embodiments, the zoom-in command includes a one-handed double pinch gesture and/or a two-handed de-pinch gesture, as described above (e.g., with reference to FIG. 7D). Furthermore, at FIG. 7J, computer system 700 detects, while detecting user gesture 733, a user gaze directed at a first position within displayed media item 731, as indicated by gaze indication 714.

At FIG. 7K, in response to detecting user gesture 733 (e.g., the zoom-in command) while the gaze of the user was directed to the first position in displayed media item 731, computer system 700 zooms in on media item 731 with the first position as a center point of the zoom-in operation. Furthermore, at FIG. 7K, in response to detecting user gesture 733 (e.g., the zoom-in command) and in accordance with a determination that displayed media item 731 is a panoramic media item, computer system 700 enlarges the size of media window 704, and also curves media window 704. At FIG. 7K, lighting effects 730-2 extend from media window 704. In some embodiments, lighting effects 730-2 differ from lighting effects 730-1 based on the changing visual content that is being displayed in media window 704. In some embodiments, when computer system 700 is a head mounted device, display of media window 704 occupies a larger field-of-view of the user while media window 704 is displayed with the curved appearance (e.g., in contrast to when media window 704 is displayed without the curved appearance).

At FIG. 7K, computer system 700 detects (e.g., via sensors 715) user gesture 734. In some embodiments, user gesture 734 is a continuation of the zoom-in command of user gesture 733 (e.g., a continuation of a two-handed de-pinch gesture (e.g., various embodiments of which were described above (e.g., with reference to FIG. 7D))). Furthermore, at FIG. 7K, computer system 700 detects, while detecting user gesture 734, a user gaze directed at a second position within the displayed media item, as indicated by gaze indication 714.

At FIG. 7L, in response to detecting user gesture 734 (e.g., the zoom-in command (e.g., various embodiments of which were described above (e.g., with reference to FIG. 7D))) while the gaze of the user was directed to the second position in the displayed media item, computer system 700 further zooms in on panoramic media item 731 with the second position as the center point of the zoom-in operation. Furthermore, in FIG. 7L, in response to detecting user gesture 734 (e.g., the zoom-in command) and in accordance with a determination that displayed media item 731 is a panoramic media item, computer system 700 further enlarges the size of media window 704, and further curves media window 704. At FIG. 7L, lighting effects 730-3 extend from media window 704. In some embodiments, lighting effects 730-3 differ from lighting effects 730-2 and 730-1 based on the changing visual content that is being displayed in media window 704.

Furthermore, in FIG. 7L, as media item 731 is further zoomed in, media item 731 is zoomed in sufficiently that certain content on the left and right sides of media item 731 is no longer visible within media window 704. In FIG. 7L, in accordance with a determination that there is additional content on the left side of media item 731 that is not visible in media window 704, computer system 700 displays visual effect 736A on a left side of media window 704. Similarly, in accordance with a determination that there is additional content on the right side of media item 731 that is not visible in media window 704, computer system 700 displays visual effect 736B on the right side of media window 704. In some embodiments, visual effect 736A includes blurring and/or visually obscuring the left edge of media window 704, and visual effect 736B includes blurring and/or visually obscuring the right edge of media window 704.

At FIG. 7L, while displaying media item 731 in selected media user interface 719, computer system 700 detects user gesture 738. In some embodiments, user gesture 738 corresponds to a previous content item command (e.g., a pinch and drag gesture in a first (e.g., right) direction (e.g., various embodiments of which were described above (e.g., with reference to FIGS. 7D and 7F))) and/or a next content item command (e.g., a pinch and drag gesture in a second (e.g., left) direction (e.g., various embodiments of which were described above (e.g., with reference to FIGS. 7D and 7F))).

At FIG. 7M, in response to detecting user gesture 738, computer system 700 ceases displaying media item 731 of FIG. 7L within selected media user interface 719, and displays non-stereoscopic video media item 741 within selected media user interface 719. In FIG. 7M, in accordance with a determination that depicted media item 741 is a non-stereoscopic media item, one or more controls are displayed overlaid on the media item. The one or more controls include, for example, share option 728A, time and location information 728B, and close option 728C, as well as scrubber 740. Scrubber 740 can be manipulated by a user (e.g., a user can interact with scrubber 740) to navigate within video media item 741, and also includes one or more playback controls, such as a pause button, a play button, a fast forward button, and/or a rewind button. In FIG. 7M, lighting effects 730-4 extend from media window 704. As discussed above with reference to FIG. 7F, in some embodiments, lighting effects for a video are smoothed over time such that lighting effects at a respective time in the video are determined based on a plurality of video frames (e.g., a plurality of video frames immediately before and/or immediately after the respective time).

At FIG. 7M, while displaying non-stereoscopic video media item 741 in selected media user interface 719, computer system 700 detects user gesture 742. In some embodiments, user gesture 742 corresponds to a previous content item command (e.g., a pinch and drag gesture in a first (e.g., right) direction (e.g., various embodiments of which were described above (e.g., with reference to FIGS. 7D and 7F))) and/or a next content item command (e.g., a pinch and drag gesture in a second (e.g., left) direction (e.g., various embodiments of which were described above (e.g., with reference to FIGS. 7D and 7F))).

At FIG. 7N, in response to detecting user gesture 742, computer system 700 ceases displaying non-stereoscopic video media item 741 of FIG. 7M within selected media user interface 719, and displays stereoscopic video media item 743 within selected media user interface 719. In FIG. 7N, in accordance with a determination that depicted media item 743 is a stereoscopic media item, one or more controls (e.g., share option 728A, time and location information 728B, close option 728C, scrubber 740) are displayed (e.g., outside of and/or not overlapping) media window 704. In some embodiments, the one or more controls (e.g., 728A, 728B, 728C, and/or 740) are displayed when a hand of the user is in a first position (e.g., a raised position) and are hidden/not displayed when the hand of the user is not in the first position (e.g., when the hand of the user is in a lowered position). In some embodiments, the one or more controls are displayed when the hand of the user is in the first position and are hidden when the hand of the user is not in the first position regardless of whether the displayed media item is a stereoscopic media item or a non-stereoscopic media item. In some embodiments, the one or more controls are displayed when the hand of the user is in the first position and are hidden when the hand of the user is not in the first position regardless of whether the displayed media item is a still image or a video.

Furthermore, in accordance with a determination that depicted media item 743 is a stereoscopic media item, media item 743 is displayed within a three-dimensional shape with multiple layers (e.g., 720, 722, and 724). In FIG. 7N, lighting effects 726-4 extend from media window 704. As discussed above with reference to FIG. 7F and FIG. 7M, in some embodiments, lighting effects for a video are smoothed over time such that lighting effects at a respective time in the video are determined based on a plurality of video frames (e.g., a plurality of video frames immediately before and/or immediately after the respective time).

Additional descriptions regarding FIGS. 7A-7N are provided below in reference to methods 800, 900, and 1000 described with reference to FIGS. 8-10.

FIG. 8 is a flow diagram of an exemplary method 800 for interacting with media items and user interfaces, in accordance with some embodiments. In some embodiments, method 800 is performed at a computer system (e.g., 700) (e.g., computer system 101 in FIG. 1) (e.g., a smart phone, a smart watch, a tablet, and/or a wearable device) that is in communication with a display generation component (e.g., 702) (e.g., a display controller; a touch-sensitive display system; a display (e.g., integrated and/or connected), a 3D display, a transparent display, a projector, and/or a heads-up display) and one or more input devices (e.g., 715) (e.g., a touch-sensitive surface (e.g., a touch-sensitive display); a mouse; a keyboard; a remote control; a visual input device (e.g., a camera); an audio input device (e.g., a microphone); and/or a biometric sensor (e.g., a fingerprint sensor, a face identification sensor, and/or an iris identification sensor)). In some embodiments, the method 800 is governed by instructions that are stored in a non-transitory (or transitory) computer-readable storage medium and that are executed by one or more processors of a computer system, such as the one or more processors 202 of computer system 101 (e.g., control 110 in FIG. 1). Some operations in method 800 are, optionally, combined and/or the order of some operations is, optionally, changed.

In some embodiments, the computer system (e.g., 700) displays (802), via the display generation component (e.g., 702), a media library user interface (e.g., 708) that includes representations (e.g., thumbnails and/or previews) of a plurality of media items (e.g., 710A-710F) (e.g., images, photos, and/or videos) including a representation of a first media item (e.g., 710A-710F).

While displaying the media library user interface (804), the computer system detects (806), at a first time, via the one or more input devices, a user gaze (e.g., 714) corresponding to a first position in the media library user interface (e.g., detects and/or determines that a user is gazing at the first position in the media library user interface). In some embodiments, the first position in the media library user interface is a position that corresponds to the representation of the first media item or is a position in the media library user interface that does not correspond to the representation of the first media item (e.g., corresponds to a representation of a second media item different from the first media item).

In response to detecting the user gaze corresponding to the first position in the media library user interface (808), the computer system changes (810) an appearance of the representation of the first media item from being displayed, via the display generation component, in a first manner (e.g., with a first set of visual characteristics) to being displayed in a second manner different from the first manner (e.g., with a second set of visual characteristics) (e.g., media item 710A in FIGS. 7A-7B and/or media item 710C in FIGS. 7B-7C).

The computer system detects (812), at a second time subsequent to the first time (e.g., after or while displaying the representation of the first media item in a second manner), via the one or more input devices, a user gaze corresponding to a second position in the media library user interface (e.g., 714 in FIG. 7C) (e.g., detects and/or determines that the user is gazing at the second position in the media library user interface). In some embodiments, the second position in the media library user interface is a position that corresponds to the representation of the first media item or a position in the media library user interface that does not correspond to the representation of the first media item (e.g., corresponds to a representation of a second media item different from the first media item)) different from the first position.

In response to detecting the user gaze corresponding to the second position in the media library user interface (814), the computer system displays (816), via the display generation component, the representation of the first media item in a third manner different from the second manner (e.g., with a third set of visual characteristics different from the second set of visual characteristics) (e.g., media item 710A from FIG. 7B to FIG. 7C). In some embodiments, the third manner is the same as the first manner.

Changing the appearance of the representation of the first media item from being displayed in the first manner to being displayed in the second manner in response to detecting the user gaze corresponding to the first position in the media library user interface provides the user with visual feedback about the state of the system (e.g., that the user gaze corresponding the first position has been detected), which provides improved visual feedback.

In some embodiments, the computer system displays (e.g., at a third time subsequent to the second time), via the display generation component, the media library user interface (e.g., 708) that includes representations (e.g., thumbnails and/or previews) of the plurality of media items (e.g., 710A-710F) (e.g., images, photos, and/or videos) including a representation of a second media item different from the first media item. While displaying the media library user interface including the representation of the second media item, the computer system detects (e.g., at a fourth time subsequent to the third time), via the one or more input devices, a user gaze corresponding to a third position in the media library user interface (e.g., 714 in FIG. 7C) (e.g., the second position or a third position different from the first position and/or the second position) (e.g., detects and/or determines that a user is gazing at the third position in the media library user interface) (e.g., a third position in the media library user interface that corresponds to the representation of the second media item or a third position in the media library user interface that does not correspond to the representation of the second media item (e.g., corresponds to a representation of a third media item different from the second media item)). In response to detecting the user gaze corresponding to the third position in the media library user interface, the computer system changes an appearance of the representation of the second media item (e.g., 710C) from being displayed in a fourth manner (e.g., with a fourth set of visual characteristics) (in some embodiments, the fourth manner is the same as the first manner, the second manner, and/or the third manner) to being displayed in a fifth manner different from the fourth manner (e.g., media item 710C in FIG. 7B to FIG. 7C) (e.g., with a fifth set of visual characteristics different from the fourth set of visual characteristics). In some embodiments, the fifth manner is the same as the first manner, the second manner, and/or the third manner.

In some embodiments, the computer system detects (e.g., at a fifth time subsequent to the fourth time) (e.g., after or while displaying the representation of the second media item in the fifth manner), via the one or more input devices, a user gaze corresponding to a fourth position in the media library user interface (e.g., detecting and/or determining that the user is gazing at the fourth position in the media library user interface) (e.g., a fourth position in the media library user interface that corresponds to the representation of the second media item or a fourth position in the media library user interface that does not correspond to the representation of the second media item (e.g., corresponds to a representation of a third media item different from the second media item)) different from the third position. In response to detecting the user gaze corresponding to the fourth position in the media library user interface, the computer system displays, via the display generation component, the representation of the second media item in a sixth manner different from the fifth manner (e.g., with a sixth set of visual characteristics different from the fifth set of visual characteristics). In some embodiments, the sixth manner is the same as the fourth manner.

Changing the appearance of the representation of the second media item from being displayed in the fourth manner to being displayed in the fifth manner in response to detecting the user gaze corresponding to the third position in the media library user interface provides the user with visual feedback about the state of the system (e.g., that the user gaze corresponding the third position has been detected), which provides improved visual feedback.

In some embodiments, the first media item (e.g., 710A) includes a plurality of elements including a first element and a second element. In some embodiments, displaying the representation of the first media item in the first manner includes displaying the first element and the second element within a first two-dimensional plane (e.g., media item 710A in FIG. 7A) (e.g., a two-dimensional plane that includes a first dimension and a second dimension different from the first dimension (e.g., perpendicular to the first dimension)) (e.g., displaying the first element and the second element within a two-dimensional object and/or as part of a single two-dimensional object). In some embodiments, displaying the representation of the first media item in the second manner includes separating the first element and the second element along a third dimension that extends outside of the first two-dimensional plane (e.g., media item 710A in FIG. 7B) (e.g., a third dimension perpendicular to the first two-dimensional plane).

In some embodiments: the media library user interface defines a first plane having an x-axis and a y-axis perpendicular to the x-axis (e.g., the media library user interface includes at least one planar surface, wherein the planar surface defines an x-axis and a y-axis) (in some embodiments, the representations of the plurality of media items are displayed on (e.g., within) the first plane); the first media item includes a plurality of elements including a first element and a second element; displaying the representation of the first media item in the first manner includes displaying the plurality of elements at a first position on a z-axis, wherein the z-axis is perpendicular to both the x-axis and the y-axis (e.g., the representation of the first media item is displayed as a two-dimensional object) (e.g., the plurality of elements in the first media item are displayed on a single two-dimensional plane (e.g., the first plane)) (in some embodiments, when displayed in the first manner, the representation of the first media item is displayed as a two-dimensional, planar object that is presented within the first plane) (in some embodiments, the first plane defined by the media library user interface is positioned at the first position on the z-axis); and displaying the representation of the first media item in the second manner includes concurrently displaying: the first element at a second position on the z-axis (in some embodiments, the second position on the z-axis is the same as the first position on the z-axis or different from the first position on the z-axis); and the second element at a third position on the z-axis different from the second position.

In some embodiments, the first media item includes a third element, and displaying the representation of the first media item in the second manner includes concurrently displaying: the first element at the second position on the z-axis; the second element at the third position on the z-axis different from the second position; and the third element at a fourth position on the z-axis different from the second and third positions.

Changing the appearance of the representation of the first media item from being displayed in the first manner to being displayed in the second manner by expanding elements in a third dimension in response to detecting the user gaze corresponding to the first position in the media library user interface provides the user with visual feedback about the state of the system (e.g., that the user gaze corresponding the first position has been detected), which provides improved visual feedback.

In some embodiments, displaying the representation of the first media item in the first manner includes displaying the representation of the first media item at a first position relative to a user. In some embodiments, displaying the representation of the first media item in the second manner includes displaying the representation of the first media item at a second position relative to the user that is further away from the user than the first position (e.g., the representation of the first media item is pushed backwards and/or away from the user) (e.g., as described with reference to media items 710A-710F in FIGS. 7A-7D).

In some embodiments, displaying the media library user interface includes displaying, concurrently with the representation of the first media item, a representation of a third media item different from the representation of the first media item; and displaying the representation of the first media item in the second manner includes displaying the representation of the first media item at the second position relative to the user while maintaining a position of the third media item relative to the user (e.g., moving the representation of the first media item backwards and/or away from the user while maintaining the position of the third media item relative to the user).

In some embodiments, the media library user interface defines a first plane having an x-axis and a y-axis perpendicular to the x-axis (e.g., the media library user interface includes at least one planar surface, wherein the planar surface defines an x-axis and a y-axis) (in some embodiments, the representations of the plurality of media items are displayed on (e.g., within) the first plane); displaying the representation of the first media item in the first manner includes displaying the representation of the first media item at a first position on a z-axis, wherein the z-axis is perpendicular to both the x-axis and the y-axis, and further wherein a front surface of the media library user interface defines a positive direction of the z-axis and a back surface of the media library user interface defines a negative direction of the z-axis (in some embodiments, the positive direction of the z-axis extends towards a user, and the negative direction of the z-axis extends away from the user); and displaying the representation of the first media item in the second manner includes displaying the representation of the first media item at a second position on the z-axis different from the first position, wherein the second position is a more negative z-axis position than the first position (e.g., the first media item is pushed backwards (e.g., further away from a user) in the second manner compared to the first manner) (in some embodiments, the representation of the first media item is displayed at a second position on the z-axis and parallel to the first plane).

In some embodiments, while displaying the representation of the first media item in the first manner, representations of one or more (e.g., two or more) other media items are displayed at the first position on the z-axis; and while displaying the representation of the first media item in the second manner, representations of the one or more (e.g., two or more) other media items are displayed at (e.g., maintained at) the first position on the z-axis.

Changing the appearance of the representation of the first media item from being displayed in the first manner to being displayed in the second manner by moving the representation of the first media item away from a user in response to detecting the user gaze corresponding to the first position in the media library user interface provides the user with visual feedback about the state of the system (e.g., that the user gaze corresponding the first position has been detected), which provides improved visual feedback.

In some embodiments, the first media item includes video content (e.g., cinematic content and/or moving visual content); displaying the representation of the first media item in the first manner includes displaying a static representation of the video content of the first media item (e.g., displaying a static thumbnail image representation of the first media item); and displaying the representation of the first media item in the second manner includes displaying playback of the video content of the first media item (e.g., playback of at least a subset of the video content of the first media item) (e.g., displaying moving visual content and/or cinematic content of the first media item) (e.g., displaying playback of the video content of the first media item within the media library user interface) (e.g., displaying playback of the video content of the first media item within the media library user interface without displaying playback of video content of any other media items within the media library user interface) (e.g., as described with reference to media items 710A-710F in FIGS. 7A-7D). Changing the appearance of the representation of the first media item from being displayed in the first manner to being displayed in the second manner by displaying playback of the video content of the first media item in response to detecting the user gaze corresponding to the first position in the media library user interface provides the user with visual feedback about the state of the system (e.g., that the user gaze corresponding the first position has been detected), which provides improved visual feedback.

In some embodiments, displaying the representation of the first media item in the third manner different from the second manner includes displaying a second static representation of the video content of the first media item (e.g., displaying a static thumbnail image representation of the first media item) (e.g., as described with reference to media items 710A-710F in FIGS. 7A-7D). In some embodiments, the second static representation is the same as the static representation or different from the static representation. In some embodiments, in response to detecting the user gaze corresponding to the second position in the media library user interface, the computer system ceases playback of the video content of the first item. In some embodiments, in response to detecting the user gaze corresponding to the second position in the media library user interface, the computer system changes an appearance of a representation of a second media item different from the first media item from displaying a static representation of video content of the second media item (e.g., displaying a static thumbnail image representation of video content of the first item) to displaying playback of video content of the second media item (e.g., displaying moving visual content and/or cinematic content of the second media item)). Changing the appearance of the representation of the first media item from being displayed in the second manner to being displayed in the third manner (e.g., by displaying a static representation of the video content of the first media item) in response to detecting the user gaze corresponding to the second position in the media library user interface provides the user with visual feedback about the state of the system (e.g., that the user gaze corresponding the second position has been detected), which provides improved visual feedback.

In some embodiments, displaying the representation of the first media item in the second manner includes (in some embodiments, displaying playback of the video content of the first media item includes) applying a low pass filter (e.g., a blurring and/or smoothing filter) to the video content of the first media item (e.g., as described with reference to media items 710A-710F in FIGS. 7A-7D). In some embodiments, while displaying the media library user interface, the computer system detects one or more user inputs (e.g., one or more touch inputs, one or more non-touch inputs, one or more gestures (e.g., one or more air gestures)) corresponding to selection of the first media item (e.g., a one-handed pinch gesture and/or a two-handed de-pinch gesture while the gaze of the user is maintained on and/or directed to the first media item); and in response to detecting the one or more user inputs corresponding to selection of the first media item, the computer system displays playback of the video content of the first media item without the low pass filter applied. In some embodiments, in response to detecting the one or more user inputs corresponding to selection of the first media item, the computer system displays a media player user interface different from the media library user interface (in some embodiments, the computer system ceases display of the media library user interface and/or ceases display of at least part of the media library user interface), and displays, within the media player user interface, playback of the video content of the first media item without the low pass filtered applied. Changing the appearance of the representation of the first media item from being displayed in the first manner to being displayed in the second manner (e.g., by displaying playback of the video content of the first media item with a low pass filter applied) in response to detecting the user gaze corresponding to the first position in the media library user interface provides the user with visual feedback about the state of the system (e.g., that the user gaze corresponding the first position has been detected), which provides improved visual feedback.

In some embodiments, while displaying the representation of the first media item in the second manner, including displaying playback of the video content of the first media item, the computer system outputs audio content of the first media item at a first volume level (e.g., audio content corresponding to the video content of the first media item). While displaying the media library user interface (in some embodiments, while displaying playback of the video content of the first media item (e.g., within the media library user interface) and/or while outputting audio content of the first media item at the first volume level), the computer system detects, via the one or more input devices, one or more user inputs (e.g., one or more touch inputs, one or more non-touch inputs, and/or one or more gestures (e.g., one or more air gestures)) corresponding to selection of the first media item (e.g., a one-handed pinch gesture and/or a two-handed de-pinch gesture while the gaze of the user is maintained on and/or directed to the first media item). In response to detecting the one or more user inputs corresponding to selection of the first media item, the computer system outputs audio content of the first media item at a second volume level that is louder than the first volume level (e.g., as described with reference to media items 710A-710F in FIGS. 7A-7D). In some embodiments, the one or more user inputs corresponding to selection of the first media item includes one or more air gestures. In some embodiments, detecting the one or more user inputs corresponding to selection of the first media item includes detecting a one-handed pinch gesture (e.g., a one-handed pinch air gesture) and/or a two-handed de-pinch gesture (e.g., a two-handed de-pinch air gesture) while the gaze of the user is maintained on and/or directed to the first media item (e.g., detecting the one-handed pinch gesture and/or the two-handed de-pinch gesture while detecting that the gaze of the user is maintained on and/or directed to the first media item)). In some embodiments, the computer system outputs audio content of the first media item at the second volume level while continuing to display playback of the video content of the first media item. In some embodiments, in response to detecting the one or more user inputs corresponding to selection of the first media item, the computer system displays a media player user interface different from the media library user interface (in some embodiments, the computer system ceases display of the media library user interface and/or ceases display of at least part of the media library user interface), and displays, within the media player user interface, playback of the video content of the first media item while outputting audio content of the first media item at the second volume level. Automatically increasing the volume at which audio content of the first media item is output in response to opening and/or selection of the first media item allows the user to increase the playback volume without providing further user inputs, which reduces the number of inputs needed to perform an operation.

In some embodiments, displaying playback of the video content of the first media item is performed in response to detecting the user gaze corresponding to the first position in the media library user interface (e.g., without any additional user inputs) (e.g., as described with reference to media items 710A-710F in FIGS. 7A-7D). In some embodiments, the playback of the video content of the first media item is displayed in accordance with a determination that the user gaze corresponding to the first position in the media library user interface has been maintained for a threshold duration of time. Displaying playback of the video content of the first media item in response to detecting the user gaze corresponding to the first position in the media library user interface allows a user to play video content of the first media item without additional user inputs, which reduces the number of inputs needed to perform an operation.

In some embodiments, the first media item includes a plurality of elements including a first element and a second element (e.g., a plurality of elements arranged in a plurality of layers, including a first element in a first layer and a second element in a second layer (in some embodiments, each layer is positioned at a different position along a z-axis)). In some embodiments, while continuing to detect the user gaze corresponding to the first position in the media library user interface, the computer system displays, via the display generation component, the first element moving with respect to the second element as a viewpoint of the user shifts relative to the first media item (e.g., shifting the first element relative to the second element in response to movement of the viewpoint of the user or in response to movement of the first media item while the viewpoint of the user remains in the same place) (e.g., as described with reference to media items 710A-710F in FIGS. 7A-7D). In some embodiments, the first element shifts relative to the second element by an amount based on an amount of the change in the viewpoint of the user relative to the first media item. In some embodiments, the first element shifts relative to the second element in a direction based on a direction of the change in the viewpoint of the user relative to the first media item. In some embodiments, displaying the first element moving with respect to the second element is performed in response to detecting one or more user inputs (e.g., one or more gestures (e.g., movement of the user's hands and/or head) (e.g., one or more air gestures) and/or one or more non-gesture inputs). Displaying the first element moving with respect to the second element while detecting the user gaze corresponding to the first position in the media library user interface provides the user with visual feedback about the state of the system (e.g., that the user gaze corresponding the first position has been detected), which provides improved visual feedback.

In some embodiments, the computer system detects (e.g., after and/or while displaying the representation of the first media item in the third manner), via the one or more input devices, a user gaze (e.g., 714) corresponding to the first position in the media library user interface (e.g., 708) (e.g., detecting and/or determining that a user is gazing at the first position in the media library user interface) (e.g., a first position in the media library user interface that corresponds to the representation of the first media item). While continuing to detect the user gaze corresponding to the first position in the media library user interface (e.g., at a fourth time subsequent to the third time), the computer system detects, via the one or more input devices, one or more user gestures (e.g., 716 or 718) (e.g., movement of the hands, head, and/or body of a user) (e.g., one or more air gestures (e.g., a one-handed pinch air gesture, a one-handed double pinch air gesture, a pinch and drag air gesture, a two-handed pinch air gesture and/or a two-handed de-pinch air gesture)) (in some embodiments, one or more non-gesture inputs) (in some embodiments, one or more user gestures corresponding to selection of the first media item). In response to detecting the one or more user gestures while continuing to detect the user gaze corresponding to the first position in the media library user interface, the computer system changes an appearance of the representation of the first media item from being displayed, via the display generation component, in a seventh manner (e.g., with a seventh set of visual characteristics) to being displayed in an eighth manner different from the seventh manner (e.g., with an eighth set of visual characteristics) (e.g., changing an appearance of media item 710F in response to user gesture 718, as described with reference to FIGS. 7D-7F). In some embodiments, the seventh manner is the same as the second manner. In some embodiments, in response to detecting the one or more user gestures while continuing to detect the user gaze corresponding to the first position in the media library user interface, the computer system changes an appearance of the representation of the first media item from being displayed in the second manner to being displayed in the eighth manner different from the second manner. Changing an appearance of the representation of the first media item in response to detecting the one or more user gestures while continuing to detect the user gaze corresponding to the first position in the media library provides the user with visual feedback about the state of the system (e.g., that the system has detected the one or more user gestures while continuing to detect the user gaze corresponding to the first position), which provides improved visual feedback.

In some embodiments, the one or more user gestures includes a pinch gesture (e.g., a pinch air gesture) (e.g., a one-handed pinch gesture or a two-handed pinch gesture) (e.g., two fingers (e.g., two fingers of one hand or two hands) moving from a first distance relative to one another to a second distance relative to one another, wherein the second distance is smaller than the first distance) (e.g., as described with reference to FIGS. 7D-7F). In some embodiments, the second distance is smaller than a threshold distance (e.g., the two fingers are moved to a position that is sufficiently close to satisfy a distance threshold). In some embodiments, the pinch gesture corresponds to a selection gesture indicative of user selection of the first media item (e.g., user selection of the first media item without selection of any other media items (e.g., user selection of only the first media item)); display of the representation of the first media item in the eight manner is indicative of user selection of the first media item (e.g., indicative of user selection of the first media item from a plurality of media items, without selecting any other media items of the plurality of media items (e.g., user selection of only the first media item)); and display of the representation of the first media item in the seventh manner is not indicative of user selection of the first media item.

In some embodiments, changing the appearance of the representation of the first media item from being displayed in the seventh manner to being displayed in the eight manner includes expanding the size of the representation of the first media item. In some embodiments, changing the appearance of the representation of the first media item from being displayed in the seventh manner to being displayed in the eight manner includes initiating playback of the first media item (e.g., initiating video playback of the first media item). In some embodiments, changing the appearance of the representation of the first media item from being displayed in the seventh manner to being displayed in the eight manner includes displaying the representation of the first media item in a selected media user interface different from the media library user interface. In some embodiments, in response to detecting the one or more user gestures including the pinch gesture, the computer system ceases to display representations of one or more media items different from the representation of the first media item (e.g., representations of one or more media items that were displayed in the media library user interface).

Changing an appearance of the representation of the first media item in response to detecting the one or more user gestures while continuing to detect the user gaze corresponding to the first position in the media library provides the user with visual feedback about the state of the system (e.g., that the system has detected the one or more user gestures while continuing to detect the user gaze corresponding to the first position), which provides improved visual feedback.

In some embodiments, the first media item (e.g., 710A-710F) includes a plurality of elements including a first element and a second element. In some embodiments, displaying the representation of the first media item in the seventh manner includes: displaying the first element at a first position; and displaying the second element at a second position that is closer to a user of the computer system than the first position. In some embodiments, the one or more user gestures (e.g., one or more air gestures) includes a first gesture (e.g., a first air gesture). In some embodiments, in response to detecting the first gesture while continuing to detect the user gaze corresponding to the first position in the media library user interface, the computer system moves the second element with respect to the first element to decrease a distance between the first element and the second element (e.g., as described with reference to FIGS. 7D-7F). In some embodiments, the first gesture is a pinch gesture (e.g., a pinch air gesture) (e.g., a gesture in which a first finger moves closer to a second finger), and the second element is moved along an axis with respect to the first element to decrease a distance between the first element and the second element along the axis based on a magnitude of the pinch gesture (e.g., based on the amount of movement of one finger relative to another).

In some embodiments, the media library user interface defines a first plane having an x-axis and a y-axis perpendicular to the x-axis (e.g., the media library user interface includes at least one planar surface, wherein the planar surface defines an x-axis and a y-axis) (in some embodiments, the representations of the plurality of media items are displayed on (e.g., within) the first plane); the first media item includes a plurality of elements including a first element and a second element; displaying the representation of the first media item in the seventh manner includes concurrently displaying: the first element at a first position on the z-axis; and the second element at a second position on the z-axis different from the second position; the one or more user gestures includes a first gesture; and: in response to detecting the first gesture while continuing to detect the user gaze corresponding to the first position in the media library user interface, the computer system moves the second element along the z-axis with respect to the first element to decrease a distance between the first element and the second element along the z-axis based on a magnitude of the first gesture. In some embodiments, the first gesture is a pinch gesture (e.g., a pinch air gesture) (e.g., a gesture in which a first finger moves closer to a second finger), and the second element is moved along the z-axis with respect to the first element to decrease a distance between the first element and the second element along the z-axis based on a magnitude of the pinch gesture (e.g., based on the amount of movement of one finger relative to another).

Moving the second element with respect to the first element in response to detecting the first gesture while continuing to detect the user gaze corresponding to the first position provides the user with visual feedback about the state of the system (e.g., that the system has detected the first gesture while continuing to detect the user gaze corresponding to the first position), which provides improved visual feedback.

In some embodiments, the one or more user gestures includes a second gesture (e.g., a second air gesture) performed subsequent to the first gesture. In some embodiments, in response to detecting the second gesture while continuing to detect the user gaze corresponding to the first position in the media library user interface, the computer system moves the second element with respect to the first element (e.g., moving the second element along a pre-defined axis) to increase a distance between the first element and the second element (e.g., based on a magnitude of the second gesture) (e.g., as described with reference to FIGS. 7D-7F). In some embodiments, moving the second element with respect to the first element to increase a distance between the first element and the second element includes moving the first element to a first position on an axis (e.g., a pre-defined axis (e.g., an axis that extends towards a user of the computer system)) and/or moving the second element to a second position on the axis. In some embodiments, the second gesture is a de-pinch gesture (e.g., a de-pinch air gesture) (e.g., a gesture in which a first finger moves further from a second finger). In some embodiments, the second element is moved (e.g., moved along an axis) with respect to the first element to increase a distance between the first element and the second element based on a magnitude of the de-pinch gesture (e.g., based on the amount of movement of one finger relative to another). In some embodiments, moving the second element with respect to the first element to increase a distance between the first element and the second element is performed in accordance with a determination that the first gesture failed to satisfy a completion threshold. Moving the second element with respect to the first element in response to detecting the second gesture while continuing to detect the user gaze corresponding to the first position in the media library provides the user with visual feedback about the state of the system (e.g., that the system has detected the second gesture while continuing to detect the user gaze corresponding to the first position), which provides improved visual feedback.

In some embodiments, the one or more user gestures (e.g., 718) includes a third gesture (e.g., a third air gesture) performed subsequent to the first gesture; and the third gesture is indicative of user selection of the first media item (e.g., user selection of the first media item without selecting any other media items (e.g., selection of only the first media item)). In some embodiments, the third gesture is a continuation of the first gesture (e.g., a continuation of the first gesture beyond a completion threshold). In some embodiments, in response to detecting the third gesture, the computer system increases the distance between the first element and the second element (e.g., along a pre-defined axis) (e.g., as described with reference to FIGS. 7D-7F). In some embodiments, in response to detecting the first gesture, the distance between the first element and the second element is decreased to a first distance, and in response to detecting the third gesture, the distance between the first element and the second element is increased from the first distance to a second distance. In some embodiments, in response to detecting the first gesture while continuing to detect the user gaze corresponding to the first position in the media library user interface, the computer system moves the second element with respect to the first element to decrease a distance between the first element and the second element to a first distance based on a magnitude of the first gesture; and subsequent to moving the second element with respect to the first element to decrease the distance between the first element and the second element to the first distance: in accordance with a determination that the first gesture satisfies a completion threshold, the computer system increases the distance between the first element and the second element to a second distance. Increasing the distance between the first element and the second element in response to detecting the third gesture provides the user with visual feedback about the state of the system (e.g., that the system has detected the third gesture), which provides improved visual feedback.

In some embodiments, displaying the media library user interface (e.g., 708) includes displaying, concurrently with the representation of the first media item (e.g., 710A-710F), a representation of a second media item different from representation of the first media item (e.g., 710A-710F); and the one or more user gestures includes a first selection gesture (e.g., an air gesture) (e.g., 718) (e.g., an air tap gesture (e.g., a tap gesture that does not contact any surface or object); a two-finger pinch gesture; a two-finger de-pinch gesture; a one-handed pinch gesture; and/or a one-handed de-pinch gesture) corresponding to selection of the first media item (e.g., selection of media item 710F in FIG. 7D) (e.g., selection of the first media item without selection of any other media items (e.g., selection of only the first media item)). In some embodiments, detecting the first selection gesture includes detecting a predefined gesture (e.g., an air gesture) while also detecting that the gaze of the user is directed to and/or maintained on the first media item (e.g., a one-handed pinch gesture and/or a two-handed de-pinch gesture while the gaze of the user is directed to and/or maintained on the first media item). In some embodiments, in response to detecting the first selection gesture corresponding to selection of the first media item, the computer system visually obscures the representation of the second media item (e.g., blurring the representation of the second media item) (e.g., as described with reference to FIGS. 7D-7F). Visually obscuring the representation of the second media item in response to detecting the first selection gesture provides the user with visual feedback about the state of the system (e.g., that the system has detected the first selection gesture corresponding to selection of the first media item), which provides improved visual feedback.

In some embodiments, while detecting the user gaze (e.g., 714) corresponding to the first position in the media library user interface (and, optionally, while displaying the representation of the first media item in the second manner), the computer system detects, via the one or more input devices, a second set of one or more user gestures (e.g., 718) (e.g., movement of a user's hands, head (e.g., side to side), and/or body part) (e.g., one or more air gestures)). In response to detecting the second set of one or more user gestures, the computer system shifts visual content of the representation of the first media item based on the second set of one or more user gestures (e.g., based on a direction of movement of the second set of one or more user gestures) (e.g., FIGS. 7C-7D). In some embodiments, in response to detecting the second set of one or more user gestures, the computer system displays additional content (e.g., additional content of the first media item and/or additional content of the media library user interface). Shifting visual content of the representation of the first media item in response to detecting the second set of one or more user gestures provides the user with visual feedback about the state of the system (e.g., that the system has detected the second set of one or more user gestures), which provides improved visual feedback. In some embodiments, when the computer system is a head-mounted device, the second set of one or more user gestures corresponds to a rotation of the user's head.

In some embodiments, while displaying the media library user interface (e.g., 708), the computer system detects, via the one or more input devices, a third set of one or more user gestures (e.g., 716) (e.g., one or more air gestures) that includes a pinch gesture (e.g., a pinch air gesture) (e.g., placement of two fingers next to one another and/or movement of two fingers closer to one another) and a drag gesture (e.g., a drag air gesture) (e.g., movement of a hand (e.g., movement of a pinched hand) in a direction) (e.g., a pinch and drag gesture). In response to detecting the third set of one or more user gestures, the computer system displays scrolling of the media library user interface (e.g., FIGS. 7C-7D). In some embodiments, prior to detecting the third set of one or more user gestures, the computer system displays representation of a first set of media items, and: displaying scrolling of the media library user interface includes: subsequent to detecting the third set of one or more user gestures, displaying representations of a second set of media items different from the first set of media items. In some embodiments, displaying scrolling of the media library user interface includes displaying scrolling of the first set of media items in a direction until at least a subset of the first set of media items is no longer displayed. Displaying scrolling of the media library user interface in response to detecting the third set of one or more user gestures provides the user with visual feedback about the state of the system (e.g., that the system has detected the third set of one or more user gestures), which provides improved visual feedback.

In some embodiments, while displaying the media library user interface (e.g., 708), the computer system detects, via the one or more input devices, one or more user inputs (e.g., 718) corresponding to selection of the first media item (e.g., 710F) (e.g., one or more gesture inputs (e.g., one or more air gestures) and/or one or more non-gesture inputs) (e.g., a one-handed pinch gesture and/or a two-handed de-pinch gesture while the gaze of the user is directed to and/or maintained on the first media item) (e.g., selection of the first media item without selecting any other media items (e.g., selection of only the first media item)). In response to detecting the one or more user inputs corresponding to selection of the first media item, the computer system displays, via the display generation component, the first media item in a selected media user interface (e.g., 719) different from the media library user interface. In some embodiments, the selected media user interface overlays the media library user interface. In some embodiments, in response to detecting the one or more user inputs corresponding to selection of the first media item, the computer system ceases to display the media library user interface or ceases to display at least part of the media library user interface. While displaying the first media item in the selected media user interface, the computer system detects, via the one or more input devices, a fourth set of one or more user gestures (e.g., 732) (e.g., one or more air gestures) that includes a pinch gesture (e.g., a pinch air gesture) (e.g., placement of two fingers next to one another and/or movement of two fingers closer to one another) and a drag gesture (e.g., a drag air gesture) (e.g., movement of a hand (e.g., movement of a pinched hand) in a direction) (e.g., a pinch and drag gesture in a first direction). In response to detecting the fourth set of one or more user gestures: the computer system ceases display of the first media item within the selected media user interface; and displays, via the display generation component, a second media item different from the first media item within the selected media user interface (e.g., as described with reference to FIG. 7F). In some embodiments, the computer system replaces display of the first media item within the selected media user interface with display of the second media item within the selected media user interface. In some embodiments, displaying the second media item within the selected media user interface is performed in accordance with a determination that the drag gesture (e.g., the pinch and drag gesture) corresponds to a particular direction (e.g., a left direction, a right direction, an up direction, and/or a down direction). In some embodiments, a pinch and drag gesture in a different direction from the particular direction results in a different action (e.g., ceasing to display the selected media user interface and/or displaying the media library user interface). Ceasing display of the first media item within the selected media user interface and displaying the second media item different from the first media item within the selected media user interface in response to detecting the fourth set of one or more user gestures provides the user with visual feedback about the state of the system (e.g., that the system has detected the fourth set of one or more user gestures), which provides improved visual feedback.

In some embodiments, while displaying the media library user interface (e.g., 708), the computer system detects, via the one or more input devices, one or more user inputs (e.g., 718) corresponding to selection of the first media item (e.g., 710F) (e.g., one or more gesture inputs (e.g., one or more air gestures) and/or one or more non-gesture inputs) (e.g., a one-handed pinch gesture and/or a two-handed de-pinch gesture while the gaze of the user is directed to and/or maintained on the first media item) (e.g., selection of the first media item without selecting any other media items (e.g., selection of only the first media item)). In response to detecting the one or more user inputs corresponding to selection of the first media item, the computer system displays, via the display generation component, the first media item (e.g., 710F) in a selected media user interface (e.g., 719) different from the media library user interface. In some embodiments, the selected media user interface overlays the media library user interface. In some embodiments, in response to detecting the one or more user inputs corresponding to selection of the first media item, the computer system ceases to display the media library user interface or ceases to display at least part of the media library user interface. While displaying the first media item in the selected media user interface, the computer system detects, via the one or more input devices, a fifth set of one or more user gestures (e.g., 732) (e.g., one or more air gestures) that includes a pinch gesture (e.g., placement of two fingers next to one another and/or movement of two fingers closer to one another) and a drag gesture (e.g., movement of a hand (e.g., movement of a pinched hand) in a direction) (e.g., a pinch and drag gesture in a first direction). In response to detecting the fifth set of one or more user gestures: the computer system ceases display of the selected media user interface; and displays, via the display generation component, the media library user interface (e.g., 708) (e.g., as described with reference to FIG. 7F) (e.g., at a location that was previously occupied by the selected media user interface). In some embodiments, ceasing display of the selected media user interface and displaying the media library user interface is performed in accordance with a determination that the drag gesture (e.g., the pinch and drag gesture) corresponds to a particular direction (e.g., a left direction, a right direction, an up direction, and/or a down direction). In some embodiments, a pinch and drag gesture in a different direction from the particular direction results in a different action (e.g., replacing display of the first media item within the selected media user interface with a different media item within the selected media user interface). Ceasing display of the selected media user interface and displaying the media library user interface in response to detecting the fifth set of one or more user gestures provides the user with visual feedback about the state of the system (e.g., that the system has detected the fifth set of one or more user gestures), which provides improved visual feedback.

In some embodiments, while displaying the media library user interface (e.g., 708), the computer system detects, via the one or more input devices, one or more user inputs (e.g., 718) corresponding to selection of the first media item (e.g., 710F) (e.g., one or more gesture inputs (e.g., one or more air gestures) and/or one or more non-gesture inputs) (e.g., a one-handed pinch gesture and/or a two-handed de-pinch gesture while the gaze of the user is directed to and/or maintained on the first media item) (e.g., selection of the first media item without selecting any other media items (e.g., selection of only the first media item)). In response to detecting the one or more user inputs corresponding to selection of the first media item, the computer system displays, via the display generation component, the first media item (e.g., 710F) in a selected media user interface (e.g., 719) different from the media library user interface. In some embodiments, the selected media user interface overlays the media library user interface. In some embodiments, in response to detecting the one or more user inputs corresponding to selection of the first media item, the computer system ceases to display the media library user interface or ceases to display at least part of the media library user interface. While displaying the first media item in the selected media user interface, the computer system detects, via the one or more input devices, a sixth set of one or more user gestures (e.g., one or more air gestures) (e.g., 732) that includes a pinch gesture (e.g., placement of two fingers next to one another and/or movement of two fingers closer to one another) and a drag gesture (e.g., movement of a hand (e.g., movement of a pinched hand) in a direction) (e.g., a pinch and drag gesture in a first direction). In response to detecting the sixth set of one or more user gestures and in accordance with a determination that the drag gesture (e.g., the pinch and drag gesture) corresponds to a first direction (e.g., a left direction, a right direction, an up direction, and/or a down direction): the computer system ceases display of the first media item within the selected media user interface; and displays, via the display generation component, a second media item different from the first media item within the selected media user interface. In some embodiments, displaying the second media item includes replacing display of the first media item within the selected media user interface with display of the second media item within the selected media user interface. In some embodiments, in response to detecting the sixth set of one or more user gestures and in accordance with a determination that the drag gesture (e.g., the pinch and drag gesture) corresponds to a second direction different from the first direction (e.g., a left direction, a right direction, an up direction, and/or a down direction): the computer system ceases display of the selected media user interface; and displays, via the display generation component, the media library user interface (e.g., as described with reference to FIG. 7F).

In some embodiments, in response to detecting the sixth set of one or more user gestures: in accordance with a determination that the drag gesture is in a third direction different from the first direction and the second direction (and, optionally opposite to the first direction): the computer system ceases display of the first media item within the selected media user interface; and displays, via the display generation component, a third media item different from the first media item and the second media item within the selected media user interface. In some embodiments, the computer system replaces display of the first media item within the selected media user interface with display of the third media item within the selected media user interface.

Ceasing display of the first media item within the selected media user interface and displaying the second media item different from the first media item within the selected media user interface in response to detecting the sixth set of one or more user gestures and in accordance with a determination that the drag gesture corresponds to a first direction provides the user with visual feedback about the state of the system (e.g., that the system has detected the sixth set of one or more user gestures and has determined that the sixth set of gestures correspond to the first direction), which provides improved visual feedback.

Ceasing display of the selected media user interface and displaying the media library user interface in response to detecting the sixth set of one or more user gestures and in accordance with a determination that the drag gesture corresponds to a second direction provides the user with visual feedback about the state of the system (e.g., that the system has detected the sixth set of one or more user gestures and has determined that the sixth set of one or more user gestures correspond to the second direction), which provides improved visual feedback.

In some embodiments, while displaying the media library user interface (e.g., 708), the computer system detects, via the one or more input devices, one or more user inputs (e.g., 718) (e.g., one or more gesture inputs (e.g., one or more air gestures) and/or one or more non-gesture inputs) corresponding to selection of the first media item (e.g., 710F) (e.g., a one-handed pinch gesture and/or a two-handed de-pinch gesture while the gaze of the user is directed to and/or maintained on the first media item) (e.g., selection of the first media item without selecting any other media items (e.g., selection of only the first media item)). In response to detecting the one or more user inputs corresponding to selection of the first media item, the computer system displays, via the display generation component, the first media item (e.g., 710F) in a selected media user interface (e.g., 719) different from the media library user interface. In some embodiments, the selected media user interface overlays the media library user interface. In some embodiments, in response to detecting the one or more user inputs corresponding to selection of the first media item, the computer system ceases to display the media library user interface or ceases to display at least part of the media library user interface. While displaying the first media item in the selected media user interface: in accordance with a determination that a hand of a user (e.g., one or more hands of a user) is in a first state (e.g., a raised state and/or in a first pose), the computer system displays, via the display generation component, a first set of user interface controls (e.g., 728A, 728B, 728C, and/or 740) (e.g., selectable controls, a close option, a share option, time information, date information, location information, and/or playback controls (e.g., a play option, a pause option, a fast forward option, and/or a rewind option)). In some embodiments, while displaying the first set of user interface controls, the computer system detects one or more selection inputs corresponding to selection of a first user interface control of the first set of user interface controls; and in response to detecting the one or more selection inputs, modifies display of the first media item (e.g., closes (e.g., ceases display) of the first media item; initiates and/or pauses playback of the first media item; skips forward and/or backward in playback of the first media item; slows down and/or speeds up playback of the first media item). In some embodiments, the first set of user interface controls includes a first user interface control that is selectable to close (e.g., cease display of) the first media item (e.g., a close option). In some embodiments, the first set of one or more user interface controls includes a second user interface control that is selectable to initiate a process for sharing the first media item to one or more external electronic devices (e.g., a share option). In some embodiments, the first set of one or more user interface controls includes a third user interface control that is selectable to resume and/or initiate playback of the first media item (e.g., a play option). In some embodiments, the first set of one or more user interface controls includes a fourth user interface control that is selectable to pause playback of the first media item (e.g., a pause option). In some embodiments, the first set of one or more user interface controls includes a fifth user interface control that is selectable to skip forward in and/or speed up playback of the first media item (e.g., a fast forward option). In some embodiments, the first set of one or more user interface controls includes a sixth user interface control that is selectable to skip backward, slow down, and/or reverse playback of the first media item (e.g., a rewind option); and in accordance with a determination that the hand of the user (e.g., one or more hands of the user) is in a second state different from the first state (e.g., a lowered state and/or in a second pose), the computer system forgoes displaying the first set of user interface controls (e.g., as described with reference to FIG. 7N).

In some embodiments, the first set of user interface controls are displayed without being overlaid on the first media item (e.g., above and/or below the first media item). In some embodiments, while displaying the first set of user interface controls, the computer system detects, via the one or more input devices, that the hand of the user has moved from the first state to the second state; and in response to detecting that the hand of the user has moved from the first state to the second state, ceases display of the first set of user interface controls.

Displaying the first set of user interface controls in accordance with a determination that the hand of the user is in the first state provides the user with visual feedback about the state of the system (e.g., that the system has detected that the hand of the user is in the first state), which provides improved visual feedback.

Forgoing displaying the first set of user interface controls when the hand of the user is in the second state, and displaying the first set of user interface controls when the hand of the user is in the first state, provide additional control options without cluttering the user interface.

In some embodiments, while displaying the media library user interface (e.g., 708), the computer system detects, via the one or more input devices, a seventh set of one or more user gestures (e.g., 718) (e.g., one or more air gestures) corresponding to selection of the first media item (e.g., 710F) (e.g., a one-handed pinch gesture and/or a two-handed de-pinch gesture while the gaze of the user is directed to and/or maintained on the first media item) (e.g., selection of the first media item without selecting any other media items (e.g., selection of only the first media item)). In response to detecting the seventh set of one or more user gestures, the computer system transitions from displaying a first set of lighting effects (e.g., a first set of visual lighting characteristics) to displaying a second set of lighting effects (e.g., a second set of visual lighting characteristics) different from the first set of lighting effects, including: subsequent to displaying the first set of lighting effects, displaying, via the display generation component, an intermediate set of lighting effects (e.g., an intermediate set of visual lighting characteristics different from the first set of visual lighting characteristics and the second set of visual lighting characteristics), wherein the intermediate set of lighting effects is different from the first set of lighting effects and the second set of lighting effects (in some embodiments, the first set of lighting effects has a first value (e.g., a first numerical value) for a first lighting characteristic (e.g., brightness, contrast, saturation), the second set of lighting effects has a second value different from the first value for the first lighting characteristic, and the intermediate set of lighting effects has a third value different from the first and second value for the first lighting characteristic, wherein the third value is between the first value and the second value); and subsequent to displaying the intermediate set of lighting effects, displaying, via the display generation component, the second set of lighting effects (e.g., as described with reference to FIGS. 7D-7F). In some embodiments, when the computer system is a head-mounted device, the appearance of the first set and/or second set of lighting effects changes in response to the computer system detecting that the user has repositioned themselves within the physical environment and/or the user has rotated their head (e.g., while the user wears the computer system).

In some embodiments, transitioning from displaying the first set of lighting effects to displaying the second set of lighting effects comprises gradually transitioning from the first set of lighting effects to the second set of lighting effects (e.g., a plurality of intermediate lighting effects applied between the first set of lighting effects to the second set of lighting effects). In some embodiments, transitioning from displaying the first set of lighting effects to displaying the second set of lighting effects includes gradually applying a light spill effect in which a plurality of light rays (e.g., a plurality of light rays of varying color, length, and/or intensity) extend from a media window (e.g., gradually increasing a brightness and/or intensity of the light spill effect). In some embodiments, the light spill effect is determined based on a selected media item (e.g., differs based on which media item is selected). In some embodiments, transitioning from displaying the first set of lighting effects to displaying the second set of lighting effects includes gradually darkening background content that is displayed concurrently with the media library user interface. In some embodiments, in response to detecting the seventh set of one or more user gestures, the selected first media item is displayed in a selected media item user interface. In some embodiments, the background content is displayed concurrently with the media library user interface at a first time and displayed concurrently with the selected media item user interface at a second time. In some embodiments, the background content is displayed in a brightened state while concurrently displayed with the media library user interface, and is displayed in a darkened state while concurrently displayed with the selected media item user interface. In some embodiments, when the computer system is a head-mounted device, the appearance of the first set and/or second set of lighting effects changes in response to the computer system detecting that the user has repositioned themselves within the physical environment and/or the user has rotated their head (e.g., while the user wears the computer system).

Transitioning from displaying the first set of lighting effects to displaying the second set of lighting effects in response to detecting the seventh set of one or more user gestures provides the user with visual feedback about the state of the system (e.g., that the system has detected the seventh set of one or more user gestures), which provides improved visual feedback.

In some embodiments, the computer system displays, via the display generation component, the first media item (e.g., 710F) in a selected media user interface (e.g., 719) different from the media library user interface (e.g., 708) (e.g., a selected media user interface indicative of selection of the first media item (e.g., indicative of selection of only the first media item) (e.g., a selected media user interface in which the first media item is visually emphasized (e.g., displayed at a larger size than other media items and/or is the only media item of the media library being displayed)). While displaying the first media item in the selected media user interface, the computer system detects, via the one or more input devices, an eighth set of one or more user gestures (e.g., 732) (e.g., one or more air gestures) corresponding to a user request to close the selected media user interface (e.g., a pinch and drag gesture (e.g., a pinch and drag gesture in a predetermined direction)). In response to detecting the eighth set of one or more user gestures, the computer system transitions from displaying a third set of lighting effects (e.g., a third set of visual lighting characteristics) (e.g., a third set of lighting effects displayed concurrently with the first media item in the selected media user interface) to displaying a fourth set of lighting effects (e.g., a fourth set of visual lighting characteristics) different from the third set of lighting effects, including: subsequent to displaying the third set of lighting effects, displaying, via the display generation component, a second intermediate set of lighting effects (e.g., a second intermediate set of visual lighting characteristics different from the third set of visual lighting characteristics and the fourth set of visual lighting characteristics), wherein the second intermediate set of lighting effects is different from the third set of lighting effects and the fourth set of lighting effects (in some embodiments, the third set of lighting effects has a first value (e.g., a first numerical value) for a first lighting characteristic (e.g., brightness, contrast, saturation), the fourth set of lighting effects has a second value different from the first value for the first lighting characteristic, and the second intermediate set of lighting effects has a third value different from the first and second value for the first lighting characteristic, wherein the third value is between the first value and the second value); and subsequent to displaying the second intermediate set of lighting effects, displaying, via the display generation component, the fourth set of lighting effects (e.g., as described with reference to FIG. 7F).

In some embodiments, transitioning from displaying the third set of lighting effects to displaying the fourth set of lighting effects comprises gradually transitioning from the third set of lighting effects to the fourth set of lighting effects (e.g., a plurality of intermediate lighting effects applied between the third set of lighting effects to the fourth set of lighting effects). In some embodiments, transitioning from displaying the third set of lighting effects to displaying the fourth set of lighting effects includes gradually decreasing a light spill effect in which a plurality of light rays (e.g., a plurality of light rays of varying color, length, and/or intensity) extend from a media window (e.g., extend from the selected media user interface) (e.g., gradually decreasing a brightness and/or intensity of the light spill effect). In some embodiments, the light spill effect is determined based on a selected media item (e.g., differs based on which media item is selected). In some embodiments, transitioning from displaying the third set of lighting effects to displaying the fourth set of lighting effects includes gradually brightening background content that is displayed concurrently with the selected media user interface. In some embodiments, in response to detecting the eighth set of one or more user gestures, the computer system ceases displaying the selected media user interface and displays the media library user interface. In some embodiments, the background content is displayed concurrently with the selected media user interface at a first time and displayed concurrently with the media library user interface at a second time. In some embodiments, the background content is displayed in a darkened state while concurrently displayed with the selected media user interface, and is displayed in a brightened state while concurrently displayed with the media library user interface.

Transitioning from displaying the third set of lighting effects to displaying the fourth set of lighting effects in response to detecting the eighth set of one or more user gestures provides the user with visual feedback about the state of the system (e.g., that the system has detected the eighth set of one or more user gestures), which provides improved visual feedback.

In some embodiments, the computer system concurrently displays, via the display generation component: the first media item (e.g., 741 or 743) in a selected media user interface (e.g., 719) different from the media library user interface (e.g., 708) (e.g., a selected media user interface indicative of selection of the first media item (e.g., indicative of selection of only the first media item) (e.g., a selected media user interface in which the first media item is visually emphasized (e.g., displayed at a larger size than other media items and/or is the only media item of the media library being displayed)); and a navigation user interface element (e.g., 740) (e.g., a scrubber bar) for navigating through visual content (e.g., navigating through a plurality of frames (e.g., images of a video, and/or navigating through a plurality of media items)). Displaying the navigation user interface element concurrently with the first media item in the selected media user interface allows a user to navigate through content with fewer inputs, which reduces the number of inputs needed to perform an operation.

In some embodiments, the navigation user interface element (e.g., 740) comprises one or more selectable controls that, when selected, perform respective functions associated with one or more respective media items (e.g., pause option shown in scrubber 740 in FIGS. 7M-7N) (e.g., a play option, a pause option, a fast forward option, a rewind option, and/or a skip option). In some embodiments, while displaying the navigation user interface element, the computer system detects one or more selection inputs (e.g., one or more air gestures) corresponding to selection of a first selectable control of the one or more selectable controls; and in response to detecting the one or more selection inputs, the computer system modifies display of the first media item (e.g., initiating and/or pausing playback of the first media item; skipping forward and/or backward in playback of the first media item; slowing down and/or speeding up playback of the first media item). In some embodiments, the one or more selectable controls includes a first control that is selectable to resume and/or initiate playback of the first media item (e.g., a play option). In some embodiments, the one or more selectable controls includes a second control that is selectable to pause playback of the first media item (e.g., a pause option). In some embodiments, the one or more selectable controls includes a third control that is selectable to skip forward in and/or speed up playback of the first media item (e.g., a fast forward option). In some embodiments, the one or more selectable controls includes a fourth control that is selectable to skip backward in, slow down, and/or reverse playback of the first media item (e.g., a rewind option). Displaying one or more selectable controls allows a user to perform various respective functions with fewer inputs, which reduces the number of inputs needed to perform an operation.

In some embodiments, while displaying the media library user interface (e.g., 708), the computer system detects, via the one or more input devices, one or more user inputs (e.g., 718) (e.g., one or more touch inputs, one or more non-touch inputs, and/or one or more gestures (e.g., one or more air gestures)) corresponding to selection of the first media item (e.g., 710F) (e.g., a one-handed pinch gesture and/or a two-handed de-pinch gesture while the gaze of the user is directed to and/or maintained on the first media item). In response to detecting the one or more user inputs corresponding to selection of the first media item: in accordance with a determination that a first set of criteria have been met (e.g., in accordance with a determination that a first user setting (e.g., an immersive viewing setting) is enabled and/or disabled; in accordance with a determination that the first media item is of a particular type; and/or in accordance with a determination that one or more user inputs of a particular type are detected), the computer system displays, via the display generation component, the first media item at a first angular size; and in accordance with a determination that the first set of criteria have not been met, the computer system displays, via the display generation component, the first media item at a second angular size that is different from the first angular size (e.g., as described with reference to FIG. 7F). In some embodiments, the first angular size corresponds to an immersive viewing experience (e.g., with a greater angular size for the media item being viewed), and the second angular size corresponds to a non-immersive viewing experience (e.g., the second angular size is smaller than the first angular size). In some embodiments, when the computer system is a head-mounted device and while the first media item is displayed at the first angular size, the computer system changes the perspective that the first media item is displayed from in response to the computer system detecting that the user has repositioned themselves in a physical environment and/or rotated their head (e.g., while the user wears the computer system). Displaying the first media item at the first angular size in accordance with a determination that the first set of criteria have been met provides the user with visual feedback about the state of the system (e.g., that the first set of criteria have been met), which provides improved visual feedback.

In some embodiments, the computer system displays, via the display generation component, the first media item (e.g., 710F) (e.g., within a selected media user interface different from the media library user interface) (e.g., a selected media user interface indicative of selection of the first media item (e.g., indicative of selection of only the first media item)) (e.g., a selected media user interface in which the first media item is visually emphasized relative to other media items (e.g., displayed at a larger size than other media items and/or is the only media item of the media library being displayed)), wherein the first media item is displayed (e.g., within the selected media user interface) with vignetting applied to the first media item (e.g., darkening, fading, obscuring, and/or blurring edges and/or corners of the first media item) (e.g., as described with reference to FIG. 7F). Displaying the representation of the first media item with vignetting applied to the first media item indicates to the user that the representation of the first media item is being displayed, for example, in a selected state, which provides improved visual feedback.

In some embodiments, the computer system detects (e.g., at a sixth time subsequent to the second time) (e.g., after or while displaying the representation of the first media item in the third manner), via the one or more input devices, a user gaze (e.g., 714) corresponding to the first position in the media library user interface (e.g., 708) (e.g., detecting and/or determining that a user is gazing at the first position in the media library user interface) (e.g., a first position in the media library user interface that corresponds to the representation of the first media item). While continuing to detect the user gaze corresponding to the first position in the media library user interface (e.g., at a seventh time subsequent to the sixth time), the computer system detects, via the one or more input devices, a selection gesture (e.g., 718) (e.g., an air gesture) (e.g., movement of the hands, head, and/or body of a user) (in some embodiments, one or more non-gesture inputs) corresponding to selection of the first media item (e.g., 710F) (e.g., a one-handed pinch gesture and/or a two-handed de-pinch gesture while the gaze of the user is directed to and/or maintained on the first media item). In response to detecting the selection gesture corresponding to selection of the first media item while continuing to detect the user gaze corresponding to the first position in the media library user interface: in accordance with a determination that the selection gesture corresponds to a first type of selection gesture (e.g., an air gesture) (e.g., a one-handed pinch gesture, a one-handed double pinch gesture, a two-handed pinch gesture, a two-handed de-pinch gesture, a partially completed one-handed pinch gesture, and/or a completed one-handed pinch gesture), the computer system displays, via the display generation component, the first media item in a ninth manner (e.g., with a ninth set of visual characteristics) (e.g., displaying the first media item in an intermediate selected state (e.g., in a transitional state transitioning from the media library user interface to a selected media user interface)) (e.g., displaying the first media item at a size that is smaller than a size of the first media item displayed in the selected media user interface, and is larger than the size of the representation of the first media item within the media library user interface); and in accordance with a determination that the selection gesture corresponds to a second type of selection gesture different from the first type of selection gesture (e.g., a one-handed pinch gesture, a one-handed double pinch gesture, a two-handed pinch gesture, a two-handed de-pinch gesture, a partially completed one-handed pinch gesture, and/or a completed one-handed pinch gesture), the computer system displays, via the display generation component, the first media item in a tenth manner different from the ninth manner (e.g., with a tenth set of visual characteristics different from the ninth set of visual characteristics) (e.g., in a selected media user interface different from the media library user interface indicative of user selection of the first media item) In some embodiments, displaying the first media item in the ninth manner includes displaying the first media item in a transitional state and displaying the first media item in the tenth manner includes displaying the first media item in a selected state. In some embodiments, displaying the first media item in the ninth manner includes displaying the first media item at a first size that is larger than a size of the representation of the first media item in the media library user interface, and displaying the first media item in the tenth manner includes displaying the first media item at a second size that is larger than the first size (e.g., as described with reference to FIG. 7F). Displaying the first media item in the ninth manner and/or in the tenth manner in response to detecting the selection gesture corresponding to selection of the first media item provides the user with visual feedback about the state of the system (e.g., that the system has detected the selection gesture corresponding to selection of the first media item), which provides improved visual feedback.

In some embodiments, aspects/operations of methods 800, 900, 1000, and 1100 may be interchanged, substituted, and/or added between these methods. For example, the media library user interface displayed in method 800 is optionally the user interface displayed in method 900, and/or the first media item displayed in method 800 is optionally the first media item displayed in methods 900 and/or 1000. For brevity, these details are not repeated here.

FIG. 9 is a flow diagram of an exemplary method 900 for interacting with media items and user interfaces, in accordance with some embodiments. In some embodiments, method 1000 is performed at a computer system (e.g., 700) (e.g., computer system 101 in FIG. 1) (e.g., a smart phone, a smart watch, a tablet, and/or a wearable device) that is in communication with a display generation component (e.g., 702) (e.g., a display controller; a touch-sensitive display system; a display (e.g., integrated and/or connected), a 3D display, a transparent display, a projector, and/or a heads-up display) and one or more input devices (e.g., 715) (e.g., a touch-sensitive surface (e.g., a touch-sensitive display); a mouse; a keyboard; a remote control; a visual input device (e.g., a camera); an audio input device (e.g., a microphone); and/or a biometric sensor (e.g., a fingerprint sensor, a face identification sensor, and/or an iris identification sensor)). In some embodiments, the method 1000 is governed by instructions that are stored in a non-transitory (or transitory) computer-readable storage medium and that are executed by one or more processors of a computer system, such as the one or more processors 202 of computer system 101 (e.g., control 110 in FIG. 1). Some operations in method 900 are, optionally, combined and/or the order of some operations is, optionally, changed.

In some embodiments, the computer system (e.g., 700) displays (902), via the display generation component (e.g., 702), a user interface (e.g., 708, 719) at a first zoom level (e.g., user interface 708 in FIG. 7D; user interface 719 in FIG. 7F or FIG. 7J) (e.g., a user interface that includes one or more content items (e.g., one or more selectable content items and/or media items (e.g., photos and/or videos)) and/or representations of one or more content items (e.g., selectable representations of one or more media items)). While displaying the user interface (904), the computer system detects (906), via the one or more input devices, one or more user inputs (e.g., 718, 732, 733, 734) (e.g., one or more tap inputs, one or more gestures (e.g., one or more air gestures), and/or one or more other inputs) corresponding to a zoom-in user command (e.g., a one-handed pinch gesture, a one-handed double pinch gesture, a two-handed pinch gesture, and/or a two-handed de-pinch gesture). In response to detecting the one or more user inputs corresponding to the zoom-in user command (908): in accordance with a determination that a user gaze (e.g., 714) (e.g., a user gaze detected while detecting the one or more user inputs and/or subsequent to detecting the one or more user inputs) corresponds to a first position in the user interface (910) (e.g., in accordance with a determination that a user is gazing at the first position in the user interface), the computer system displays (912), via the display generation component, the user interface at a second zoom level that is greater than the first zoom level (e.g., user interface 708 in FIG. 7E; user interface 719 in FIG. 7G; user interface 719 in FIG. 7H; user interface 719 in FIG. 7K), wherein displaying the user interface at the second zoom level includes zooming the user interface using a first zoom center that is selected based on the first position (e.g., maintaining the first position of the user interface at its current display position on the display generation component while expanding and/or zooming the user interface (e.g., maintaining the first position of the user interface at its current display position on the display generation component for at least a portion of the zooming operation)); and in accordance with a determination that the user gaze (e.g., a user gaze detected while detecting the one or more user inputs and/or subsequent to detecting the one or more user inputs) corresponds to a second position in the user interface different from the first position (914) (e.g., in accordance with a determination that a user is gazing at the second position in the user interface), the computer system displays (916), via the display generation component, the user interface at a third zoom level that is greater than the first zoom level (e.g., a third zoom level that is equal to or different from the second zoom level) (e.g., user interface 708 in FIG. 7E; user interface 719 in FIG. 7G; user interface 719 in FIG. 7H; user interface 719 in FIG. 7K), wherein displaying the user interface at the third zoom level includes zooming the user interface using a second zoom center that is selected based on the second position and the second zoom center is at a different location than the first zoom center (e.g., maintaining the second position of the user interface at its current display position on the display generation component while expanding and/or zooming the user interface (e.g., maintaining the second position of the user interface at its current display position on the display generation component for at least a portion of the zooming operation)). Displaying the user interface at the second zoom level using a first zoom center that is selected based on the position of a user gaze in response to detecting the one or more user inputs corresponding to the zoom-in user command provides the user with visual feedback about the state of the system (e.g., that the system has detected the one or more user inputs, and has detected the position of the user gaze), which provides improved visual feedback.

In some embodiments, the one or more user inputs corresponding to the zoom-in user command (e.g., 718, 732, 733, or 734) includes: a first pinch gesture (e.g., an air gesture) (e.g., a gesture in which two fingers move closer to one another (e.g., a gesture in which an index finger and a thumb of a hand move closer to one another)) (e.g., a one-handed pinch gesture (e.g., two fingers from one hand moving closer to one another)); and a second pinch gesture (e.g., an air gesture) occurring subsequent to the first pinch gesture (e.g., a second one-handed pinch gesture (e.g., with the same hand as the first pinch gesture)) (e.g., a first pinch gesture and a second pinch gesture occurring and/or detected within a threshold duration of time of one another). Displaying the user interface at the second zoom level using a first zoom center that is selected based on the position of a user gaze in response to a first pinch gesture and a second pinch gesture provides the user with visual feedback about the state of the system (e.g., that the system has detected the first pinch gesture and the second pinch gesture, and has detected the position of the user gaze), which provides improved visual feedback.

In some embodiments, the one or more user inputs corresponding to the zoom-in user command (e.g., 718, 732, 733, or 734) includes a two-handed de-pinch gesture (e.g., an air gesture) (e.g., a gesture in which a first hand moves away from another hand) (e.g., a gesture in which a first hand making a pinched shape (e.g., a predefined pinched shape (e.g., a shape in which the index finger and the thumb of the hand are in contact) moves away from a second hand making the pinched shape). Displaying the user interface at the second zoom level using a first zoom center that is selected based on the position of a user gaze in response to a two-handed de-pinch gesture provides the user with visual feedback about the state of the system (e.g., that the system has detected the two-handed de-pinch gesture, and has detected the position of the user gaze), which provides improved visual feedback.

In some embodiments, in response to detecting the one or more user inputs corresponding to the zoom-in user command (e.g., 718, 732, 733, or 734): in accordance with a determination that the user interface is displaying a first media item is of a first type (e.g., a non-panoramic image), the computer system displays the first media item at a first size (e.g., a first coverage area and/or a first set of dimensions)(e.g., a predefined maximum size for media items of the first type); and in accordance with a determination that the user interface is displaying a second media item of a second type different from the first type (e.g., a panoramic image (e.g., an image generated by stitching a plurality of image captures together in a particular direction) (e.g., an image having a set of dimensions (e.g., width and/or height) identified as panoramic dimensions)) (e.g., an image having an aspect ratio that is greater than a threshold aspect ratio (e.g., an image having an aspect ratio that is greater than and/or greater than or equal to 16:9)), the computer system displays the second media item at a second size (e.g., a second coverage area and/or a second set of dimensions) that is greater than the first size (e.g., a size greater than the predefined maximum size for media items of the first type) (e.g., media window 704 in FIGS. 7K-7L) (e.g., as described with reference to FIGS. 7J-7L). In some embodiments, panoramic images can be expanded to a larger size than non-panoramic images. Automatically displaying a second media item at a second size that is greater than the first size in accordance with a determination that the user interface is displaying a media item of a second type allows a user to display media items of the second type (e.g., panoramic images) at a greater size without requiring additional user inputs, which performs an operation when a set of conditions has been met without requiring further user input.

In some embodiments, in response to detecting the one or more user inputs corresponding to the zoom-in user command (e.g., 718, 732, 733, or 734): in accordance with a determination that the user interface is displaying a first media item of a first type (e.g., a non-panoramic image), the computer system displays the first media item as a flat object (e.g., a two-dimensional object, a non-curved object, a flat planar object, and/or an object having flat, non-curved surfaces); and in accordance with a determination that the user interface is displaying a second media item of a second type (e.g., a panoramic image (e.g., an image generated by stitching a plurality of image captures together in a particular direction) (e.g., an image having a set of dimensions (e.g., width and/or height) identified as panoramic dimensions)), the computer system displays the second media item as a curved object (e.g., a three-dimensional object, a curved planar object, and/or an object having one or more curved surfaces) (e.g., media window 704 in FIGS. 7K-7L) (e.g., as described with reference to FIGS. 7J-7L). In some embodiments, panoramic images are curved as they are zoomed, and non-panoramic images are not curved as they are zoomed. In some embodiments, when the computer system is a head-mounted device, the second media item occupies more of the user's field of view when the second media item is displayed as a curved object in contrast to when the first media item is displayed as a flat object. Automatically displaying a second media item as a curved object in accordance with a determination that the user interface is displaying a media item of a second type allows a user to display media items of the second type (e.g., panoramic images) as curved objects without requiring additional user inputs, which performs an operation when a set of conditions has been met without requiring further user input.

In some embodiments, displaying the user interface at the first zoom level includes displaying a representation of a first media item (e.g., a thumbnail representation of a first media item) at a first size (e.g., 710F in FIG. 7D); and a three-dimensional environment (e.g., 706) at least partially surrounds the user interface (e.g., 708) and includes background content (e.g., a representation of a physical or virtual environment) behind the user interface. In some embodiments, the background content at least partially surrounds the user interface. In some embodiments, the three-dimensional environment and/or the background content are displayed (e.g., behind the user interface) by the display generation component. In some embodiments, the three-dimensional environment and/or the background content are visible to a user (e.g., behind the user interface), but are not displayed by the display generation component (e.g., the three-dimensional environment and/or the background content are tangible physical objects that are visible by a user behind the user interface without being displayed by the display generation component). In some embodiments, in response to detecting the one or more user inputs corresponding to the zoom-in user command (e.g., 718): the computer system transitions the representation of the first media item from being displayed at the first size (e.g., 710F in FIG. 7D) to being displayed at a second size larger than the first size (e.g., 710F in FIG. 7F) (e.g., enlarging the display of the first media item); and reduces a visual emphasis of the background content relative to the first media item (e.g., three-dimensional environment 706 in FIG. 7F) (e.g., dimming the background content). In some embodiments, the background content is transitioned from being displayed at the first brightness level to being displayed at the second brightness level concurrently with the representation of the first media item transitioning from being displayed at the first size to being displayed at the second size. Displaying the background content in a darkened state when a user has zoomed in a first media item provides feedback to the user about the state of the system (e.g., that the system is displaying the first media item in a zoomed-in state), which provides improved visual feedback.

In some embodiments, displaying the user interface at the first zoom level includes displaying a representation of a first media item (e.g., a thumbnail representation of a first media item) at a first size (e.g., 710F in FIG. 7D). In some embodiments, in response to detecting the one or more user inputs corresponding to the zoom-in user command (e.g., 718): the computer system transitions the representation of the first media item from being displayed at the first size (e.g., 710F in FIG. 7D) to being displayed at a second size larger than the first size (e.g., 710F in FIG. 7F) (e.g., enlarging the display of the first media item); and displays a light spill effect (e.g., 726-1) extending from the user interface (e.g., 704) (e.g., extending from the first media item). In some embodiments, light spill effects include one or more visual characteristics (e.g., brightness, intensity, size and/or length, color, saturation, contrast) that are determined based on visual content (e.g., visual characteristics) of the first media item (e.g., different media items results in different light spill effects). In some embodiments, the light spill effect includes one or more of: a glow around the edge of the item; the appearance of light surrounding the item; the appearance of light ray around the item; and/or the appearance of a light source behind the middle or center of the item. In some embodiments, the size of the representation of the first media item is gradually increased in response to the one or more user inputs corresponding to the zoom-in user command. In some embodiments, the light spill effects extending from the user interface to the background content are gradually modified (e.g., gradually intensified) concurrently with the gradual increase in size of the representation of the first media item. Displaying the light spill effect when a user has zoomed in a first media item provides feedback to the user about the state of the system (e.g., that the system is displaying the first media item in a zoomed-in state), which provides improved visual feedback.

In some embodiments, displaying the user interface at the first zoom level includes displaying a first media item at a first size (e.g., 731 in FIGS. 7J, 7K) (e.g., displaying the representation of the first media item within a selected media user interface indicative of user selection of the first media item). In some embodiments, displaying the user interface at the second zoom level includes: displaying the first media item at a second size larger than the first size (e.g., 731 in FIG. 7L); in accordance with a determination that the second size is greater than a predetermined threshold size, displaying the first media item with a blurring effect applied to at least a first edge of the first media item (e.g., 736A or 736B); and in accordance with a determination that the second size is not greater than the predetermined threshold size, displaying the first media item without the blurring effect applied to any edges of the first media item (e.g., FIG. 7J). In some embodiments, the blurring effect is applied to the first edge of the first media item as an indication that additional content of the first media item extending beyond the first edge is not displayed and/or that the user can scroll in the direction of the first edge to view additional content of the first media item. In some embodiments, the blurring effect includes blurring visual content at the first edge of the first media item and/or otherwise visually obscuring visual content at the first edge of the first media item. In some embodiments, displaying the first media item without the blurring effect applied to any edges of the first media item is indicative of the entirety of the first media item being displayed. Displaying the first media item with the blurring effect applied to the first edge of the first media item provides feedback to the user about the state of the system (e.g., that there is additional content of the first media item extending beyond the first edge that is not displayed), which provides improved visual feedback.

In some embodiments, the user interface is a media library user interface (e.g., 708) that includes representations of a plurality of media items (e.g., 710A-710F) in a media library (e.g., a collection of media items associated with a device (e.g., stored on the device) and/or associated with a user), including a representation of a first media item and a representation of a second media item. In some embodiments, displaying the user interface at the first zoom level includes concurrently displaying: the representation of the first media item at a first size (e.g., having a first set of dimensions (e.g., height and/or width)), and the representation of the second media item at a second size (in some embodiments, the second size is different from or the same as the first size) (e.g., 708 in FIG. 7D). In some embodiments, displaying the user interface at the second zoom level includes concurrently displaying: the representation of the first media item at a third size larger than the first size; and the representation of the second media item at a fourth size larger than the second size (e.g., FIG. 7E). In some embodiments, the fourth size is different from or the same as the third size. In some embodiments, displaying the user interface at the first zoom level includes displaying a media library grid with representations of a plurality of media items, and displaying the user interface at the second zoom level includes zooming in on the media library grid (e.g., displaying representations of fewer media items, but at larger sizes). Displaying the representation of the first media item at the third size and displaying the representation of the second media item at the fourth size in response to detecting the one or more user inputs corresponding to the zoom-in user command provides the user with visual feedback about the state of the system (e.g., that the system has detected the one or more user inputs corresponding to the zoom-in user command), which provides improved visual feedback.

In some embodiments, displaying the user interface at the first zoom level includes displaying the user interface at a first size (e.g., having a first set of dimensions (e.g., height and/or width)). In some embodiments, in response to detecting the one or more user inputs corresponding to the zoom-in user command: in accordance with a determination that the user interface is a first user interface (e.g., 719) (e.g., a selected media user interface (e.g., a user interface displaying a media item selected by a user, and/or a user interface indicative of and/or response to user selection of a media item)), the computer system displays the user interface at a second size that is larger than the first size (e.g., selected media user interface 719 in FIGS. 7J-7L); and in accordance with a determination that the user interface is a second user interface different from the first user interface (e.g., 708) (e.g., a media library user interface (e.g., a user interface displaying representations of a plurality of media items of a media library)), the computer system maintains the user interface at the first size (e.g., media library user interface 708 in FIGS. 7D-7E) (in some embodiments, a selected media user interface (e.g., 719) can be expanded to a larger size in response to a zoom-in command, while a media library user interface (e.g., 708) is not expanded to a larger size in response to a zoom-in command). Displaying the user interface at the second size that is larger than the first size in response to detecting the one or more user inputs corresponding to the zoom-in user command provides the user with visual feedback about the state of the system (e.g., that the system has detected the one or more user inputs corresponding to the zoom-in user command), which provides improved visual feedback.

In some embodiments, aspects/operations of methods 800, 900, 1000 and 1100 may be interchanged, substituted, and/or added between these methods. For example, the media library user interface displayed in method 800 is optionally the user interface displayed in method 900, and/or the first media item displayed in method 800 is optionally the first media item displayed in methods 900 and/or 1000. For brevity, these details are not repeated here.

FIG. 10 is a flow diagram of an exemplary method 1000 for interacting with media items and user interfaces, in accordance with some embodiments. In some embodiments, method 1000 is performed at a computer system (e.g., 700) (e.g., computer system 101 in FIG. 1) that is in communication with a display generation component (e.g., 702) (e.g., a display controller; a touch-sensitive display system; a display (e.g., integrated and/or connected), a 3D display, a transparent display, a projector, and/or a heads-up display) and one or more input devices (e.g., 715) (e.g., a touch-sensitive surface (e.g., a touch-sensitive display); a mouse; a keyboard; a remote control; a visual input device (e.g., a camera); an audio input device (e.g., a microphone); and/or a biometric sensor (e.g., a fingerprint sensor, a face identification sensor, and/or an iris identification sensor)). In some embodiments, the method 1000 is governed by instructions that are stored in a non-transitory (or transitory) computer-readable storage medium and that are executed by one or more processors of a computer system, such as the one or more processors 202 of computer system 101 (e.g., control 110 in FIG. 1). Some operations in method 1000 are, optionally, combined and/or the order of some operations is, optionally, changed.

In some embodiments, the computer system (e.g., 700) detects (1002), via the one or more input devices, one or more user inputs (e.g., 718) (e.g., one or more tap inputs, one or more gestures (e.g., one or more air gestures), and/or one or more other inputs) corresponding to selection of a first media item (e.g., 710F) (e.g., a one-handed pinch gesture and/or a two-handed de-pinch gesture while the gaze of the user is directed to and/or maintained on the first media item) (e.g., selection of a first media item of a media library; selection of a first media item of a plurality of media items in a media library; selection of a first media item of a plurality of media items; and/or selection of a first media item of a plurality of displayed media items (e.g., selection of a representation of a first media item of a plurality of displayed representations of media items)). In response to detecting the one or more user inputs corresponding to selection of the first media item (1004): in accordance with a determination that the first media item is a media item that includes a respective type of depth information (1006) (e.g., a stereoscopic media item with media captured at the same time from two different cameras (or sets of cameras) that is displayed by displaying an image from a first set of one or more cameras for a first eye of a user and an image from a second set of one or more cameras for a second eye of the user), the computer system displays (1008), via the display generation component, the first media item in a first manner (e.g., FIG. 7F) (e.g., having a first set of visual characteristics); and in accordance with a determination that the first media item is a media item that does not include the respective type of depth information (1010), the computer system displays (1012), via the display generation component, the first media item in a second manner (e.g., having a second set of visual characteristics) different from the first manner (e.g., FIG. 7J) (e.g., as described with reference to FIGS. 7F and 7J). Displaying the first media item in the first manner in accordance with a determination that the first media item is a media item that includes a respective type of depth information provides the user with visual feedback about the state of the system (e.g., that the system has determined that the first media item includes the respective type of depth information), which provides improved visual feedback.

In some embodiments, displaying the first media item in the first manner includes displaying the first media item having a first type of border (e.g., a surrounding edge and/or boundary) surrounding the first media item (e.g., a first border having a first shape, a first border having a first set of visual characteristics) (e.g., a first border having refractive edges and/or a first border having rounded corners) (e.g., FIG. 7F). In some embodiments, displaying the first media item in the second manner includes displaying the first media item having a second type of border (e.g., a surrounding edge and/or boundary) different from the first border surrounding the first media item (e.g., a second border having a second shape, a second border having a second set of visual characteristics) (e.g., a second border having non-refractive edges and/or a second border having non-rounded (e.g., rectangular and/or pointed) corners) (e.g., FIG. 7J) (e.g., as described with reference to FIG. 7F). In some embodiments, a media library (e.g., presented in a media library user interface) includes a set of media items (e.g., a plurality of media items) of the first type, and a set of media items (e.g., a plurality of media items) of the second type. In response to detecting one or more user inputs corresponding to selection of a respective media item of the first type, the computer system displays the respective media item of the first type in the first manner, including displaying the respective media item of the first type having the first type of border surrounding the respective media item of the first type. In response to detecting one or more user inputs corresponding to selection of a respective media item of the second type, the computer system displays the respective media item of the second type in the second manner, including displaying the respective media item of the second type having the second type of border surrounding the respective media item of the second type. In some embodiments, media items of the first type are displayed in the first manner, including being displayed with the first type of border, and media items of the second type are displayed in the second manner, including being displayed with the second type of border. Displaying the border of a first media item differently based on whether the first media item includes the respective type of depth information provides the user with visual feedback about the state of the system (e.g., whether or not the first media item includes the respective type of depth information), which provides improved visual feedback.

In some embodiments, when the first media item is displayed in the first manner, content (e.g., background content) at least partially surrounding (e.g., entirely surrounding) the first media item (e.g., 706) (e.g., background content displayed behind the first media item and partially surrounding the first media item) has (e.g., is modified by the display generation component to have) a first appearance (e.g., FIG. 7F) (e.g., having a third set of visual characteristics) (e.g., having selectable controls displayed outside of the boundaries of the first media item and/or having a third set of lighting effects applied to the background content); and when the first media item is displayed in the second manner, the content (e.g., background content) at least partially surrounding (e.g., entirely surrounding) the first media item has (e.g., is modified by the display generation component to have) a second appearance different from the first appearance (e.g., FIG. 7J) (e.g., having a fourth set of visual characteristics) (e.g., without displaying selectable controls outside of the boundaries of the first media item and/or having a fourth set of lighting effects applied to the background content) (e.g., as described with reference to FIG. 7F). In some embodiments, the content at least partially surrounding the first media item is displayed by the display generation component. In some embodiments, the content at least partially surrounding the first media item is not displayed by the display generation component (e.g., the content at least partially surrounding the first media item includes one or more tangible physical objects that are visible by a user behind the user interface without the content being displayed by the display generation component). Displaying content surrounding the first media item differently based on whether the first media item includes the respective type of depth information provides the user with visual feedback about the state of the system (e.g., whether or not the first media item includes the respective type of depth information), which provides improved visual feedback.

In some embodiments, the computer system displays a set of light rays (e.g., 726-1, 726-2, 726-3, 726-4, 730-1, 730-2, 730-3, or 730-4) extending from the first media item (e.g., a light spill lighting effect) (e.g., light rays extending from the outer boundaries of the first media item into background content at least partially surrounding the first media item). In some embodiments, light rays are visual effects for which one or more visual characteristics of the light rays (e.g., brightness, intensity, size, length, color, saturation, and/or contrast) is determined based on visual content (e.g., visual characteristics) of the first media item (e.g., different media items results in different light spill light rays). In some embodiments, displaying the first media item in the second manner includes forgoing displaying the set of light rays extending from the first media item. In some embodiments, the set of light rays extending from the first media item change over time (e.g., the set of light rays extending from the first media item change over time as visual content of the first media item changes over time (e.g., as visual content (e.g., video content) of the first media item plays)). Displaying a set of light rays extending from the first media item in response to detecting one or more user inputs corresponding to selection of the first media item provides the user with visual feedback about the state of the system (e.g., that the system has detected the one or more user inputs corresponding to selection of the first media item), which provides improved visual feedback.

In some embodiments, the one or more visual characteristics of the set of light rays (e.g., brightness, intensity, size, length, color, saturation, and/or contrast) (e.g., 726-1, 726-2, 726-3, 726-4, 730-1, 730-2, 730-3, or 730-4) is determined based on one or more colors at the edges (e.g., at the outer boundaries or within a predetermined distance from an edge) of the first media item (e.g., as described with reference to FIG. 7F) (for example, in some embodiments, visual characteristics of light rays extending from a first edge of the first media item are determined based on colors displayed on the first edge of the first media item and/or visual characteristics of light rays extending from a second edge of the first media item are determined based on colors displayed on the second edge of the first media item). Displaying a set of light rays extending from the first media item in response to detecting one or more user inputs corresponding to selection of the first media item provides the user with visual feedback about the state of the system (e.g., that the system has detected the one or more user inputs corresponding to selection of the first media item), which provides improved visual feedback.

In some embodiments, the set of light rays (e.g., 726-1, 726-2, 726-3, 726-4, 730-1, 730-2, 730-3, or 730-4) includes a first light ray having a first length and a second light ray having a second length different from the first length (e.g., the set of light rays includes rays that have different or variable lengths). In some embodiments, the set of light rays includes a third light ray having a third length different from the first length and the second length. In some embodiments, the first light ray extends from a first side (e.g., top, bottom, left, and/or right) of the first media item, the second light ray extends from a second side of the first media item different from the first size, a third light ray extends from a third side of the first media item different from the first and second sides, and a fourth light ray extends from a fourth side of the first media item different from the first, second, and third sides. Displaying a set of light rays extending from the first media item in response to detecting one or more user inputs corresponding to selection of the first media item provides the user with visual feedback about the state of the system (e.g., that the system has detected the one or more user inputs corresponding to selection of the first media item), which provides improved visual feedback.

In some embodiments, the first media item includes the respective type of depth information (e.g., a stereoscopic media item with media captured at the same time from two different cameras (or sets of cameras) that is displayed by displaying an image from a first set of one or more cameras for a first eye of a user and an image from a second set of one or more cameras for a second eye of the user), and the first media item was captured by the computer system (e.g., 700) (e.g., using a plurality of cameras connected to and/or integrated in the computer system). In some embodiments, prior to detecting the one or more user inputs, the computer system captures, via the one or more input devices, the first media item (e.g., using a plurality of cameras connected to and/or integrated in the computer system). In some embodiments, a media item includes the respective type of depth information if the first media item is a stereoscopic capture (e.g., a stereoscopic media item). In some embodiments, a stereoscopic capture includes two images that are captured at the same time from two different cameras that are spaced apart (e.g., spaced apart at approximately the same distances as a person's eyes), and the two images are displayed at the same time to a user (a first image for a first eye of the user, and a second image for a second eye of the user) to recreate the depth of the captured scene. In some embodiments, when the computer system is a head-mounted device and when the first media item includes depth information, the computer system displays a first perspective of the physical environment included in the media item on a first display of the computer system and the computer system displays a second perspective of the physical environment included in the media item on a second display of the electronic device such that the user perceives a stereoscopic depth between content included in the media item.. Displaying the first media item in the first manner in accordance with a determination that the first media item is a media item that includes a respective type of depth information provides the user with visual feedback about the state of the system (e.g., that the system has determined that the first media item includes the respective type of depth information), which provides improved visual feedback.

In some embodiments, displaying the first media item in the first manner includes displaying the first media item with a first set of lighting effects (e.g., 726-1, 726-2, 726-3, or 726-4) (e.g., a first set of light spill lighting effects extending from the first media item (e.g., a first set of light spill lighting effects having one or more visual characteristics (e.g., brightness, intensity, size, length, color, saturation, and/or contrast) determined based on visual content of the first media item)). In some embodiments, displaying the first media item in the second manner includes displaying the first media item with a second set of lighting effects (e.g., 730-1, 730-2, 730-3, or 730-4) (e.g., a second set of lighting effects different from the first set of lighting effects or a second set of lighting effects that are the same as the first set of lighting effects) (e.g., a second set of light spill light effects extending from the first media item (e.g., a second set of light spill lighting effects having one or more visual characteristics (e.g., brightness, intensity, size, length, color, saturation, and/or contrast) determined based on visual content of the first media item)). For example, in some embodiments, regardless of whether the first media item is a media item that includes a respective type of depth information (e.g., is a stereoscopic media item) or is a media item that does not include the respective type of depth information (e.g., is not a stereoscopic media item), the first media item is displayed with lighting effects applied to the first media item. In some embodiments, regardless of whether the first media item is a media item that includes a respective type of depth information (e.g., is a stereoscopic media item) or is a media item that does not include the respective type of depth information (e.g., is not a stereoscopic media item), the first media item is displayed with light spill light rays extending from the first media item. In some embodiments, the light spill light rays extending from the first media item differ based on whether the first media item includes the respective type of depth information or does not include the respective type of depth information (e.g., one or more algorithms for determining the light spill light rays extending from the first media item differ based on whether the first media item includes the respective type of depth information or does not include the respective type of depth information). Displaying the first media item with the first set of lighting effects or the second set of lighting effects in response to detecting the one or more user inputs corresponding to selection of the first media item provides the user with visual feedback about the state of the system (e.g., that the system has detecting the one or more user inputs corresponding to selection of the first media item), which provides improved visual feedback.

In some embodiments, the first set of lighting effects (e.g., 726-1, 726-2, 726-3, or 726-4) are determined based on a first set of colors at the edges of the first media item (e.g., colors displayed at an outermost edge, border, and/or boundary of the first media item) (e.g., within a predetermined distance from an edge) and based on a second set of colors interior to the edges of the first media item (e.g., colors displayed in an interior portion of the first media item (e.g., not on an edge of first media item) (e.g., greater than the predetermined distance from an edge) (e.g., closer to a center and/or further from the edge of the first media item than the first set of colors)), and the first set of colors are given greater weight than the second set of colors in determining the first set of lighting effects. In some embodiments, the second set of lighting effects (e.g., 730-1, 730-2, 730-3, or 730-4) are determined based on a third set of colors at the edges of the first media item (e.g., colors displayed at an outermost edge, border, and/or boundary of the first media item)(e.g., within a predetermined distance from an edge) and based on a fourth set of colors interior to the edges of the first media item (e.g., colors displayed in an interior portion of the first media item (e.g., not on an edge of first media item) (e.g., greater than the predetermined distance from an edge) (e.g., closer to a center and/or further from the edge of the first media item than the third set of colors)), and the third set of colors are given greater weight than the fourth set of colors in determining the second set of lighting effects (e.g., as described with reference to FIG. 7F). Displaying the first media item with the first set of lighting effects or the second set of lighting effects in response to detecting the one or more user inputs corresponding to selection of the first media item provides the user with visual feedback about the state of the system (e.g., that the system has detecting the one or more user inputs corresponding to selection of the first media item), which provides improved visual feedback.

In some embodiments, the first set of lighting effects and the second set of lighting effects include: light emitted in front of the first media item (e.g., light extending outward from a front surface of the first media item); and light emitted behind the first media item (e.g., light extending outward from a back surface of the first media item) (e.g., light emitted in front of media window 704 and light emitted behind media window 704) (e.g., as described with reference to FIG. 7F). For example, in some embodiments, regardless of whether the first media item is a media item that includes a respective type of depth information (e.g., is a stereoscopic media item) or is a media item that does not include the respective type of depth information (e.g., is not a stereoscopic media item), the first media item is displayed with lighting effects that includes light emitted in front of the first media item and light emitted behind the first media item. In some embodiments, the light emitted in front of the first media item and/or the light emitted behind the first media item reflects off of other content that is visible to the user (e.g., content that at least partially surrounds the first media item (e.g., background content)). In some embodiments, the other content that is visible to the user is displayed by the display generation component. In some embodiments, the other content that is visible to the user is not displayed by the display generation component (e.g., the other content includes physical (e.g., real) background content that is visible behind the first media item, but is not displayed by the display generation component). Displaying the first media item with the first set of lighting effects or the second set of lighting effects, including light emitted in front of the first media item and light emitted behind the first media item, in response to detecting the one or more user inputs corresponding to selection of the first media item provides the user with visual feedback about the state of the system (e.g., that the system has detecting the one or more user inputs corresponding to selection of the first media item), which provides improved visual feedback.

In some embodiments, displaying the first media item in the first manner includes: in accordance with a determination that the first media item is a video, displaying the first media item with a third set of lighting effects (e.g., 726-4); and in accordance with a determination that the first media item is a still image, displaying the first media item with a fourth set of lighting effects (e.g., 726-1, 726-2, or 726-3) (e.g., a fourth set of lighting effects the same as or different from the third set of lighting effects). In some embodiments, displaying the first media item in the second manner includes: in accordance with a determination that the first media item is a video, displaying the first media item with a fifth set of lighting effects (e.g., 730-4); and in accordance with a determination that the first media item is a still image, displaying the first media item with a sixth set of lighting effects (e.g., 730-1, 730-2, or 730-3) (e.g., as described with reference to FIGS. 7F, 7N, and 7M) (e.g., a sixth set of lighting effects the same as or different from the fifth set of lighting effects). In some embodiments, regardless of whether the first media item is a still image or a video, the first media item is displayed with lighting effects applied to the first media item. In some embodiments, the lighting effects differ based on whether the first media item is a video or a still image. In some embodiments, the lighting effects are the same regardless of whether the first media item is a video or a still image. In some embodiments, the third set of lighting effects and the fifth set of lighting effects (e.g., lighting effects for videos) change over time (e.g., a set of light rays extending from the first media item change over time as visual content of the first media item changes over time (e.g., as video content of the first media item is played)). Displaying the first media item with the first set of lighting effects or the second set of lighting effects in response to detecting the one or more user inputs corresponding to selection of the first media item provides the user with visual feedback about the state of the system (e.g., that the system has detecting the one or more user inputs corresponding to selection of the first media item), which provides improved visual feedback.

In some embodiments, the first media item is a video; and the first set of lighting effects (e.g., 730-4 or 726-4) at a respective playback time in the video includes a lighting effect that is generated based on content from the video from multiple playback times in the video, including the respective playback time in the video (e.g., as described with reference to FIGS. 7F, 7N, and 7M) (e.g., the lighting effect emits light from the video based on time averaged content from the video, so that content from multiple frames is combined to generate an average color that is used to generate the lighting effect). In some embodiments, displaying the first media item with the first set of lighting effects applied includes: in accordance with a determination that the first media item is a video, applying a first smoothing function to a first initial set of lighting effects (e.g., determining the set of lighting effects by applying a first smoothing function to a first initial set of lighting effects) (in some embodiments, the first smoothing function smooths the first initial set of lighting effects over a period of time (e.g., a predetermined duration of time)). In some embodiments, displaying the first media item with the second set of lighting effects applied includes: in accordance with a determination that the first media item is a video, applying a second smoothing function (in some embodiments, the second smoothing function is the same as or different from the first smoothing function) to a second initial set of lighting effects (e.g., determining the set of lighting effects by applying a second smoothing function to a second initial set of lighting effects) (in some embodiments, the second smoothing function smooths the second initial set of lighting effects over a period of time (e.g., a predetermined duration of time)). Displaying the first media item with the first set of lighting effects or the second set of lighting effects in response to detecting the one or more user inputs corresponding to selection of the first media item provides the user with visual feedback about the state of the system (e.g., that the system has detecting the one or more user inputs corresponding to selection of the first media item), which provides improved visual feedback.

In some embodiments, displaying the first media item in the first manner includes visually distorting one or more edges of the first media item (e.g., as described with reference to FIG. 7F) (e.g., visually obscuring and/or blurring) (e.g., visually distorting all edges and/or the entire outer border and/or boundary of the first media item). In some embodiments, displaying the first media item in the first manner includes displaying glassy edges that show some distortion. In some embodiments, displaying the first media item in the second manner includes forgoing visually distorting the one or more edges of the first media item (e.g., forgoing visually distorting any edge and/or outer boundary of the first media item). Displaying the first media item with one or more edges visually distorted based on the first media item including the respective type of depth information provides the user with visual feedback about the state of the system (e.g., that the first media item includes the respective type of depth information), which provides improved visual feedback.

In some embodiments, while displaying the first media item in the first manner: the computer system detects, via the one or more input devices, a user gaze (e.g., 714) corresponding to a first position in the first media item (e.g., detecting and/or determining that a user is gazing at the first position in the first media item); and in response to detecting the user gaze corresponding to the first position in the first media item, the computer system displays at least a portion of the first media item moving backwards (e.g., away from a viewpoint of the user) (e.g., as described with reference to FIGS. 7A-7D). Displaying the first media item moved backwards based on the first media item including the respective type of depth information and in response to detecting the user gaze corresponding to the first position provides the user with visual feedback about the state of the system (e.g., that the system has determined that the first media item includes the respective type of depth information and has detected the user gaze corresponding to the first position), which provides improved visual feedback.

In some embodiments, displaying the first media item in the first manner includes blurring one or more edges of the first media item (e.g., blurring all edges and/or the entire outer border and/or boundary of the first media item). In some embodiments, displaying the first media item in the second manner includes forgoing blurring the one or more edges of the first media item (e.g., forgoing blurring any edge or boundary of the first media item) (e.g., as described with reference to FIG. 7F). Displaying the first media item with one or more edges of the first media item blurred based on the first media item including the respective type of depth information provides the user with visual feedback about the state of the system (e.g., that the system has determined that the first media item includes the respective type of depth information), which provides improved visual feedback.

In some embodiments, displaying the first media item in the first manner includes: displaying the first media item with a first set of light spill lighting effects (e.g., 726-1) extending from the first media item (e.g., 704) (e.g., a first set of light spill lighting effects having one or more visual characteristics (e.g., brightness, intensity, size, length, color, saturation, and/or contrast) determined based on visual content of the first media item); and displaying, concurrently with the first set of light spill lighting effects, one or more additional lighting effects (e.g., as described with reference to FIG. 7F) (e.g., additional light rays extending from the first media item, additional light surrounding the first media item, lighting effects applied to a border of the first media item (e.g., refractive and/or glassy borders), and/or one or more smoothing functions applied to lighting effects extending from the first media item). In some embodiments, displaying the first media item in the second manner includes: displaying the first media item with a second set of light spill lighting effects (e.g., 730-1) (e.g., a second set of light spill lighting effects having one or more visual characteristics (e.g., brightness, intensity, size, length, color, saturation, and/or contrast) determined based on visual content of the first media item) (in some embodiments, the same as the first set of light spill lighting effects or different from the first set of light spill lighting effects) extending from the first media item (e.g., 704) without applying the one or more additional lighting effects (e.g., as described with reference to FIG. 7F). Displaying the first media item with one or more additional lighting effects based on the first media item including the respective type of depth information provides the user with visual feedback about the state of the system (e.g., that the system has determined that the first media item includes the respective type of depth information), which provides improved visual feedback.

In some embodiments, displaying the first media item in the first manner includes displaying the first media item within a three-dimensional shape (e.g., 704 in FIG. 7I) with continuous edges (e.g., as described with reference to FIGS. 7F and 7I) (e.g., a three-dimensional shape without sharp and/or pointed corners, for example a shape that is continuous and smooth, such as a convex shape with a surface that differentiable with a respective number (e.g., 2, 3, 4, 10, 100, or infinite) of continuous derivatives)). In some embodiments, displaying the first media item in the second manner includes forgoing displaying the first media item within the three-dimensional shape with continuous edges (e.g., displaying the first media item in a two-dimensional shape, and/or in a three-dimensional shape that does not have continuous edges (e.g., that has sharp and/or pointed corners) and/or in a different three-dimensional shape). Displaying the first media item within the three-dimensional shape with continuous edges based on the first media item including the respective type of depth information provides the user with visual feedback about the state of the system (e.g., that the system has determined that the first media item includes the respective type of depth information), which provides improved visual feedback. In some embodiments, when the computer system is a head mounted device, computer system 700 displays different perspectives of the three-dimensional shape of the first media item in response to the computer system detecting that the user has repositioned themselves within a physical environment and/or rotated their head (e.g., while the user wears computer system 700 on their head).

In some embodiments, the three-dimensional shape with continuous edges includes a curved front surface and a curved back surface (e.g., 704 in FIG. 7I) (e.g., as described with reference to FIGS. 7F and 7I) (e.g., a curved back surface positioned directly across from and/or opposite to the curved front surface). Displaying the first media item within the three-dimensional shape with continuous edges based on the first media item including the respective type of depth information provides the user with visual feedback about the state of the system (e.g., that the system has determined that the first media item includes the respective type of depth information), which provides improved visual feedback.

In some embodiments, the three-dimensional shape with continuous edges has one or more refractive edges that apply refractive properties to (e.g., deflect, bend, or change direction of) light being emitted from the one or more refractive edges (e.g., 704 in FIG. 7I) (e.g., as described with reference to FIGS. 7F and 7I). Displaying the first media item within the three-dimensional shape with continuous edges based on the first media item including the respective type of depth information provides the user with visual feedback about the state of the system (e.g., that the system has determined that the first media item includes the respective type of depth information), which provides improved visual feedback.

In some embodiments, the determination that the first media item is a media item that includes a respective type of depth information is a determination that the first media item is a stereoscopic media item that includes media captured at the same time from two different cameras (or two different sets of cameras) (e.g., as described with reference to FIGS. 7A-7D). In some embodiments, a stereoscopic media item is displayed by displaying a first image captured by a first set of one or more cameras for a first eye of a user, and displaying (e.g., concurrently and/or at the same time with the first image) a second image captured by a second set of one or more camera for a second eye of the user. In some embodiments, a stereoscopic media item includes two different images that are captured at the same time from two different cameras that are spaced apart (e.g., spaced apart at approximately the same distances as a person's eyes), and the two different images are displayed at the same time to a user (a first image displayed to a first eye of the user, and a second image different from the first image displayed to a second eye of the user) to recreate the depth of the captured scene. Displaying the first media item in the first manner in accordance with a determination that the first media item is a stereoscopic media item that includes media captured at the same time from two different cameras provides the user with visual feedback about the state of the system (e.g., that the system has determined that the first media item is a stereoscopic media item that includes media captured at the same time from two different cameras), which provides improved visual feedback.

In some embodiments, displaying the first media item in the first manner includes displaying one or more controls (e.g., 728A, 728B, 728C, or 740) (e.g., playback controls (e.g., play, pause, rewind, fast forward), a share option, and/or a close option) outside of the outer boundaries of the first media item (e.g., outside of media window 704) (e.g., FIGS. 7F-7H and 7N) (e.g., not overlaid on the first media item). In some embodiments, displaying the first media item in the second manner includes displaying the one or more controls overlaid on the first media item. In some embodiments, the one or more controls includes a first control that is selectable to close (e.g., cease display of) the first media item (e.g., a close option). In some embodiments, the one or more controls includes a second control that is selectable to initiate a process for sharing the first media item to one or more external electronic devices (e.g., a share option). In some embodiments, the one or more controls includes a third control that is selectable to resume and/or initiate playback of the first media item (e.g., a play option). In some embodiments, the one or more controls includes a fourth control that is selectable to pause playback of the first media item (e.g., a pause option). In some embodiments, the one or more controls includes a fifth control that is selectable to skip forward in and/or speed up playback of the first media item (e.g., a fast forward option). In some embodiments, the one or more controls includes a sixth control that is selectable to skip backward, slow down, and/or reverse playback of the first media item (e.g., a rewind option). Displaying the first media item with one or more controls displayed outside the outer boundaries of the first media item based on the first media item including the respective type of depth information provides the user with visual feedback about the state of the system (e.g., that the system has determined that the first media item includes the respective type of depth information), which provides improved visual feedback.

In some embodiments, aspects/operations of methods 800, 900, 1000 and 1100 may be interchanged, substituted, and/or added between these methods. For example, the media library user interface displayed in method 800 is optionally the user interface displayed in method 900, and/or the first media item displayed in method 800 is optionally the first media item displayed in methods 900 and/or 1000. For brevity, these details are not repeated here.

FIGS. 11A-11F illustrate examples of displaying media. FIG. 1200 is a flow diagram of an exemplary method 1200 for displaying media. The user interfaces in FIGS. 11A-11F are used to illustrate the processes described below, including the process in FIG. 12.

FIG. 11A depicts computer system 700, which is a tablet that includes display device 702 and one or more cameras (e.g., computer system 700 is in wired communication and/or wireless communication with the one or more cameras). Though FIG. 11A depicts computer system 700 as a tablet, the techniques described blow are applicable to head-mounted devices. In some embodiments, where computer system 700 is a head-mounted device, computer system 700 optionally includes two displays (one for each eye of the user of computer system 700), with each display displaying various content. When computer system 700 is a head-mounted device, computer system 700 displays various elements (e.g., such as visual effect 1112 discussed below) stereoscopically to create a perception of depth. Further, when computer system 700 is a head-mounted device, a user may walk around a physical environment and/or turn their head to get a different perspective of an object, such as virtual portal 1102.

As illustrated in FIG. 11A, computer system 700 displays, display device 702, media user interface 1104. As illustrated in FIG. 11A, media user interface includes representation of physical environment 1106. At FIG. 11A, chair 1106a, couch 1106b, and water dispenser 1106c are within the field-of-view of the one or more cameras that are in communication with computer system 700. At FIG. 11A, because chair 1106a, couch 1106b, and water dispenser 1106c are within the field-of-view of the one or more cameras that are in communication with computer system 700, representation of physical environment 1106 includes chair 1106a, couch 1106b, and water dispenser 1106c. When a user looks at display device (e.g., a touch-sensitive display) 702, the user can see representation of physical environment 1106 along with one or more virtual objects that computer system 700 displays (e.g., as shown in FIGS. 11A-11F). Thus, computer system 700 presents an augmented reality environment through display device 702. In some embodiments, content included in representation of physical environment 1106 corresponds to content that is visible (e.g., to a user) from the point of view of computer system 700. In some embodiments, content that is included in representation of physical environment 1106 corresponds to content that is visible from the point of view of a user of computer system 700. In some embodiments, representation of physical environment 1106 is a physical environment that is visible to a user (e.g., through a transparent display) without being displayed by a display.

In the embodiment of FIGS. 11A-11F, the point of view of computer system 700 corresponds to the field-of-view of one or more cameras that are in communication with computer system 700. Accordingly, as computer system 700 is moved throughout the physical environment, the point of view of computer system 700 changes which causes the field-of-view of the one more cameras to correspondingly change.

As illustrated in FIG. 11A, computer system 700 displays virtual portal 1102 within representation of physical environment 1106. Computer system 700 displays virtual portal 1102 as a three-dimensional object within representation of physical environment 1106. Accordingly, computer system 700 displays virtual portal 1102 with an amount of depth. The amount of depth that computer system 700 displays virtual portal 1102 as having is directly correlated to the angle of the positioning of computer system 700 relative to the display of virtual portal 1102 (e.g., similar to how the thickness of a thin sheet of glass can be seen when an individual views the thin sheet of glass from an angle). The display of virtual portal 1102 is world-locked. Therefore, computer system 700 maintains the relative positioning of virtual portal 1102 within representation of physical environment 1106 as the point of view of computer system 700 changes (e.g., as computer system 700 is moved throughout the physical environment).

As illustrated in FIG. 11A, computer system 700 displays representation of media item 1108 within virtual portal 1102. A user can view representation of media item 1108 by looking through virtual window 1118. Virtual window 1118 is a translucent portion of virtual portal 1102 that a user can see through. Virtual window 1118 is positioned on the front side of virtual portal 1102 of. Representation of media item 1108 corresponds to a previously captured stereoscopic media item (e.g., photo or video) (e.g., a media item that is captured from a set of cameras (e.g., two or more cameras) (e.g., the set of cameras are space apart by approximately the same distance that human eyes are spaced apart) that are located at a common location in a physical environment, where each camera in the set of cameras captures a unique perspective of the physical environment). Further, as illustrated in FIG. 11A, computer system 700 displays visual effect 1112 as overlaid on top of representation of media item 1108. At FIG. 11A, visual effect 1112 is a blur effect that covers the content that is displayed at the edges of representation of media item 1108. In some embodiments, when computer system 700 is a head-mounted device, computer system 700 displays a first image (e.g. a first perspective of the environment depicted in representation of media item 1108) to a first eye of the user and computer system 700 displays a second image (e.g., second) perspective of the environment depicted in representation of media item 1108) to a second eye of the user such that a user views media item 1108 with a stereoscopic depth effect (e.g., displaying the separate images to different eyes of the user creates a stereoscopic depth effect).

At FIG. 11A, computer system 700 displays representation of media item 1108, back blur layer 1112a, and impinging blur layer 1112b within virtual portal 1102. Back blur layer 1112a and impinging blur layer 1112b are combined to create visual effect 1112 that computer system 700 displays as obscuring the edges of representation of media item 1108. Further, as illustrated in FIG. 11A, computer system 700 displays a vignette effect as part of displaying representation of media item 1108. Accordingly, as illustrated in FIG. 11A, computer system 700 displays the periphery of representation of media item 1108 as darker than the center of representation of media item 1108.

FIG. 11A includes schematic 1114 as a visual aid to help depict the positional relationship between the back blur layer, the impinging blur layer, and representation of media item 1108 within virtual portal 1102. Schematic 1114 includes representation of back blur layer 1114b (e.g., that corresponds to the back blur layer that is displayed in virtual portal 1102), representation of impinging blur layer 1114c (e.g., that corresponds to the impinging blur layer that is displayed within virtual portal 1102), representation of content 1114d (e.g., that corresponds to representation of media item 1108 that is displayed within virtual portal 1102) and representation of window 1114e (e.g., that corresponds to virtual window 1118 of virtual portal 1102).

At FIG. 11A, schematic 1114 depicts that representation of content 1114d is positioned between representation of back blur layer 1114b and representation of impinging blur layer 1114c. Accordingly, computer system 700 displays (e.g., renders) representation of media item 1108 between back blur layer 1112a and impinging blur layer 1112b within virtual portal 1102. Further, as illustrated by schematic 1114, back blur layer 1112a is wider than representation of content 1114d and impinging blur layer 1112b impinges on the edges of representation of media item 1108.

Back blur layer 1112a is a blur of an extrapolation of content that is at the edges of the stereoscopic media item that corresponds to representation of media item 1108. As the content that is at the edges of the stereoscopic media item changes (e.g., when the stereoscopic media item corresponds to a video media item), the content that is included in back blur layer 1112a changes based on the changes to the content at the edges of the stereoscopic media item.

Impinging blur layer 1112b is a blur of the content that is at the edges of the stereoscopic media item that corresponds to representation of media item 1108. Computer system 700 displays impinging blur layer 1112b as extending inwards from the edges of representation of media item 1108 towards the middle of representation of media item 1108. Further, impinging blur layer 1112b is a blur effect that decreases in magnitude (e.g., intensity) as impinging blur layer 1112b extends towards the center of the representation of media item 1108. That is, impinging blur layer 1112b becomes more translucent as impinging blur layer 1112b extends towards the center of representation of media item 1108 (e.g., impinging blur layer 1112b is feathered). Similar to back blur layer 1112a, the content that is blurred by impinging blur layer 1112b changes as the content at the edges of the stereoscopic media item changes (e.g., when the stereoscopic media item corresponds to a video media item).

As illustrated in FIG. 11A, schematic 1114 includes representation of electronic device 1114a. Representation of electronic device 1114a indicates the positioning of computer system 700 relative to the location of the display of virtual portal 1102. At FIG. 11A, as indicated by the positioning of representation of electronic device 1114a relative to representation of window 1114e in schematic 1114, computer system 700 is positioned at a location in the physical environment that is directly in front of the display of virtual portal 1102. Further, as indicated by the positioning of representation of content 1114d and representation of window 1114e in schematic 1114, computer system 700 displays representation of media item 1108 behind virtual window 1118 of virtual portal 1102 (e.g., representation of media item 1108 is further away from computer system 700 than virtual window 1118 of virtual portal 1102). In the embodiments of FIGS. 11A-11F the computer system 700 is being held and/or worn by a user. Accordingly, the point of view of computer system 700 corresponds to the point of view of the user.

At FIG. 11A, computer system 700 makes a determination that the positioning of computer system 700 is centered with the display of virtual portal 1102. At FIG. 11A, because computer system 700 makes a determination that the positioning of computer system 700 is centered with the display of virtual portal 1102, computer system 700 uniformly displays visual effect 1112 around the periphery of representation of media item 1108. At FIG. 11A, computer system 700 is repositioned within the physical environment. In some embodiments, when computer system 700 is a head-mounted device, computer system 700 separately displays visual effect 1112 uniformly around the periphery of representation of media item 1108 on two display devices that each correspond to different eyes of the user (e.g., computer system 700 separately displays visual effect 1112 uniformly around the periphery of representation of media item 1112 to the two eyes of the user). In some embodiments, computer system 700 concurrently displays two or more representations of stereoscopic media items with visual effect 1112. In some embodiments, computer system 700 displays a representation of a non-stereoscopic media item without visual effect 1112. In some embodiments, computer system 700 concurrently displays representation of media item 1108 with visual effect 1112 and a representation of a non-stereoscopic media item without visual effect 1112. In some embodiments, the representation of media item 1108 is a depiction of a media item that was captured via the one or more cameras that are in communication with computer system 700. In some embodiments, the representation of media item 1108 is a depiction of a media item that was captured via an external device that is in communication (e.g., wired communication and/or wireless communication) with computer system 700. In some embodiments, representation of media item 1108 is a representation of a physical environment that is captured from two or more unique perspectives and computer system 700 displays different perspectives of the physical environment to each eye of the user.

At FIG. 11B, computer system 700 makes a determination that computer system 700 is positioned to the right of the display of virtual portal 1102. Because computer system 700 makes a determination that computer system 700 is positioned to the right of the display of virtual portal 1102, computer system 700 displays virtual portal 1102 to the left of the center of display device 702 of computer system 700. Computer system 700 changes the location of the display of virtual portal 1102 on display device 702 based on the positioning of computer system 700 relative to the display of virtual portal 1102 (e.g., computer system 700 displays virtual portal 1102 to the right of the center of display device 702 if computer system 700 is positioned to the left of the display of virtual portal 1102). As explained above, the display of virtual portal 1102 is world locked. Accordingly, the position of the display of virtual portal 1102 relative to content included in representation of the physical environment 1106 does not change in response to the positioning of computer system 700 changing. In some embodiments, when computer system 700 is a head-mounted device, computer system 700 separately displays virtual portal 1102 to the left of center of two separate display devices that each correspond to different eyes of the user (e.g., computer system 700 separately displays visual effect 1112 to the left of center of the two separate display devices for each eye of the user).

Further, at FIG. 11B, because computer system 700 makes a determination that computer system 700 is positioned to the right of the display of virtual portal 1102, computer system 700 increases the size of visual effect 1112 that is displayed on the left boundary of virtual portal 1102. More specifically, computer system 700 increases the amount of back blur layer 1112a (e.g., that makes up part of visual effect 1112) that is displayed on the left boundary of virtual portal 1102.

The display of back blur layer 1112a is dynamic. That is, computer system 700 increases the amount of back blur layer 1112a that is displayed on a respective boundary of virtual portal 1102 when it is determined that the angle of the positioning of computer system 700 relative to the display of virtual portal 1102 increases. More specifically, computer system 700 increases the amount of back blur layer 1112a that is displayed on a boundary of virtual portal 1102 that is opposite the positioning of computer system 700 (e.g., computer system 700 increases the amount of back blur layer 1112a that is displayed on the right boundary of virtual portal 1102 if computer system 700 is positioned to the left of the display of virtual portal 1102 and vice versa). Accordingly, as the viewpoint of computer system 700 changes throughout the physical environment, the appearance of representation of media item 1108 changes based on the change of the viewpoint of computer system 700. More specifically, as the viewpoint of computer system 700 changes throughout the physical environment, the portion of representation of media item 1108 that is obscured by visual effect 1112 changes.

The amount of the back blur region that computer system 700 displays depends on of the relative angle between the positioning of computer system 700 and the display of virtual portal 1102. The greater the relative angle between the positioning of computer system 700 and the display of virtual portal 1102, the larger the amount of the back blur region that computer system 700 displays on the boundary of virtual portal 1102 that is opposite the position of computer system 700.

At 11B, computer system 700 makes a determination that computer system 700 is positioned closer to the display of virtual portal 1102 than the previous position of computer system 700 (e.g., in comparison to the positioning of computer system 700 at FIG. 11A). At FIG. 11B, because computer system 700 makes a determination that computer system 700 is positioned closer to the display of virtual portal 1102 than the previous position of computer system 700, computer system 700 increases the size of the display of virtual portal 1102 (e.g., in comparison to the size of the display of virtual portal 1102 at FIG. 11A) (e.g., to indicate that the distance between computer system 700 and the display of virtual portal 1102 within representation of physical environment 1106 has decreased).

As explained above, movement of computer system 700 causes the field-of-view of the one or more cameras that are in communication with computer system 700 to change. Further, as explained above, appearance of representation of the physical environment 1106 corresponds to the portion of the physical environment that is within the field-of-view of the one or more cameras. Accordingly, as computer system 700 is repositioned within the physical environment, the appearance of representation of physical environment 1106 correspondingly changes. Accordingly, at FIG. 11B, because the positioning of computer system 700 has shifted to the right within the physical environment, the positioning of the content included in representation of the physical environment 1106 (e.g., couch 1106b, and water dispenser 1106c) shift to the left within media user interface 1104 (e.g., in comparison to the positioning of the content included in representation of the physical environment 1106 at FIG. 11A).

As illustrated in FIG. 11B, computer system 700 displays specular effect 1120 on the corner of virtual portal 1102. The display of specular effect 1120 aids in creating the perception that virtual portal 1102 is a three-dimensional object within representation of physical environment 1106. At FIG. 11B, computer system 700 is repositioned within the physical environment. In some embodiments, specular effect 1120 is displayed around the periphery of virtual portal 1102. In some embodiments, computer system 700 displays representation of media item 1108 with a parallax effect (e.g., computer system 700 shows the foreground portion of representation of media item 1108 shift/move relative to the background portion of representation of media item 1109) as computer system 700 is repositioned within the physical environment. In some embodiments, computer system 700 changes which portion of representation of media item 1108 is obscured by the impinging layer of visual effect 1112 in response to detecting a change in the viewpoint of computer system 700. In some embodiments, in response to detecting a change in the viewpoint of computer system 700, computer system 700 changes the appearance of representation of media item 1108 differently for each eye of the user.

At FIG. 11C, computer system 700 makes a determination that computer system 700 is positioned to the left of the display of virtual portal 1102 (e.g., computer system 700 is positioned at an angle relative to the display of virtual portal 1102). At FIG. 11C, because computer system 700 makes a determination that computer system 700 is positioned to the left of the display of virtual portal 1102, computer system 700 displays virtual portal 1102 to the right of the center of display device 702 of computer system 700. Further, at FIG. 11C, because computer system 700 makes a determination that computer system 700 is positioned to the left of the display of virtual portal 1102, computer system 700 increases the amount of back blur layer 1112a (e.g., that forms part of visual effect 1112) that is displayed on the right boundary of virtual portal 1102 (e.g., in comparison to the amount of back blur layer 1112a that is displayed on the right boundary of virtual portal 1102 at FIGS. 11A & 11B). In some embodiments, when computer system 700 is a head-mounted device, computer system 700 separately displays virtual portal 1102 to the right of center of two separate display devices of computer system 700 that each correspond to different eyes of the user (e.g., computer system 700 separately displays virtual portal 1102 to the right of center of a display for each eye of the user). In some embodiments, when computer system 700 is a head-mounted device, computer system 700 separately increases the amount of the display of back blur layer 1112a on the right boundary of virtual portal 1102 for two separate display devices of computer system 700 that each correspond to different eyes of the user (e.g., computer system 700 separately increases the amount of the display of virtual portal 1102 for each eye of the user).

Further, at FIG. 11C, computer system 700 makes a determination that computer system 700 is positioned further from the display of virtual portal 1102 than the previous position of computer system 700 (e.g., the position of computer system 700 at FIG. 11B) within the physical environment. Because computer system 700 makes a determination that computer system 700 is positioned further from the display of virtual portal 1102 than the previous position of computer system 700, computer system 700 decreases the size of the display of virtual portal 1102 (e.g., in comparison to the size of virtual portal 1102 at FIG. 11B) (e.g., to indicate that the distance between computer system 700 and the display of virtual portal 1102 has increased). In some embodiments, when computer system 700 is a head-mounted device, computer system 700 separately decreases the size of the display of virtual portal 1102 on two separate display devices of computer system 700 that each correspond to different eyes of the user.

At Figure, because computer system 700 is positioned to the left and further from the display of virtual portal 1102 than the previous position of computer system 700, (e.g., the position of computer system 700 at FIG. 11B) the positioning of the content included in representation of the physical environment 1106 (e.g., chair 1106a, couch 1106b, and water dispenser 1106c) shifts to the right within media user interface 1104 (e.g., in comparison to the positioning of the content included in representation of the physical environment 1106 at FIG. 11B). As illustrated in FIG. 11C, computer system 700 maintains the display of specular effect 1120 on the left corner of virtual portal 1102. At FIG. 11C, computer system 700 is repositioned within the physical environment. In some embodiments, the location of the display of specular effect 1120 is based on the point of view of computer system 700 relative to the display of virtual portal 1102.

At FIG. 11D, computer system 700 makes a determination that the positioning of computer system 700 is centered with the display of virtual portal 1102. At FIG. 11D, because computer system 700, makes a determination that the positioning of computer system 700 is centered with the display of virtual portal 1102, computer system 700 uniformly displays back blur layer 1112a around the periphery of virtual portal 1102 (e.g., computer system 700 displays the same amount of back blur layer 1112a on each boundary of virtual portal 1102). In some embodiments, when computer system 700 is a head-mounted device, computer system 700 uniformly displays back blur layer 1112a around the periphery of virtual portal 1102 on two separate display devices of computer system 700 that each correspond to different eyes of the user.

Further, at FIG. 11D, computer system 700 makes a determination that the positioning of computer system 700 within the physical environment is closer to the display of virtual portal 1102 than the previous positioning of computer system 700 (e.g., the positioning of computer system 700 at FIG. 11C). Because computer system 700 makes a determination that the positioning of computer system 700 is closer to the display of virtual portal than the previous positioning of computer system 700, computer system 700 increases the size of the display virtual portal 1102 (e.g., to indicate the decrease in distance between computer system 700 and the display of virtual portal 1102). In some embodiments, when computer system 700 is a head-mounted device, computer system 700 separately increases the size of the display of virtual portal 1102 on two separate display devices of computer system 700 that each correspond to different eyes of the user.

At FIG. 11D, computer system 700 detects a request to display representation of media item 1108 with an immersive appearance. In some embodiments, the request to display representation of media item 1108 with the immersive appearance corresponds to computer system 700 detecting an input that corresponds to activation of one or more hardware input mechanisms (e.g., one or more hardware input mechanisms are depressed and/or rotated) that are in communication with computer system 700. In some embodiments, the request to display representation of media item 1108 with the immersive appearance corresponds to computer system 700 detecting that it is repositioned to a location within the physical environment that corresponds to the display of virtual portal 1102.

At FIG. 11E, in response to detecting the request to display representation of media item 1108 with the immersive appearance, computer system 700 displays representation of media item 1108 with the immersive appearance. At FIG. 11E, display of representation of media item 1108 takes up the entirety of the display device 702. That is, while computer system 700 displays representation of media item 1108 displayed with the immersive appearance, representation of physical environment 1106 is not visible. Computer system 700 displays content included in media item 1108 (e.g., the tree and the woman) at full scale (e.g., real world scale) while computer system 700 displays representation of media item 1108 with the immersive appearance. Representation of media item 1108 occupies a larger amount of the viewpoint of the user while representation of media item 1108 is displayed with the immersive appearance in contrast to when representation of media item 1108 is displayed with a non-immersive appearance (e.g., the appearance of representation of media item 1108 in FIGS. 11A-11D). In some embodiments, when computer system 700 is a head-mounted device, computer system 700 displays representation of media item 1108 on the majority (e.g., entirety) of two separate display devices of computer system 700 that each correspond to different eyes of the user when computer system 700 displays representation of media item 1108 with the immersive appearance.

At FIG. 11E, computer system 700 detects that the point of view of computer system 700 is rotated to the left in the physical environment. In some embodiments, computer system 700 displays representation of media item 1108 as wrapping around the viewpoint of a user while computer system 700 displays representation of media item 1108 with the immersive appearance. In some embodiments, in response to detecting the request to display representation of media item 1108 with the immersive appearance, the distance between the computer system 700 and virtual portal 1102 decreases (e.g., computer system 700 moves the display of virtual portal 1102 closer to the position of computer system 700 and/or computer system 700 is moved closer to the display of virtual portal 1102 within representation of physical environment 1106). In some embodiments, in response to detecting the request to display representation of media item 1108 with the immersive appearance, computer system 700 increases the size of representation of media item 1108 along the z-axis of representation of media item 1108 (e.g., computer system 700 increases the thickness of virtual portal 1102). In some embodiments, as a part of displaying representation of media item 1108 with the immersive appearance, computer system 700 displays back blur layer 1112a that is based on an extrapolation of content included at the edges of the stereoscopic media item.

At FIG. 11F, in response to computer system 700 detecting that the point of view of computer system 700 is rotated to the left, computer system 700 updates the display of representation of media item 1108 to show the left half of representation of media item 1108. More specifically, computer system 700 updates the display of representation of media item 1108 such that the left half of representation of media item 1108 (e.g., the portion of representation of media item 1108 that includes the tree) is visible and the right portion of representation of media item 1108 (e.g., the portion of representation of media item that includes the individual) is not visible. That is, while computer system 700 displays representation of media item 1108 with the immersive appearance, the display of representation of media item 1108 is changes based on changes to the point of view of computer system 700. In some embodiments, computer system 700 ceases to display representation of media item 1108 with the immersive appearance in response to computer system 700 detecting a request to display representation of media item 1108 with a non-immersive appearance (e.g., the appearance of representation of media item 1108 at FIGS. 11A-11D). In some embodiments, computer system 700 ceases to display representation of media item 1108 with the immersive appearance in response to computer system 700 detecting that computer system 700 is repositioned away from the location within the physical environment that corresponds to the display of virtual portal 1102.

Additional descriptions regarding FIGS. 11A-11F are provided below in reference to method 1200 described with respect to FIG. 12.

FIG. 12 is a flow diagram of an exemplary method 1200 for displaying a media item, in accordance with some embodiments. In some embodiments, method 1200 is performed at a computer system (e.g., 700) (e.g., a smart phone, a tablet, and/or a head-mounted device) that is in communication (e.g., wired communication and/or wireless communication) with a display generation component (e.g., 702) (e.g., a display controller; a touch-sensitive display system; a display (e.g., integrated and/or connected), a 3D display, a transparent display, a heads-up display, and/or a head-mounted display). In some embodiments, method 1200 is governed by instructions that are stored in a non-transitory (or transitory) computer-readable storage medium and that are executed by one or more processors of a computer system, such as the one or more processors 202 of computer system 101 (e.g., control 110 in FIG. 1). Some operations in method 1200 are, optionally, combined and/or the order of some operations is, optionally, changed.

The computer system displays (1202), via the display generation component, user interface (e.g., 1104) that includes (e.g., a user interface that corresponds to a media viewing application that is installed on the computer system (e.g., a third party media viewing application or a media viewing application that is installed on the computer system by the manufacturer of the computer system)) a first representation of a stereoscopic media item (e.g., 1108) (1204) (e.g., the stereoscopic media item was previously captured (e.g., previously captured using one or more cameras that are in communication with the computer system)) (e.g., a media item (e.g., a video or a still photo) that can be represented to the user in a manner that conveys depth; a media item that is captured using two or more cameras with different perspectives (or sets of cameras); and/or a media item that is captured using cameras that are in communication (e.g., wired communication or wireless) with the computer system), wherein the first representation of the stereoscopic media item includes at least a first edge (e.g., a boundary of 1108) and a visual effect (e.g., impinging blur layer 1112b) (1206) (e.g., a graphical element and/or effect; a blurred region), wherein the visual effect obscures at least a first portion of the stereoscopic media item and extends inwards from at least the first edge of the first representation of the stereoscopic media item towards an interior (e.g., a center of the first representation of the stereoscopic media item) (e.g., in a direction extending inwards towards the center of the first representation of the captured stereoscopic media item that is perpendicular to a direction of the first edge) of the first representation of the stereoscopic media item (e.g., as described above in reference to FIG. 11A) (e.g., the first representation of the captured stereoscopic media item and the visual effect are displayed while a representation (e.g., a virtual representation or an optical representation) of the physical environment (e.g., the physical environment of the location of the computer system) (e.g., a real time representation of the physical environment) is visible to a user of the computer system) (e.g., the visual effect is concurrently displayed with the first representation of the captured stereoscopic media item) (e.g., the computer system renders the visual effect and the first representation of the captured stereoscopic media item in separate layers (e.g., the visual effect is rendered behind the representation of the captured stereoscopic media item)). In some embodiments, the content included in the first representation of the captured stereoscopic media item that is covered by the visual effect is visible (e.g., visible to a user of the computer system) (e.g., the visual effect has a degree of translucency). In some embodiments, content included in the first representation of the captured stereoscopic media item obscures a portion of the visual effect (e.g., content included in the captured stereoscopic media item blocks a user from viewing a portion of the visual effect). In some embodiments, the computer system displays a boundary (e.g., a solid colored (e.g., black) line) around the first representation of the captured stereoscopic media item. In some embodiments, the first representation of the captured stereoscopic media item is head locked (e.g., the positioning of the first representation of the captured stereoscopic media item relative to a representation of the physical environment changes as the orientation of the computer system changes within the physical environment). In some embodiments, the first representation of the captured stereoscopic media item is world locked (e.g., the positioning of the captured stereoscopic media item relative to a representation of the physical environment is maintained when the orientation of the computer system changes within the physical environment). Displaying a visual effect that obscures a first portion of the stereoscopic media item and extends inward from a first edge of the stereoscopic media item towards the interior of the stereoscopic media item aids in reducing the amount of window violation (e.g., a visual effect that occurs when an object within a stereoscopic media item is obscured by an edge of a window that the stereoscopic media item is displayed behind at a point in time when the content of the stereoscopic media item is to be perceived in front of the window) that a user detects while the user views the stereoscopic media item from certain angles (e.g., extreme angles), which results in an enhanced viewing experience for the user, reducing window violation enhances the operability of the devices and make the user-device interfaces more efficient; doing so also reduces power usage and improves batter life of the computer system by enabling the user to use the device more quickly and efficiently

In some embodiments, the stereoscopic media item (e.g., that is represented by 1108) was captured from a set of cameras (e.g., two or more cameras that are positioned at a different locations (e.g., slightly different (e.g., separated by a 1 inch, 2 inches, 3 inches, and/or the average interpupillary distance for a person) in a physical environment) (e.g., two or more cameras that are in communication (e.g., wired communication and/or wireless communication) with the computer system), wherein a first camera from the set of cameras captures a first perspective of a physical environment, wherein a second camera from the set of cameras (e.g., that is different from the first camera) captures a second perspective of the physical environment, wherein the second perspective is different from the first perspective (e.g., as discussed above in reference to FIG. 11A). In some embodiments, the computer system displays via the display generation component (e.g., 702), the first perspective of the physical environment to a first eye (e.g., the user's left eye) of a user and not a second eye (e.g., the user's right eye) of the user (e.g., the perspective of the physical environment that is captured via the first camera is visible to the first eye of the user and not the second eye of the user (e.g., the perspective of the physical environment that is captured via the second camera is not visible to the second eye of the user)) (e.g., as discussed above in reference to FIG. 11A) and the computer system displays, via the display generation component, the second perspective to the second eye of the user and not the first eye of the user (e.g., as discussed above in reference to FIG. 11A) (e.g., the perspective of the physical environment that is captured via the second camera is visible to the second eye of the user and not the first eye of the user) (e.g., the second perspective includes content that is not included in the first perspective and vice versa) (e.g., the stereoscopic media item was captured by two or more spaced apart cameras that are pointing in the same general direction and spaced apart by approximately the distance that human eyes are spaced apart to create a stereoscopic effect when the images are concurrently displayed to different eyes of the user). In some embodiments, when the computer system is a head-mounted device, the computer system displays the first perspective of the physical environment on a first display device of the computer system and the computer system displays the second perspective of the physical environment on a second display device of the electronic device, where the first display device corresponds to a first eye of the user (e.g., is visible to a first eye of the user) and the second display device corresponds to a second eye of the user (e.g., is visible to a second eye of the user). Displaying a first perspective of the physical environment to a first eye of the user and displaying a second perspective of the physical environment to a second eye of the user enhances the user's perception of depth between content that is included in the first representation of the stereoscopic media item, which results in an enhanced and more accurate viewing experience for the user.

In some embodiments, while displaying the first representation of the stereoscopic media item (e.g., 1108), the computer system detects a first change in a viewpoint of a user (e.g., change in viewpoint of 700) (e.g., change in the positioning of the user's entire body, change in the positioning of a first portion of the user's body (e.g., the user's head)) (e.g., lateral movement of the user, side to side movement of the user, and/or user's movement along a horizontal plane). In some embodiments, in response to detecting the first change in the viewpoint of the user, the computer system changes the appearance of the first representation of the stereoscopic media item based on the first change in the viewpoint of the user (e.g., as discussed above in reference to FIG. 11B) (e.g., the change in the appearance of the first representation of the stereoscopic media is correlated to the change in the viewpoint of the user). In some embodiments, two or more visual properties of the first representation of the stereoscopic media item are changed as part of changing the appearance of the first representation of the stereoscopic media item. In some embodiments, portions of the first representation of the stereoscopic media item that were not visible prior to the change in the viewpoint of the user are visible after the change in the viewpoint of the user. Changing the appearance of the stereoscopic media item in response to detecting the change in the viewpoint of the user allows the user to control the appearance of the representation of the stereoscopic media item without displaying additional controls, which provides additional control options without cluttering the user interface. Changing the appearance of the stereoscopic media item in response to detecting the change in the viewpoint of the user provides user with visual feedback regarding the state of the computer system (e.g., the computer system has detected the change in the viewpoint of the user), which provides improved visual feedback.

In some embodiments, prior to changing the appearance of the first representation of the stereoscopic media item (e.g., 1108), the visual effect (e.g., impinging blur layer 1112b) obscures the first portion of the first representation of the stereoscopic media item (e.g., and the visual effect does not obscure a third portion of the first representation of the stereoscopic media item). In some embodiments, changing the appearance of the first representation of the stereoscopic media item includes modifying the visual effect such that the visual effect obscures a second portion of the first representation of the stereoscopic media item that is different from the first portion (e.g., as discussed above in reference to FIG. 11B) (e.g., and the visual effect does not obscure the first portion of the representation of the stereoscopic media item). In some embodiments, the first portion of the first representation of the stereoscopic media item includes content that is included in the second portion of the representation of the stereoscopic media item (e.g., content in the first portion of the representation of the stereoscopic media item overlaps with the content included third portion of the representation of the stereoscopic media item). Changing which portion of the first representation of the stereoscopic media item that the visual effect obscures in response to detecting the change in the viewpoint of the user allows the user to control the display of the visual effect without displaying additional controls, which provides additional control options without cluttering the user interface.

In some embodiments, changing the appearance of the first representation of the stereoscopic media item (e.g., 1108) includes, changing the appearance of the first representation of the stereoscopic media item that is displayed to a left eye of a user and not a right eye of the user in a first manner (e.g., as discussed above in reference to FIG. 11B) and changing the appearance of the first representation of the first stereoscopic media item that is displayed to the right eye and not the left eye of the user (e.g., that is different from the left eye of the user) of the user in a second manner, wherein the second manner is different from the first manner (e.g., as discussed above in reference to FIG. 11B) (e.g., there is an overlap of content of the first representation of the stereoscopic media item that is displayed to both the left eye of the user and the right eye of the user) (e.g., content included in the first representation of the stereoscopic media item is visible to the left eye of the user and not the right eye of the user and vice versa) (e.g., the computer system increases the amount of the visual effect that is visible to the left eye of the user and the computer system decreases the amount of the visual effect that is visible to the right eye of the user. In some embodiments, the computer system displays a change in the same visual characteristic (e.g., brightness, translucency, and/or size) of the first representation of the stereoscopic media item to both the left eye of the user and the right eye of the user. In some embodiments, the computer system displays a change in a first visual characteristics (e.g., brightness, translucency, and/or size) of the first representation of the stereoscopic media item to the left eye of the user and the computer system displays a change to a second visual characteristic of the first representation of the stereoscopic media item to the right eye of the user, where the first visual characteristic is different from the second visual characteristic. In some embodiments, when the computer system is a head-mounted device, the computer system changes the appearance of the first representation of the stereoscopic media item that is displayed on a first display device of the computer system (e.g., that corresponds to a first eye of the user(e.g., the first display device is visible to the first eye of the user)) differently than how the computer system changes the appearance of the representation of the stereoscopic media item that is displayed on a second display device of the computer system (e.g., that corresponds to a second eye of the user (e.g., the second display device is visible to the second eye of the user)). Changing the appearance of the first representation of the stereoscopic media item that is displayed to a left eye of a user differently from how the first representation of the stereoscopic media item that is displayed to a right eye of the user (e.g., second eye of the user) is changed allows the user to control what is independently displayed to both eyes of the user without displaying additional controls, which provides additional control options without cluttering the user interface. Changing the appearance of the first representation of the stereoscopic media item that is displayed to a left eye of a user differently from how the first representation of the stereoscopic media item that is displayed to a right eye of the user (e.g., second eye of the user) is changed helps mitigate the amount of window violation (e.g., a visual effect that occurs when an object within a stereoscopic media item is obscured by an edge of a window that the stereoscopic media item is displayed behind at a point in time when the content of the stereoscopic media item is to be perceived in front of the window) that a user detects when the user views the stereoscopic media item from extreme angles, which results in an enhanced viewing experience for the user.

In some embodiments, the visual effect (e.g., impinging blur layer 1112b) has a visual characteristic (e.g., a density and/or a color (e.g., a color gradient that is monochromatic or multicolored)) (e.g., an amount of translucency (e.g., the amount of the representation of the physical environment that is visible behind the visual property)) (e.g., the visual property is overlaid a first portion of the physical environment and is not overlaid a second portion of the representation of the physical environment) that decreases through a plurality of values (e.g., gradually or through a plurality of discrete steps) as the visual effect extends inwards from at least the first edge of the first representation of the stereoscopic media item (e.g., a boundary of 1108) towards the interior of the first representation of the stereoscopic media item (e.g., as discussed above in reference to FIG. 11A). In some embodiments, a second visual characteristic (e.g., translucency) of the visual effect increases through a plurality of values as the distances towards the center of the first representation of the stereoscopic media item decreases. Decreasing a visual characteristic of the blur effect assists the user in viewing content that is within the overlap of the capture region of two or more cameras while not viewing content that is not within the overlap of the capture region of the two or more cameras, which aids in mitigating of the amount of window violation (e.g., a visual effect that occurs when an object within a stereoscopic media item is obscured by an edge of a window that the stereoscopic media item is displayed behind at a point in time when the content of the stereoscopic media item is to be perceived in front of the window) that a user detects while viewing the stereoscopic media item, which results in an enhanced viewing experience for the user

In some embodiments, the first representation of the stereoscopic media (e.g., 1108) includes content at the first edge (e.g., a boundary of 1108) of the first representation of the stereoscopic media item (and optionally at one or more other edges of the first representation of the stereoscopic media item). In some embodiments, the visual effect (e.g., impinging blur layer 1112b) is a blur of the content at the first edge of the first representation of the stereoscopic media item (and optionally at one or more other edges of the first representation of the stereoscopic media item) (e.g., as described above in reference to FIG. 11A). Blurring content at the first edge of the first representation of the stereoscopic media aids in mitigating the amount of window violation (e.g., a visual effect that occurs when an object within a stereoscopic media item is obscured by an edge of a window that the stereoscopic media item is displayed behind at a point in time when the content of the stereoscopic media item is to be perceived in front of the window) that a user detects while the user views the stereoscopic media item from extreme angles, which results in an enhanced viewing experience for the user.

In some embodiments, the visual effect is displayed (e.g., concurrently displayed) on the first edge and a second edge of the first representation of the stereoscopic media item (e.g., 1108). In some embodiments, while displaying the first representation of the stereoscopic media item, the computer system detects a second change in the viewpoint of a user (e.g., change in viewpoint of 700), (e.g., change in the positioning of the user's entire body, change in the positioning of a first portion of the user's body (e.g., the user's head)) (e.g., lateral movement of the user, side to side movement of the user, and/or user's movement along a horizontal plane). In some embodiments, the second change in the viewpoint of the user includes a change in the angle of the viewpoint of the user relative to the display of the first representation of the stereoscopic media item (e.g., the angle of the viewpoint of the user relative to the display of the first representation of the stereoscopic media item changes by 5, 10, 15, 25, 30, 35, 40, 55 or 60 degrees). In some embodiments, in response to detecting the second change in the viewpoint of the user and in accordance with a determination that the second change in the viewpoint of the user is in a first direction (e.g., to the left, to the right, up, and/or down), the computer system increases the size of the visual effect (e.g., back blur layer1112a) on at least the second edge of the first representation of the stereoscopic media item (e.g., as discussed above in reference to FIGS. 11B and 11C) (e.g., the size of a blur region that is displayed behind the representation of the stereoscopic media item increases) (e.g., and decreases the size of the visual effect on the first edge of the first representation of the stereoscopic media item) (e.g., the second edge is on the side of the first representation of the stereoscopic media item that is opposite the first direction (e.g., the second edge is on the left side of the stereoscopic media item if the first direction is to the right)) and in accordance with a determination that the second change in the viewpoint of the user is in a second direction that is different from the first direction (e.g., to the left, to the right, up, and/or down), the computer system increases the size of the visual effect on at least the first edge of the first representation of the stereoscopic media item (e.g., as discussed above in reference to FIGS. 11B and 11C) (e.g., the size of a blur region that is displayed behind the representation of the stereoscopic media item increases) (e.g., and decreases the size of the visual effect that is displayed on the second edge of the first representation of the stereoscopic media item) (e.g., the first edge is on the side of the first representation of the stereoscopic media item that is opposite the second direction (e.g., the first side is at the top of the first representation of the stereoscopic media item if the second direction is downward)). In some embodiments, the first edge and the second edge are on opposite sides of the first representation of the stereoscopic media item and the first direction is opposite the second direction. In some embodiments, when the size of the visual effect on the second edge of the first representation of the stereoscopic media item is changed, the size of the visual effect on the first edge of the first representation of the stereoscopic media is unchanged and vice versa. In some embodiments, the first edge and the second edge are on opposite sides of the first representation (e.g., a left edge and a right edge). Changing the size of the visual effect on a respective edge of the first representation of the stereoscopic media item in response to detecting a change in the viewpoint of a user mitigates the amount of window violation (e.g., a visual effect that occurs when an object within a stereoscopic media item is obscured by an edge of a window that the stereoscopic media item is displayed behind at a point in time when the content of the stereoscopic media item is to be perceived in front of the window) a user detects when the user views the stereoscopic media item from certain angles, which results in an enhanced viewing experience for the user. Changing the size of the visual effect on a respective edge of the first representation of the stereoscopic media item in response to detecting a change in the viewpoint of the user allows the user to control the display of the visual effect without displaying additional controls, which provides additional control options without cluttering the user interface.

In some embodiments, displaying the user interface (e.g., 1104) includes displaying a blur region (e.g., back blur region of visual effect 1112), and wherein the stereoscopic media item includes a first plurality of edges (e.g., 3 edges, 4, edges, 5, edges, 6, edges or 7 edges). In some embodiments, in accordance with a determination that the first plurality of edges of the stereoscopic media item (e.g., that corresponds to 1108) includes first content, the blurred region includes a blurred representation of the first content, wherein the blurred representation of the first content is based on an extrapolation of the first content (e.g., the blurred representation of the first content includes an extrapolation of content that at the plurality of edges of the stereoscopic media item) (e.g., the blurred representation includes content that is not visible in the stereoscopic media item) (e.g., as described above in reference to FIG. 11A) and in accordance with a determination that the first plurality of edges of the stereoscopic media item (e.g., that corresponds to 1108) includes second content (e.g., that is different from the first content), the blurred region includes a blurred representation of the second content, wherein the blurred representation of the second content is based on an extrapolation of the second content (e.g., and the blurred region does not include an extrapolation of the first content) (e.g., as described above in reference to FIG. 11A). In some embodiments, the content that is included in the blurred region changes in response to the computer system detecting a change in the viewpoint of the user (e.g., the content that is included in the blurred region dynamically changes based on the viewpoint of the computer system). In some embodiments, the blur region extends outwards from at least the first edge of the first representation of the stereoscopic media item)

In some embodiments, the first representation of the stereoscopic media item is displayed with a vignette effect (e.g., as discussed above in reference to FIG. 11A) (e.g., a reduction of the brightness and/or saturation of the first representation of the stereoscopic media item at the periphery of the first representation of the stereoscopic media item (e.g., the brightness of the first representation of the stereoscopic media item increases as the distance from the periphery (e.g., towards the center of the first representation of the stereoscopic media item) of the first representation of the stereoscopic media item decreases)) (e.g., first representation of the stereoscopic media item is the brightest in the center and darkest at the edges of the first representation of the stereoscopic media item). In some embodiments, the computer system applies the vignette effect after the first representation of the stereoscopic media item is initially displayed. In some embodiments, the computer system applies the vignette effect as a part of initially displaying the first representation of the stereoscopic media item.

In some embodiments, displaying the user interface (e.g., 1104) includes displaying a virtual portal (e.g., 1102), and wherein the first representation of the stereoscopic media item (e.g., 1108) is displayed within the virtual portal (e.g., as described above in reference to FIG. 11A) (e.g., the virtual portal is displayed around the first representation of the stereoscopic media item). In some embodiments, the virtual portal is overlaid on top of a representation (e.g., optical or virtual representation) of a physical environment. In some embodiments, the virtual portal is displayed as a three-dimensional object (e.g., the virtual portal is displayed with depth). In some embodiments, the computer system displays content within the virtual portal that such that the content is continually visible to a user as the user moves around the display of the virtual portal. In some embodiments, when computer system is a head-mounted device, the computer system displays different perspectives of the virtual portal in response to detecting that a user is walking walk around a physical environment and/or turn their head (e.g., while the user is wearing the computer system). Displaying the representation of the stereoscopic media item within a virtual portal enhances the perception of the relative depth (e.g., as experienced by the user) between content that is included in the first representation of the stereoscopic media item, which results in an enhanced viewing experience for the user.

In some embodiments, the first representation of the stereoscopic media item (e.g., 1108) includes a foreground portion and a background portion. In some embodiments, while displaying the first representation of the stereoscopic media item, the computer system detects a third change in the viewpoint of a user (e.g., as described above in reference to FIGS. 11A, 11B, and 11C) (e.g., change in viewpoint of 700) (e.g., change in the positioning of the user's entire body, change in the positioning of a first portion of the user's body (e.g., the user's body)) (e.g., lateral movement of the user, side to side movement of the user, and/or user's movement along a horizontal plane). In some embodiments, in response to detecting the third change in the viewpoint of the user, the computer system displays, via the display generation component (e.g., 702), the foreground portion of the first representation of the stereoscopic media item move relative to the background portion of the first representation of the stereoscopic media item based on the third change in the viewpoint of the user (e.g., as described above in reference to FIG. 11B) (e.g., the computer system displays a parallax effect with respect to the foreground portion and the background portion of the first representation of the stereoscopic media item) (e.g., the foreground portion of the first representation of the stereoscopic media item shifts differently (e.g., moves faster) than the background portion of the first representation of the stereoscopic media item) (e.g., the objects in the foreground portion of the first representation of the stereoscopic media item move at a first variable speed based on the change in viewpoint of the user and objects in the background portion of the first representation of the stereoscopic media item move at a second variable speed that is based on the change in the viewpoint of the user). Displaying the foreground portion of the first representation of the stereoscopic media item move relative to the background portion of the first representation of the stereoscopic media item provides the user with visual feedback regarding depth data that is associated with the first representation of the stereoscopic media item, which provides improved visual feedback.

In some embodiments, displaying the virtual portal (e.g., 1102) includes displaying a first portion (e.g., 1118) of the virtual portal (e.g., 1102) (e.g., a window (e.g., the first representation of the stereoscopic media item sits within the window) of the virtual portal) (e.g., less than the entirety of the virtual portal) at a first location in a first representation of a physical environment (e.g., 1106) that is a first distance away from a first point-of-view of a user (e.g., positioning of 700) wherein displaying (e.g., renders) the first representation of the stereoscopic media item includes displaying the first representation of the stereoscopic media item (e.g., 1108) at a second location in the first representation of the physical environment that is a second distance away the from the first point-of-view of the user, and wherein the second distance is greater than the first distance (e.g., there is an amount of stereoscopic depth between the first portion of the virtual portal and the first representation of the stereoscopic media item (e.g., the computer system displays separate images to the two eyes of the user which cause the user to perceive that the first representation of the stereoscopic media item is positioned behind the first portion of the virtual portal)) (e.g., the representation is further from the user than the first portion of the virtual portal). In some embodiments, the computer system renders the first representation of the stereoscopic media item between the window and a blur layer. In some embodiments, the computer system renders the first representation of the stereoscopic media item between a first blur and a second blur. Displaying the representation of the stereoscopic media item further away from the user than a first portion of the portal mitigates the amount of window violation (e.g., a visual effect that occurs when an object within a stereoscopic media item is obscured by an edge of a window that the stereoscopic media item is displayed behind at a point in time when the content of the stereoscopic media item is to be perceived in front of the window) a user may experience when the computer system displays various virtual objects (e.g., selectable virtual objects) on top of the first representation of the stereoscopic media item, which provides for an enhanced viewing experience for the user.

In some embodiments, the virtual portal (e.g., 1102) is a three-dimensional virtual object with an amount of thickness, wherein the amount of thickness displayed (e.g., visible) to a user is directly correlated to an angle of the point-of-view of the user relative to the display of the virtual portal (e.g., as described above in relation to FIG. 11A) (e.g., the amount of thickness that is visible to the user increases at the angle of the point of view of the user relative to the display of the virtual portal increases).

In some embodiments, displaying the first representation of the stereoscopic media item (e.g., 1108) includes displaying a specular effect (e.g., 1120) (e.g., a virtual specular effect) (e.g., a mirror like reflection of light) at the first edge of the first representation of the stereoscopic media item (and optionally at one or more other edges of the first representation of the stereoscopic media item). In some embodiments, the specular effect is displayed on two, three, or more (e.g., all) of the edges of the first representation of the stereoscopic media item. In some embodiments, the specular effect is displayed around the periphery of the first representation of the stereoscopic media item. In some embodiments, the appearance of the specular effect changes based on a detected change of the viewpoint of the user. In some embodiments, the computer system ceases to display the specular effect in accordance with a determination that the ambient lighting in the physical environment is beneath a lighting threshold. In some embodiments, the specular effect is static (e.g., the appearance of the specular effect does not change as the viewpoint of the user changes). Displaying a specular effect at the first edge of the representation of the stereoscopic media item aids in creating the perception that the virtual portal is a three dimensional object in a physical environment, which assists the user in visualizing the depth data that is associated with the stereoscopic media item, which provides for an enhanced viewing experience for the user.

In some embodiments, the first representation of the stereoscopic media item (e.g., 1108) is displayed at a first location (e.g., virtual location) within a second representation of the physical environment (e.g., 1106) (e.g., optical representation or virtual representation) (e.g., the first location corresponds to a location in the physical environment that is in front of the positioning of the computer system in the physical environment), wherein the first location is a first distance (e.g., virtual distance) away (e.g., 6 inches, 1 foot, 1.5 feet, 5 feet, or 10 feet) from a first viewpoint of a user (e.g., viewpoint of 700). In some embodiments, while displaying the first representation of the stereoscopic media item at the first location within the second representation of the physical environment, the computer system detects a request (e.g., an activation of a hardware button that is in communication (e.g., wired communication and/or wireless communication) with the computer system; the detection (e.g., via one or more cameras that are in communication with the computer system) of an air gesture (e.g., air pinch, air swipe, and/or air tap); and/or a voice command) (e.g., the computer system detects that the user moves to a location within the physical environment that corresponds to the location of the display of the first representation of the stereoscopic media item) to display the stereoscopic media item with an immersive appearance (e.g., as discussed above in FIG. 11D) (e.g., first person view). In some embodiments, in response to detecting the request to display the first representation of the stereoscopic media item with the immersive appearance, the computer system displays the first representation of the stereoscopic media item from a second location within the second representation of the physical environment, wherein the second location is a second distance away from the first viewpoint of the user (e.g., viewpoint of 700), and wherein the second distance is less than the first distance (e.g., as discussed above in reference to FIG. 11E) (e.g., the computer system moves the display of the first representation of the stereoscopic media item towards the viewpoint of the user and/or the computer system detects that the user moves closer to the display of the first representation of the stereoscopic media item) (e.g., the computer system maintains the display of the first representation of the stereoscopic media item while the computer system moves the first representation of the media item from the first location to the second location) and the computer system increases the size of the first representation of the stereoscopic media item along a plane of the first representation of the stereoscopic media item that is parallel to the path between the first location within the second representation of the physical environment and the second location within the second representation of the physical environment (e.g., as discussed above in reference to FIG. 11E) (e.g., the display of the first representation of the stereoscopic media item occupies more of the field-of-view of the user after the size of the first representation of the stereoscopic media item is increased (e.g., while the first representation of the stereoscopic media item is displayed with an immersive appearance)) (e.g., the thickness of the first representation of the stereoscopic media item along the z-axis is increased). In some embodiments, displaying the stereoscopic media item with an immersive appearance includes displaying different perspectives of a representation of content that is included in the first representation of the stereoscopic media item, where the different perspectives are at a common point in an environment. In some embodiments, a representation of the physical environment is visible to the user while the first representation of the stereoscopic media item is displayed with an immersive appearance. In some embodiments, the computer system displays the first representation of the stereoscopic media item as moving from the first location in the representation of the physical environment to the second location in the representation of the physical while the computer system displays the size of the first representation of the stereoscopic media item increasing. In some embodiments, the computer system displays the first representation of the stereoscopic media item as moving from the first location in the representation of the physical environment to the second location in the representation of the physical environment before or after computer system displays the size of the first representation of the stereoscopic media item increasing. In some embodiments, the computer system ceases to display the first representation of the stereoscopic media item with an immersive appearance in response to detecting a request to display the first representation of the stereoscopic media item with a non-immersive appearance. In some embodiments, when the computer system is a head mounted device, the appearance of the stereoscopic media item corresponds to a positional orientation of the user's head while the stereoscopic media item is displayed with the immersive appearance. In some embodiments, when the computer system is a head-mounted device, the computer system displays the stereoscopic media item on the majority (e.g., entirety) of a first display device of the computer system and the computer system displays the stereoscopic media item on the majority (e.g., entirety) of a second display device of the computer system, where the first display device of the computer system corresponds to a first eye of the user (e.g., the first display device is visible to the first eye of the user) and the second display device of the computer system corresponds to a second eye of the user (e.g., the second display device is visible to the second eye of the user). Displaying the first representation of the stereoscopic media item closer to the user and increasing the size of the first representation of the stereoscopic media item provides the user with visual feedback regarding the state of the computer system (e.g., the computer system has detected the request to display the first representation of the stereoscopic media item with an immersive appearance), which provides improved visual feedback.

In some embodiments, content (e.g., the tree and individual in 1108) included in the first representation of the stereoscopic media item (e.g., 1108) is displayed at a respective scale that has a predetermined relationship to a scale of the objects captured when the spatial media was captured (e.g., content included in the first representation of the stereoscopic media item is displayed at a 1:1 scale relative to the representation of the physical environment as compared to a scale of the objects in the media item relative to the physical environment that the objects were located when the stereoscopic media item was captured) (e.g., content included in the first representation of the stereoscopic media item is displayed at a real world scale) the first representation of the stereoscopic media item is displayed with the immersive appearance (e.g., as discussed above in FIG. 11E). In some embodiments, the computer system displays content included in the first representation of the stereoscopic media item at less than the full scale prior to the computer system detecting the request to display the first representation of the stereoscopic media item with an immersive appearance (e.g., the first representation of the stereoscopic media item is displayed with a non-immersive appearance). Displaying content included in the first representation of the stereoscopic media item at a respective scale that has a predetermined relationship to a scale of the objects captured when the spatial media was captured provides the user with an accurate representation of the relative real world size and positioning of the content that is included in the first representation of the stereoscopic media item which enhances the user's viewing experience while the first representation of the stereoscopic media item has an immersive appearance.

In some embodiments, prior to detecting the request to display the first representation of the stereoscopic media item with the immersive appearance (e.g., 1108 at FIGS. 11E-11F), displaying the first representation of the stereoscopic media item includes displaying the first representation of the stereoscopic media item with a non-immersive appearance (e.g., 1108 at FIGS. 11A-11D) (e.g., the appearance of the content included in the first representation of the stereoscopic media item does not change based on a change to the viewpoint of the computer system). In some embodiments, the first representation of the stereoscopic media item, when displayed with the immersive appearance, occupies a first angular range of a second viewpoint of a user (e.g., 180, 270, or 360 degrees around the viewpoint of the user) (e.g., the first representation of the stereoscopic media item does not occupy the first angular range of the second viewpoint of the user while the first representation of the stereoscopic media item is displayed with a non-immersive appearance (e.g., prior to the computer system detecting the request to display the first representation with the immersive appearance)) (e.g., as discussed above in reference to FIG. 11E). In some embodiments, the first representation of the stereoscopic media item, when displayed with the non-immersive appearance, occupies a second angular range (e.g., 30, 45, 60, 120, or 180 degrees) of the second viewpoint of the user, wherein the second angular range is smaller than the first angular range (e.g., as discussed above in reference to FIG. 11E). Displaying the first representation of the stereoscopic media item around a larger angular range of the viewpoint of the user while the first representation of the stereoscopic media item is displayed with the immersive appearance provides the user with the ability to move within a larger range of motion while maintaining the view the content included in the first representation of the stereoscopic media item, which provides for an enhanced viewing experience for the user.

In some embodiments, the stereoscopic media item includes a second plurality of edges (e.g., 3 edges, 4, edges, 5 edges, or 6 edges). In some embodiments, while the first representation of the stereoscopic media item is displayed with the immersive appearance (e.g., 1108 at FIGS. 11E and 11F) and in accordance with a determination that the second plurality of edges of the stereoscopic media item (e.g., the media item represented by 1108) includes third content, the computer system displays a representation of the third content at the first edge of the first representation of the stereoscopic media item (e.g., extending outwards from at least the third edge), wherein the representation of the third content is based on an extrapolation (e.g., the representation of the third content includes an extrapolation of content that is visible at each edge of the plurality of edges of the stereoscopic media item) (e.g., the third representation includes content that is not visible in the stereoscopic media item) of the third content (e.g., as discussed above in reference to FIG. 11E) and in accordance with a determination that the second plurality of edges of the stereoscopic media item includes fourth content, the computer system displays a representation of the fourth content at the first edge of the first representation of the stereoscopic media item, wherein the representation of the fourth content is based on an extrapolation of the fourth content (e.g., as discussed above in reference to FIG. 11E). In some embodiments, the representation of the third content that is based on an extrapolation of the third content is blurred. In some embodiments, the representation of the fourth content that is based on an extrapolation of the fourth content is blurred. In some embodiments, the representation of the third content/fourth content changes in response to a detection of a change in the viewpoint of the user.

In some embodiments, the computer system displays a representation of a non-stereoscopic media item (e.g., a media item that does not include content that is captured from a plurality of perspectives), wherein the non-stereoscopic media item is displayed without the visual effect (e.g., impinging blur 1112b) (e.g., as discussed above in reference to FIG. 11A) (e.g., non-stereoscopic media items are displayed without the above described visual effects that stereoscopic media items are displayed with (e.g., non-stereoscopic media items are not displayed with a blur effect that decreases in intensity as the blur effect extends towards the middle of the non-stereoscopic media item; the non-stereoscopic media item is not displayed with a blur effect that obscures a portion of the content included in the non-stereoscopic media item; the amount of a blur effect that is displayed with a non-stereoscopic media item does not change as the point of view of the computer system changes; the portions of content that a blur effect obscures does not change in response to the point of view of the computer system changing; the non-stereoscopic media item is not displayed with a blur region that is based on an extrapolation of content included in the non-stereoscopic media item; the non-stereoscopic media item is not displayed with an immersive appearance; both eyes of a user see the same change in appearance of the non-stereoscopic media items in response to the point of view of the computer system changing). In some embodiments, the representation of the non-stereoscopic media item is concurrently displayed with the first representation of the stereoscopic media item. In some embodiments, the computer system ceases to display the first representation of the stereoscopic media item in response to displaying the non-stereoscopic media item. In some embodiments, some combination of the visual effects described above apply to stereoscopic media items and not for non-stereoscopic media items. In some embodiments, some combination of the visual effects described above apply to both stereoscopic media items and non-stereoscopic media items.

In some embodiments, the computer system displays a second representation of a second stereoscopic media item that is different than first representation of the stereoscopic media item (e.g., the second representation of a second stereoscopic media item includes content that is different from the content included in the first representation of the stereoscopic media item), wherein the second representation of the second stereoscopic media item is displayed with a second visual effect (e.g., impinging blur 1112b) (e.g., the second representation of the second stereoscopic media item is displayed with the above described visual effects that stereoscopic media items have (e.g., the second representation of the second stereoscopic media item is displayed with a blur effect that decreases in intensity as the blur effect extends towards the middle of the second representation of the second stereoscopic media item; the second representation of the second stereoscopic media item is displayed with a blur effect that obscures a portion of the content included in the second representation of the second stereoscopic media item is; the amount of a blur effect that is displayed within the second representation of the second stereoscopic media item changes as the point of view of the computer system changes; the portions of content in the second representation of the second stereoscopic media item that a blur effect obscures changes in response to the point of view of the computer system changing; the second representation of the second stereoscopic media item is displayed with a blur region that is based on an extrapolation of content included in the second representation of the second stereoscopic media item; the second representation of the second stereoscopic media item can be displayed with an immersive appearance; the eyes of a user see different changes to the appearance of the second representation of the second stereoscopic media item in response to the viewpoint of the computer system changing), wherein the second visual effect obscures at least a first portion of the second representation of the second stereoscopic media item and extends inwards from at least a first edge of the second representation of the second stereoscopic media item towards an interior (e.g., as discussed above in reference to FIG. 11A) (e.g., a center of the second representation of the second stereoscopic media item) (e.g., in a direction extending inwards towards the center of the second representation of the second stereoscopic media item that is perpendicular to a direction of the first edge) of the second representation of the second stereoscopic media item. In some embodiments, the computer system ceases to display the first representation of the stereoscopic media item as a part of displaying the second representation of the second stereoscopic media item. In some embodiments, the computer system displays the first representation of the stereoscopic media item and the second representation of the second stereoscopic media item at the same time.

In some embodiments, aspects/operations of methods 800, 900, 1000, and 1100 may be interchanged, substituted, and/or added between these methods. For example, the zoom operation that is descried in method 900 is optionally used to display the representation of the media item at an increased and/or decreased zoom level. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In another example, users can select not to provide data for customization of services. In yet another example, users can select to limit the length of time data is maintained or entirely prohibit the development of a customized service. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can generated by inferring preferences based on non-personal information data or a bare minimum amount of personal information, such as the content being requested by the device associated with a user, other non-personal information available to the service, or publicly available information.

What is claimed is:

1. A computer system that is configured to communicate with a display generation component and one or more input devices, the computer system comprising:
one or more processors; and
memory storing one or more programs configured to be executed by the one or more processors, the one or more programs including instructions for:
displaying, via the display generation component, a user interface that includes:
a first representation of a stereoscopic media item, wherein the first representation of the stereoscopic media item includes at least a first edge; and
a visual effect, wherein the visual effect obscures at least a first portion of the stereoscopic media item, wherein the visual effect extends inwards from at least the first edge of the first representation of the stereoscopic media item towards an interior of the first representation of the stereoscopic media item, and wherein the visual effect is displayed on the first edge and a second edge of the first representation of the stereoscopic media item;
while displaying the first representation of the stereoscopic media item, detecting a first change in a viewpoint of a user, wherein the first change in the viewpoint of the user includes a change in an angle of the viewpoint of the user relative to the display of the first representation of the stereoscopic media item; and
in response to detecting the first change in the viewpoint of the user:
in accordance with a determination that the first change in the viewpoint of the user is in a first direction, increasing a size of the visual effect on at least the second edge of the first representation of the stereoscopic media item; and
in accordance with a determination that the first change in the viewpoint of the user is in a second direction that is different from the first direction, increasing the size of the visual effect on at least the first edge of the first representation of the stereoscopic media item.

2. The computer system of claim 1, wherein the stereoscopic media item was captured from a set of cameras, wherein a first camera from the set of cameras captures a first perspective of a physical environment, wherein a second camera from the set of cameras captures a second perspective of the physical environment, wherein the second perspective is different from the first perspective, and wherein displaying the first representation of the stereoscopic media item includes:
displaying, via the display generation component, the first perspective of the physical environment to a first eye of a user and not a second eye of the user; and
displaying, via the display generation component, the second perspective to the second eye of the user and not the first eye of the user.

3. The computer system of claim 1, the one or more programs further including instructions for:
while displaying the first representation of the stereoscopic media item, detecting a second change in a viewpoint of a user; and
in response to detecting the second change in the viewpoint of the user, changing the appearance of the first representation of the stereoscopic media item based on the second change in the viewpoint of the user.

4. The computer system of claim 3, wherein:
prior to changing the appearance of the first representation of the stereoscopic media item, the visual effect obscures the first portion of the first representation of the stereoscopic media item; and
changing the appearance of the first representation of the stereoscopic media item includes modifying the visual effect such that the visual effect obscures a second portion of the first representation of the stereoscopic media item that is different from the first portion.

5. The computer system of claim 3, wherein changing the appearance of the first representation of the stereoscopic media item includes:
changing the appearance of the first representation of the stereoscopic media item that is displayed to a left eye of a user and not a right eye of the user in a first manner; and
changing the appearance of the first representation of the first stereoscopic media item that is displayed to the right eye and not the left eye of the user of the user in a second manner, wherein the second manner is different from the first manner.

6. The computer system of claim 1, wherein the visual effect has a visual characteristic that decreases through a plurality of values as the visual effect extends inwards from at least the first edge of the first representation of the stereoscopic media item towards the interior of the first representation of the stereoscopic media item.

7. The computer system of claim 6, wherein the first representation of the stereoscopic media item includes content at the first edge of the first representation of the stereoscopic media item, and wherein the visual effect is a blur of the content at the first edge of the first representation of the stereoscopic media item.

8. The computer system of claim 1, wherein displaying the user interface includes displaying a blur region, and wherein the stereoscopic media item includes a first plurality of edges, and wherein:
in accordance with a determination that the first plurality of edges of the stereoscopic media item includes first content, the blurred region includes a blurred representation of the first content, wherein the blurred representation of the first content is based on an extrapolation of the first content; and
in accordance with a determination that the first plurality of edges of the stereoscopic media item includes second content, the blurred region includes a blurred representation of the second content, wherein the blurred representation of the second content is based on an extrapolation of the second content.

9. The computer system of claim 1, wherein the first representation of the stereoscopic media item is displayed with a vignette effect.

10. The computer system of claim 1, wherein displaying the user interface includes displaying a virtual portal, and wherein the first representation of the stereoscopic media item is displayed within the virtual portal.

11. The computer system of claim 10, wherein displaying the virtual portal includes displaying a first portion of the virtual portal at a first location in a first representation of a physical environment that is a first distance away from a first point-of-view of a user, wherein displaying the first representation of the stereoscopic media item includes displaying the first representation of the stereoscopic media item at a second location in the first representation of the physical environment that is a second distance away from the first point-of-view of the user, and wherein the second distance is greater than the first distance.

12. The computer system of claim 10, wherein the virtual portal is a three-dimensional virtual object with an amount of thickness, wherein the amount of thickness displayed to a user is directly correlated to an angle of a point-of-view of the user relative to the display of the virtual portal.

13. The computer system of claim 1, wherein the first representation of the stereoscopic media item includes a foreground portion and a background portion; the one or more programs further including instructions for:
while displaying the first representation of the stereoscopic media item, detecting a third change in the viewpoint of a user; and
in response to detecting the third change in the viewpoint of the user, displaying, via the display generation component, the foreground portion of the first representation of the stereoscopic media item move relative to the background portion of the first representation of the stereoscopic media item based on the third change in the viewpoint of the user.

14. The computer system of claim 1, wherein displaying the first representation of the stereoscopic media item includes displaying a specular effect at the first edge of the first representation of the stereoscopic media item.

15. The computer system of claim 1, wherein the first representation of the stereoscopic media item is displayed at a first location within a second representation of a physical environment, wherein the first location is a first distance away from a first viewpoint of a user, wherein the one or more programs further include instructions for:
while displaying the first representation of the stereoscopic media item at the first location within the second representation of the physical environment, detecting a request to display the first representation of the stereoscopic media item with an immersive appearance; and
in response to detecting the request to display the first representation of the stereoscopic media item with the immersive appearance:
displaying the first representation of the stereoscopic media item from a second location within the second representation of the physical environment, wherein the second location is a second distance away from the first viewpoint of the user, and wherein the second distance is less than the first distance; and
increasing the size of the first representation of the stereoscopic media item along a plane of the first representation of the stereoscopic media item that is parallel to a path between the first location within the second representation of the physical environment and the second location within the second representation of the physical environment.

16. The computer system of claim 15, wherein, when the first representation of the stereoscopic media item is displayed with the immersive appearance, content included in the first representation of the stereoscopic media item is displayed at a respective scale that has a predetermined relationship to a scale of objects captured when the stereoscopic media item was captured.

17. The computer system of claim 15, wherein, prior to detecting the request to display the first representation of the stereoscopic media item with the immersive appearance, displaying the first representation of the stereoscopic media item includes displaying the first representation of the stereoscopic media item with a non-immersive appearance, and wherein:
the first representation of the stereoscopic media item, when displayed with the immersive appearance, occupies a first angular range of a second viewpoint of a user; and
the first representation of the stereoscopic media item, when displayed with the non-immersive appearance, occupies a second angular range of the second viewpoint of the user, wherein the second angular range is smaller than the first angular range.

18. The computer system of claim 15, wherein the stereoscopic media item includes a second plurality of edges, the one or more programs further including instructions for:
while the first representation of the stereoscopic media item is displayed with the immersive appearance:
in accordance with a determination that the second plurality of edges of the stereoscopic media item includes third content, displaying a representation of the third content at the first edge of the first representation of the stereoscopic media item, wherein the representation of the third content is based on an extrapolation of the third content; and
in accordance with a determination that the second plurality of edges of the stereoscopic media item includes fourth content, displaying a representation of the fourth content at the first edge of the first representation of the stereoscopic media item, wherein the representation of the fourth content is based on an extrapolation of the fourth content.

19. The computer system of claim 1, the one or more programs further including instructions for:
displaying a representation of a non-stereoscopic media item, wherein the non-stereoscopic media item is displayed without the visual effect.

20. The computer system of claim 1, the one or more programs further including instructions for:
displaying a second representation of a second stereoscopic media item that is different than first representation of the stereoscopic media item, wherein the second representation of the second stereoscopic media item is displayed with a second visual effect, wherein the second visual effect obscures at least a first portion of the second representation of the second stereoscopic media item and extends inwards from at least a first edge of the second representation of the second stereoscopic media item towards an interior of the second representation of the second stereoscopic media item.

21. A non-transitory computer-readable storage medium storing one or more programs configured to be executed by one or more processors of a computer system that is in communication with a display generation component, the one or more programs including instructions for:
displaying, via the display generation component, a user interface that includes:
a first representation of a stereoscopic media item, wherein the first representation of the stereoscopic media item includes at least a first edge; and
a visual effect, wherein the visual effect obscures at least a first portion of the stereoscopic media item wherein the visual effect extends inwards from at least the first edge of the first representation of the stereoscopic media item towards an interior of the first representation of the stereoscopic media item, and wherein the visual effect is displayed on the first edge and a second edge of the first representation of the stereoscopic media item;
while displaying the first representation of the stereoscopic media item, detecting a first change in a viewpoint of a user, wherein the first change in the viewpoint of the user includes a change in an angle of the viewpoint of the user relative to the display of the first representation of the stereoscopic media item; and
in response to detecting the first change in the viewpoint of the user:
in accordance with a determination that the first change in the viewpoint of the user is in a first direction, increasing a size of the visual effect on at least the second edge of the first representation of the stereoscopic media item; and
in accordance with a determination that the first change in the viewpoint of the user is in a second direction that is different from the first direction, increasing the size of the visual effect on at least the first edge of the first representation of the stereoscopic media item.

22. A method, comprising:
at a computer system that is in communication with a display generation component:
displaying, via the display generation component, a user interface that includes:
a first representation of a stereoscopic media item, wherein the first representation of the stereoscopic media item includes at least a first edge; and
a visual effect, wherein the visual effect obscures at least a first portion of the stereoscopic media item wherein the visual effect extends inwards from at least the first edge of the first representation of the stereoscopic media item towards an interior of the first representation of the stereoscopic media item, and wherein the visual effect is displayed on the first edge and a second edge of the first representation of the stereoscopic media item;
while displaying the first representation of the stereoscopic media item, detecting a first change in a viewpoint of a user, wherein the first change in the viewpoint of the user includes a change in an angle of the viewpoint of the user relative to the display of the first representation of the stereoscopic media item; and
in response to detecting the first change in the viewpoint of the user:
in accordance with a determination that the first change in the viewpoint of the user is in a first direction, increasing a size of the visual effect on at least the second edge of the first representation of the stereoscopic media item; and
in accordance with a determination that the first change in the viewpoint of the user is in a second direction that is different from the first direction, increasing the size of the visual effect on at least the first edge of the first representation of the stereoscopic media item.
